(19) United States
(12) Patent Application Publication
(10) Pub. No.: US 2014/0308646 A1
(43) Pub. Date: Oct. 16, 2014

(54) Method and System for Creating Interactive Training and Reinforcement Programs

(71) Applicant: Mindmarker BV, Maassluis (NL)

(72) Inventor: Anthonie Cornelis Wouter Wurth, Maassluis (NL)

(73) Assignee: Mindmarker BV, Maassluis (NL)

(21) Appl. No.: 14/209,905

(22) Filed: Mar. 13, 2014

Related U.S. Application Data
(60) Provisional application No. 61/780,253, filed on Mar. 13, 2013.

(51) Int. Cl. G09B 7/00

(52) U.S. Cl. CPC G09B 7/00
USPC 434/350

(57) ABSTRACT

Methods and system for creating an interactive training and reinforcement programs. Training program content is delivered to training participants in accordance with a data structure representing a timeline or schedule. A graphical representation of the timeline is presented to a trainer/user to construct a training program. Training program content comprises scheduled messages in the form of emails, videos, photos, pdf files, links to databases, text messages, questions, and surveys. The content including answers to questions is weighted. The timeline is modified in accordance with weighted scoring of the content delivered and responses by participants. A network-accessible computer system (100) stores training programs and content, delivers messages and content, receives answers to questions, scores responses, and effects changes to the timeline. Supplemental timelines called “learning loops” are generated for repetition of content, refreshers, supplemental content, timeline advancement, etc. as determined by a user and/or based on participant's scores.

### CROSS-REFERENCE TO RELATED APPLICATION

This application claims priority to and benefit under 35 U.S.C. §119(e) of U.S. Provisional Patent Application No. 61/780,253, filed Mar. 13, 2013, and entitled “Method and System for Creating Interactive Training and Reinforcement Programs”, which is incorporated herein by reference as if set forth herein in its entirety.

### TECHNICAL FIELD

The present disclosure relates to the field of interactive electronic methods and systems for training and reinforcement programs, facilitating education and training of individuals and to a system and method that allows efficient training modules and/or scenarios. More particularly, the disclosure relates to methods and systems for interactive computer-aided training and reinforcement programs that utilize multimedia content to provide reminders, instructions and questions to and obtain feedback from a plurality of users via a computer network.

### BACKGROUND

Companies and organizations in various industries are required, whether it be by law or by own requirements, to provide training on a regular basis to their employees or customers regarding safe, efficiency, communication, or otherwise necessary procedures for performing their job tasks. In particular, local, state and federal government agencies often require employers in certain fields to not only provide particular types of periodic training to employees who perform certain tasks, but also require those employers to certify on a regular basis that each such employee has received the training and has demonstrated a minimum understanding of the training materials.

Traditionally, companies and organizations provided such occupation specific training and certification functions to their employees by sponsoring classroom-like instruction for their employees. In such cases, a professional trainer is hired to teach and train the required subjects in a traditional classroom environment. Most times, at the end of the “class”, trainees are given a test to measure and determine whether they have mastered the necessary minimum materials required to receive a certification or to pass company standards. The term “trainee” is general, and should be interpreted to cover any person who receives content as described herein, including employees or contract workers of organizations such as business entities who are subject to training and education for the benefit of the individuals and/or the organization.

Companies and other organizations devote significant attention and resources to the education and training of individuals at a variety of stages in their personal and professional development. Educational and training efforts take a multitude of forms, including classic classroom lectures, periodic seminars, reading/review of reference materials, and experiential living. Another form of education and training is “distance learning”, which has been utilized by individuals to extend their education and training.

In the art of employee training and certification, a variety of approaches have been taken to remove the need for live instructors or trainers by automating the training and certification of employees in their work environment. Although there is a variety of approaches for presenting automated training materials to employees and then check their responses on the training materials, the applicant believes that these methods sometimes do not provide sufficient opportunity for the trainee to interact with the instructional material as well as is desired in the marketplace.

Accordingly, the present application believes that the results of the approaches for presenting automated training or the traditional “in class” training methods are not sufficient and satisfactory. Some market research shows that after a period of 4 to 6 weeks, 38% of trainees are back at their old skill level. Only 15% of the trainees are actively using the training material after 6 months. The applicant believes that one reason for this lack of results is that the existing available ways of presenting automated training material to the employees or the way traditional “in class” trainings methods are conducted, do not focus on the actual implementation of the training material into the employees daily tasks.

In addition to this, the present applicant believes that current methods and systems offer limited possibilities on how to analyze participants' implementation of the training materials in their daily work. The lack of this information limits companies to properly react to possible implementation issues.

The typical “in class” training sessions are designed to establish behavioral change, but often fail in doing so. In order to change behavior or teach skills or materials, the trainee needs much more than just a training session of a few days. These training sessions lack the power of repetition. In order to change a trainee's behavior or to teach a skill or material, the company, organization or a system needs to continuously and repetitively provide the materials to the trainee.

In conclusion, the present application believes that certain existing training approaches and methods have certain shortcomings in adequately providing training to effectively change employee behavior and are lacking the ability to sufficiently track, analyze and manage the employee's progress and certification results as well as is envisioned by the applicant herein. Thus, there remains a need in the art of training and evaluating of employees for an improved system and method for computer aided training, evaluation, and certification that overcomes the above described and other disadvantages inherent in the prior art of training and evaluating of employees.

### SUMMARY OF THE DISCLOSURE

In summary, the described system and methods facilitate creation, implementation and utilization of computer-based training programs and reinforcement programs in a wide range of educational, professional and/or business pursuits, and include administrative functionalities that greatly enhance system/method efficiency, flexibility and ease and speed with which educational/training modules may be customized and/or implemented. As described in detail below, aspects of the disclosed systems and methods related to delivery of training programs to program participants in accordance with a timeline that drives the delivery of training content on a schedule. This timeline is adjusted in various manners, as described herein, to alter the delivery of training content as a function of the participant's measured progress in learning and retention, as reflected in answers to questions and surveys. According to one aspect, the timeline is adjusted to repeat certain materials, return to previously-delivered materials, advance to a further point if good progress is shown, delivery supplemental materials, and various other features.

Accordingly, the present application is disclosing a system and method for training and reinforcement that not only serves as a suitable automated alternative to classroom type training, but also provides a mechanism for simultaneously managing the development status of employees.

Further aspects of the disclosure relate to an interactive computer-based system through which trainees can receive learning-specific and task-specific instructional content such that an employee can be easily and competently trained to work in a particular job. Advantageously, aspects of the disclosure describe systems and methods whereby trainees can additionally receive such task or activity specific training in the form of interactive multi-media instructional content delivered on an individual basis via stand-alone computer or mobile applications.

Additionally, further aspects of the disclosure describe a system and method for managing the current status of the development of the employee, wherein the records of each employee are stored in a centralized data bank.

To achieve the goals of improvement, the disclosed systems for computer-aided training include a central network having an electronically accessible storage media, a server, and software run by the server. The system further includes client devices (such as personal computers or mobile applications like smartphone/tablet) that serve as automated training units, which are electronically connected to the central network. The software running on the central network server is adapted to push and receive digital content/results for and from the employees.

One embodiment comprises a system designed to continuously deliver training materials to participants during a pre-determined period of time. The system uses push technology to teach, train, and at the same time analyze and motivate trainees. The system automatically sends, on predetermined days and times, a variety of different types of messages: videos, emails, pdf files, text messages, photos, audio files, and any other file types, to an unlimited number of trainees via an app to their mobile device, tablet or computer.

The system uses the data it collects from the participants so that relevant results information is loaded into a central database (accessible via the Internet) such that the current status (name, date, results, etc.) can be searched and monitored. In this manner, the training responsibilities for a large organization can be more easily administered. The system analyzes the performance and/or skill level of each trainee and redirects learning materials to trainees based on their progress. The system includes a reporting tool that can generate a variety of different reports on trainees or certain groups of trainees. The cloud based software allows customers to completely self manage the process of trainees' entry, content entry, time line creation and use of analytical tool.

Thus, preferred embodiments and aspects of the described system and methods provide for creating training scenario(s) whereby users may enhance their understanding of relevant information delivered as training materials or program. In an exemplary embodiment, sales trainings scenario(s) may be created that allow sales representatives to gain a better understanding of a company's products and services, and through scenario interactivity, provide such sales representatives with a better understanding as to how to effectively identify and communicate appropriate proposals/solutions to potential customers/third parties based upon relevant information. Training scenario(s) created according to the present invention may also function as a resource for users seeking guidance in their personal/professional situations and/or function as a training reinforcement tool that may, in the case of sales representatives, help to increase sales revenues and/or margins by establishing a better educated, more selective, direct and indirect sales force. As a result, the educational/training content associated with exemplary scenario(s) created and implemented according to the present disclosure advantageously enables sales personnel to focus their time and energies on prospects with a greater likelihood of purchasing the relevant products and services.

Aspects of the system and methods provide administrative users (“administrators”) the ability to create realistic, didactical training timelines in an easy, efficient and timely manner. The training timelines may be used for a wide variety of educational/training purposes, for example sales training, customer service training, safety training, behavior change training, and the like. It is contemplated that the disclosed system and method may be utilized to create highly effective educational/training modules and scenarios for use in all evaluative and/or communicative fields, including but not limited to developing problem solving skills, socialization skills, interviewing skills, negotiating skills, and pre-employment qualification assessment and analysis.

The potential fields of uses and applications of the described method/system are essentially limitless.

The interactive system provides various degrees of customization. For example, the training content for each customer (e.g. an organization or business entity) may be designed to show video clips of the particular job in which a trainee will be working such that the particular nuances and requirements of each skill can be easily explained and understood. Furthermore, the other content, like PDF files, texts or pictures are customizable to each customer. Additionally, the manner in which the questions are created can be modified for each situation. For example, a passing score for a training session could be based on getting a percentage of questions correct for all question categories, or a minimum number of questions correct. Consequently, if the trainee does not meet a passing score and the minimum number of questions is not answered correctly, then appropriate content, such as for example a specific video clip with the content on which the trainee scored poorly, could be automatically pushed to the trainee and the questions regenerated until the trainee passes the score.

Features and aspects of systems and methods according to the present disclosure will be discussed in more detail below with respect to the drawings and description of several embodiments. Additional features and functions of the disclosed system and method will be apparent from the detailed description that follows. It should be understood that the forthcoming description is merely illustrative and is by no means limitative of the invention as claimed, which is intended to be reflected in the claims.

### BRIEF DESCRIPTION OF THE DRAWING FIGURE(S)

So that those of ordinary skill in the art to which the subject matter pertains will more readily understand how to construct and use the method/system of the present disclosure, reference may be had to the following figures and the accompanying detailed description, wherein:

FIG. 1 is an overview block diagram of a system constructed in accordance with the present disclosure.

FIG. 2, consisting of FIGS. 2A and 2B, is a Screenshot of a Login process and a Flowchart of a Login Setup Process, respectively.

FIG. 3 is a Screenshot for a Create Training process.

FIG. 4 is a Flowchart for a Setup Process related to the Create Training process.

FIG. 5 is a Screenshot for an Add Head Trainer process.

FIG. 6 is Flowchart for the Add Head Trainer process.

FIG. 7 is a Screenshot for an Add Trainer process.

FIG. 8 is a Flowchart for the Add Trainer process.

FIG. 9 is a Screenshot for an Add Participant process.

FIG. 10 is a Flowchart for the Add Participant process.

FIG. 11, consisting of FIGS. 11A-11G, are Screenshots that illustrate various aspects involved with a process to Create Question Categories.

FIG. 12 is a Screenshot for an Add Questions process.

FIG. 13 is a Flowchart for the Add Questions process.

FIG. 14 is a Screenshot for an Add Additional Media process.

FIG. 15 is a Flowchart for the Add Additional Media process.

FIG. 16, consisting of FIGS. 16A-16G, are Screenshots showing aspects of an Add Timeline process.

FIG. 17 is a Screenshot illustrating Available Media for the Add Timeline process.

FIG. 18 is a Screenshot illustrating Add Message for the Add Time Timeline process.

FIG. 19 is a Flowchart for the Add Timeline process.

FIG. 20 is a Flowchart for a Reinforcement Score process.

FIG. 21 is a Flowchart for a Triggers process.

FIG. 22 is a diagram illustrating a Conceptual model for Re-training timeline types.

FIG. 23 is a Sequence diagram illustrating a parallel re-training timeline process.

FIG. 24 is a Sequence diagram illustrating insertion of re-training timeline.

FIG. 25 is a Sequence diagram illustrating override of a re-training timeline.

FIG. 26 is a Flow chart of a process for determining a Reinforcement score for re-training timeline messages.

FIG. 27 is a State Diagram of an Automatic Re-Training process.

FIG. 28 is a Screenshot for a Smartphone Login.

FIG. 29 is a Flowchart of a Login Delivery process.

FIG. 30 is a Flowchart of a Push Notification process.

FIG. 31 is a Flowchart of an SMS Notification process.

FIG. 32 is a Flowchart of an E-mail Notification process.

FIG. 33, consisting of FIGS. 33A and 33B, are Screenshots illustrating Processing Message in a smartphone App and in a web browser, respectively.

FIG. 34, consisting of FIGS. 34A and 34B, are Screenshots illustrating a Message with Question in a smartphone app and in a web browser, respectively.

FIG. 35 is a Flowchart for a Reading and Processing Content process.

FIG. 36 is a Screenshot of a Login process.

FIG. 37 a Flowchart for the Login process.

FIG. 38 is a Screenshot illustrating a Statistics process.

FIG. 39 is a Flowchart of the Statistics process.

FIG. 40 is a Screenshot of an Analyses process.

FIG. 41 is a Flowchart of the Analyses process.

### DETAILED DESCRIPTION

Turning now to the drawings, in which like reference numerals indicated like elements or steps or components or characteristics throughout the several drawing figures, a system constructed in accordance with various aspects of the present disclosure comprise three processes that collectively form one exemplary embodiment:

1. Setup process

2. Delivery process

3. Evaluation process

As used herein, the term “Mindmarker” is a trademark of the applicant, but applicant and his or its successors reserve the right to utilize other trademarks in connection with aspects of the described system and methods, and no limitation is intended by use of the trademarked term. On occasion, as the context may suggest, without prejudice to trademark rights, the term “Mindmarker” may refer to a system and method that effects the various processes, features, and aspects of this disclosure.

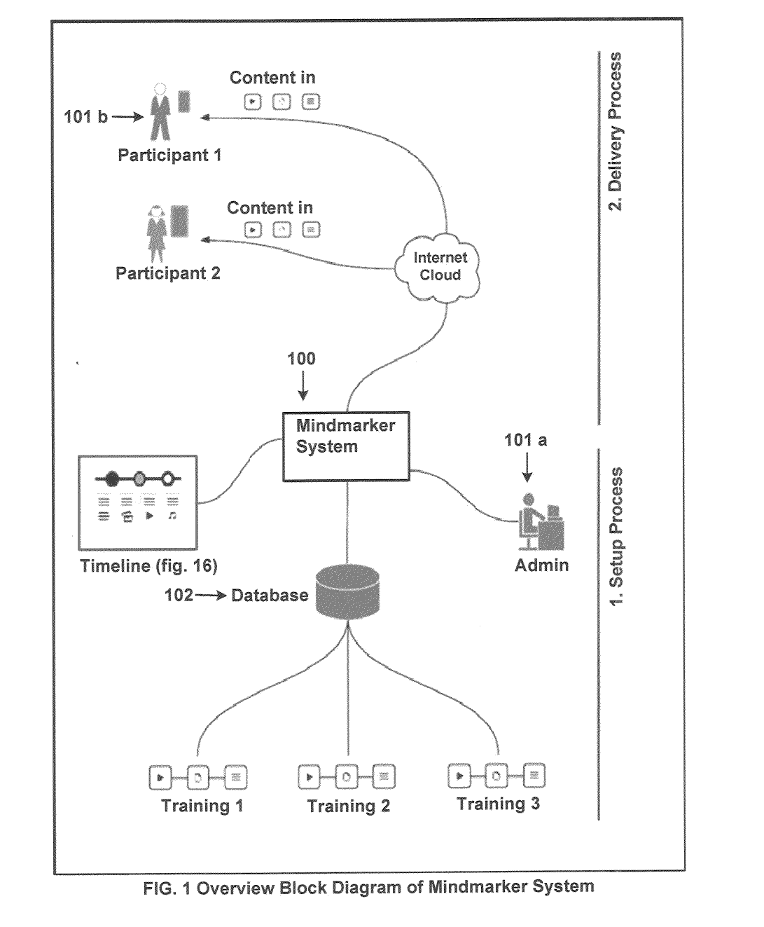

FIG. 1 is an overview of one embodiment of a system 100 and how it interacts between users 101, system, and a database 102. Multiple training programs are stored in the database. Each training (or “training program”) comprises various types of media files. The system 100 is connected to the database 102 and transfers data from and to the database. A user 101a who is an administrator is connected to the system via a computer device, tablet, or mobile device. The system 100 is connected to the various participants via the internet/cloud. Users 101b who are participants will receive the training material (messages) on times and dates as defined in the time line. The participants will receive the messages from the system on their mobile device (mobile phone or tablet) or computer.

According to one aspect, participants receive multiple messages of various kinds and types (videos, pdf files, audio, text messages, questions, surveys, pictures, links to external web services etc.). The participants interact with the system via the cloud/internet. Participants typically receive electronic notifications that content (e.g. messages) are available. The participant will complete messages (e.g. view content, etc.) and provide answers to various questions and surveys. These answers will be sent to the system and transferred to the database. The administrator will access the database through the system to analyze the answers and create reporting on progress and performance of he participants. The system will also keep score and analyze the answers received from the participants and redirect learning material based upon the scores of the participants. If the score of a participant is lower than the norm set, the system will adjust the notification frequency, send training materials (messages), of a pre-defined re-training program to this participant on the specific topic area of low scoring.

1. Setup Process

1.1. Login

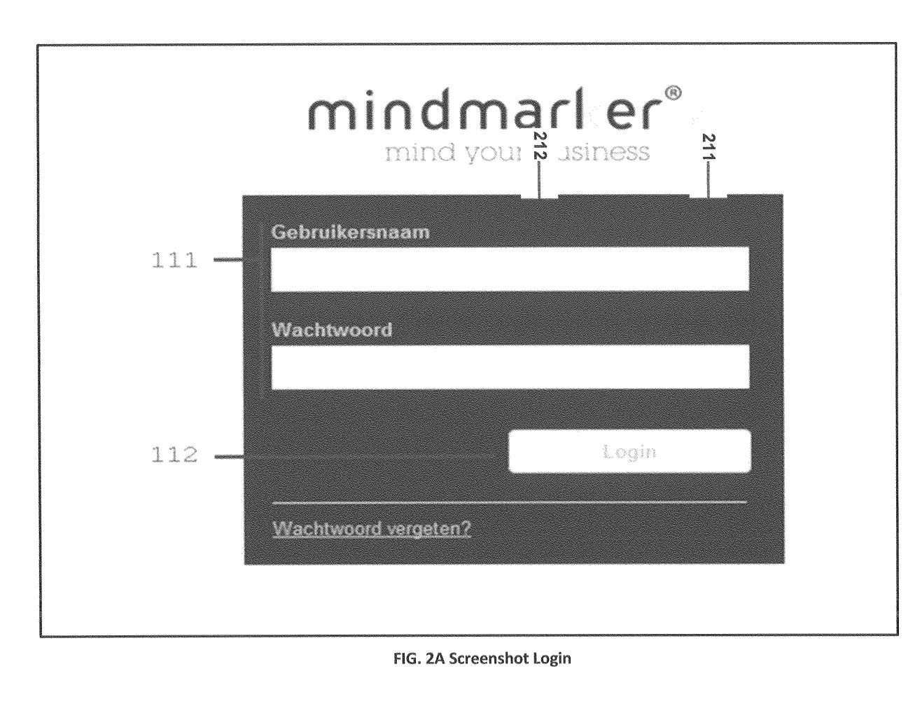

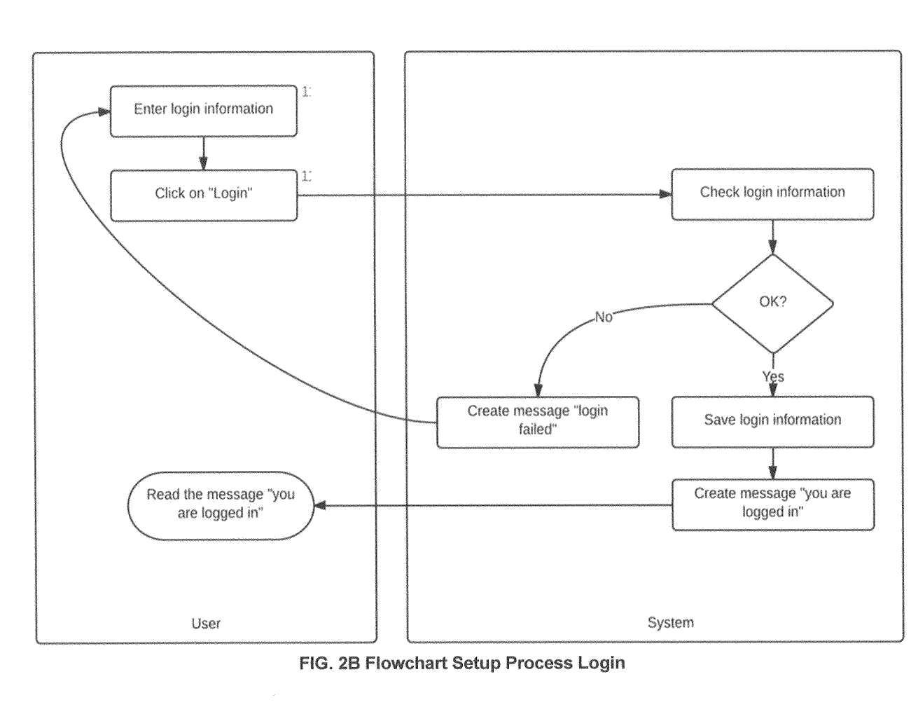

Turning now to FIG. 2A, the system 100 creates a login form and sends this to the administrator via the internet. The system administrator creates a company account using the steps as described in section 1.3. Before a training can be created in the system, a person responsible for creating the trainer (in 1.1 referred to as “user”) has to login into the system. The user completes the login form with the login information that has been created and provided by the administrator of the system. This information consists of two pieces of data (1) username and (2) password. The user completes the form with this data in the appropriate data fields (111). Once the username and password have been entered into the appropriate data fields, the head trainer either uses a mouse to click or if the user uses a touch screen, uses a finger to select the ‘login’ field (112). Once the user has selected the login field, the system checks if the entered data is correct, using the following criteria:
Does the database recognize the entered username?
Does the password code match the password code that is stored in the database?
Is the specific user authorized to login into the system?

Each user has its own unique number in the database. If the above described validation process has been successful, the system connects the IP address, which the user used to connect to the system and to login, to the unique number that was assigned to this specific user. This allows the system and the user to know that the user is logged in. The system will provide a message to the user on screen stating that login has been successful.

If the above described validation has not been successful, the system will generate a message to the user on screen stating that login has failed as a result of incorrect login data. To protect the system from any unauthorized login activity, the system does not state in its message which one of the three validation criteria caused the failure of the login process.

The above described login procedure is similar for the login of any other type of user to the system.

FIG. 2B shows the flowchart illustrating the above process.

1.2. Create a Training

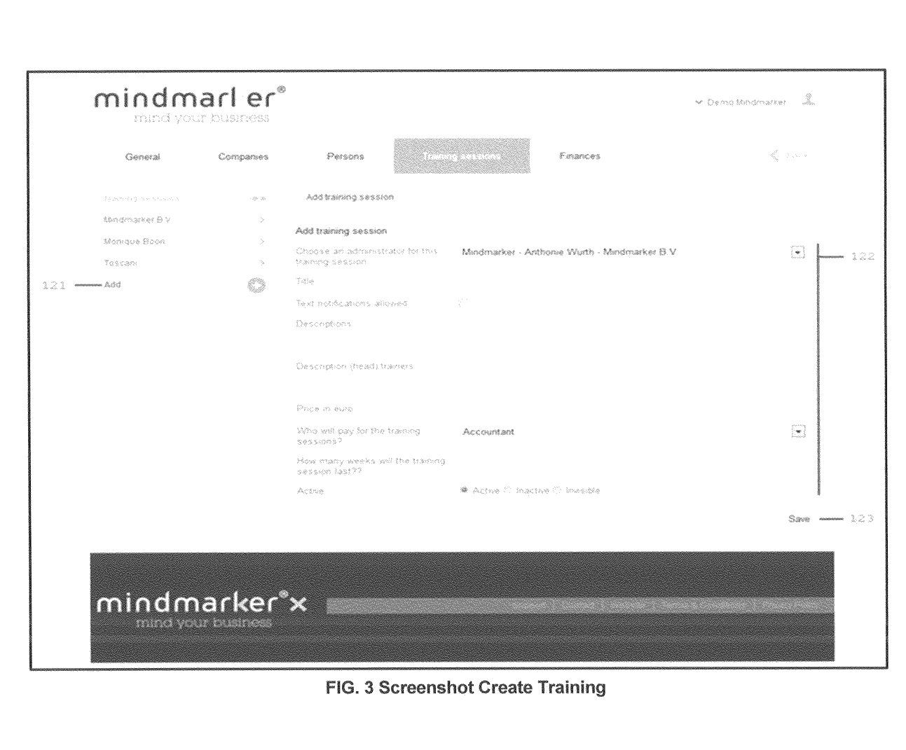

Referring now to FIG. 3, once the user has successfully logged in, a training can be created. From the menu on the screen the user selects the data field “Training Sessions” (shown as a dark button in FIG. 3). The user selects the field “Add” (121) to create a training. The system will then load and show a form (122) on screen, which has to be completed with the details of the training. The user completes the required fields on the form and selects the “Save” (123) button. This will send the data that was entered into the form to the system and the system checks if all fields have been completed correctly. If any field has not been completed, has been completed incorrectly, or has missing information the system will issue a message to the user stating what the problem is. The user receives this message on screen and can correct the problem in the form. Once the form has been completed without any errors or missing information, the system will save the entered data in the central database. The training that has been created by the user will be linked to the user in the database. The system will generate a message to the user on screen stating that the training has been successfully created.

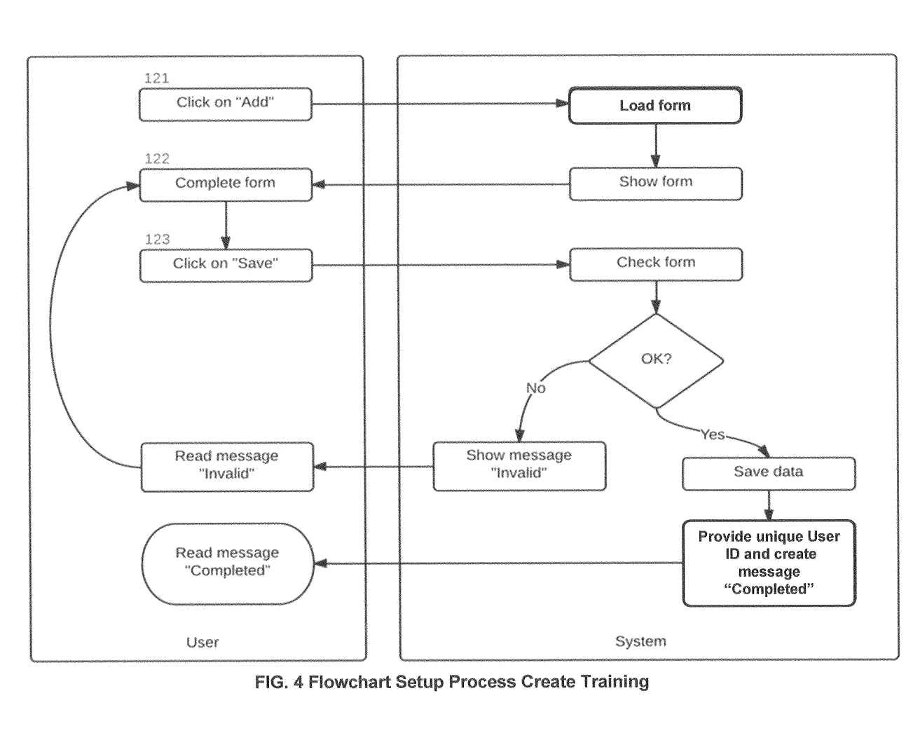

FIG. 4 shows the flowchart illustrating the above process.

1.3. Adding a Head Trainer/Program Planner

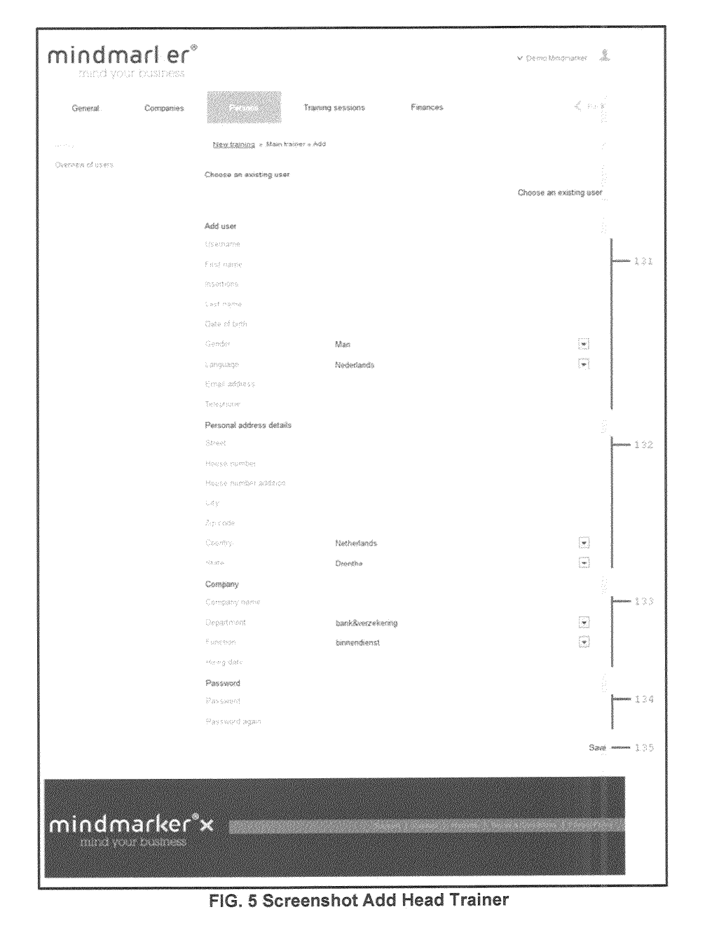

Referring now to FIG. 5, once the training has been successfully created, the user can start the process of adding content and participants to the training To complete the training set up, the user needs to add details in the system with regards to the head trainer, possible additional trainers, number of participants, details about participants, training materials and complete the timeline. A person such as a trainer who creates a training program may be considered a program planner.

From the menu on the screen the user selects the data field “Persons” (shown as a dark button in FIG. 5). By selecting the “Add” button on the screen of the user, the user can add a head trainer or one or more additional trainers.

On the screen the user selects the button “add head trainer” and the system will show on screen a form as shown in FIG. 5. The user will complete the following data related to the head trainer:

User data (131) such as username, first name, middle initial, last name, date of birth, gender, preferred language, email address and (mobile) phone number. Address details (132) such as street name, house number, address line 2, town/city, state, zip code and country. Company details (133) created by the administrator in the system such as for example company name, department, function and starting work date (attributes). And a password (134) may be added.

Once all fields have been completed and data has been entered the user selects the “Save” button on the screen (135).

This will send the data that was entered into the form to the system. The system checks if the form has been completed correctly and if the form has been completed correctly the data will be stored in the central database. In the database the system links the new user to the training and the system stores that this new user is classified as head trainer.

If the form has not been completed correctly or there is missing information, the system will send a message to the user on its screen notifying that the form was not completed correctly. The fields that were entered incorrectly or had missing information will show up in red indicating to the user that these fields were not completed correctly and that these fields should be corrected or completed. The user will correct the form and select the “save” button again to send the form to the system, which will again check the form.

Once the form has been completed correctly and the head trainer has been added to the training, the user will receive a screen message from the system informing the user that the head trainer has been successfully added.

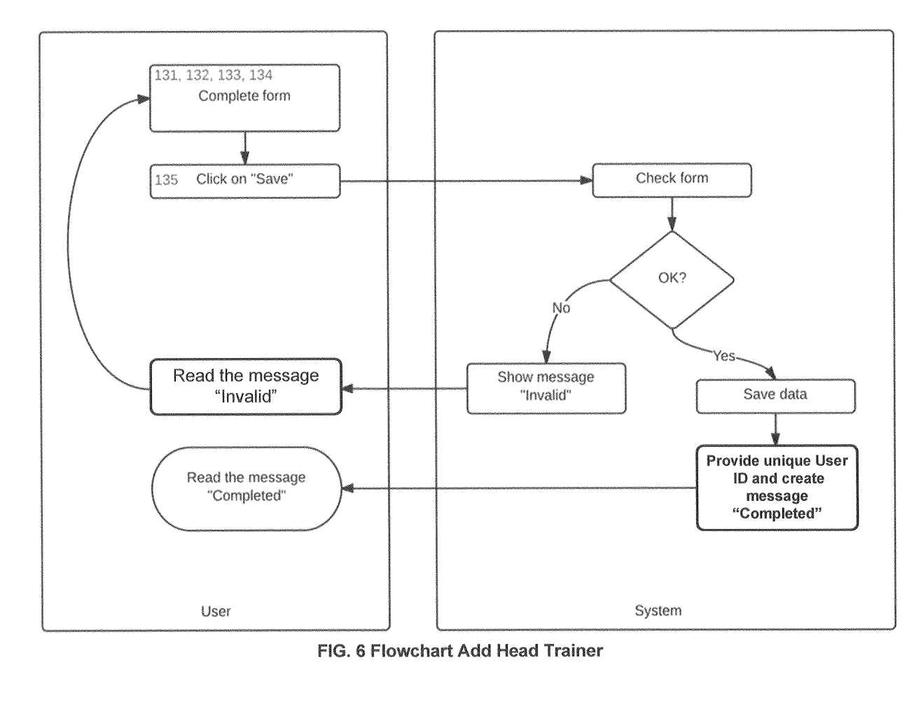

FIG. 6 shows a flowchart illustrating the above process.

1.4. Adding a Trainer

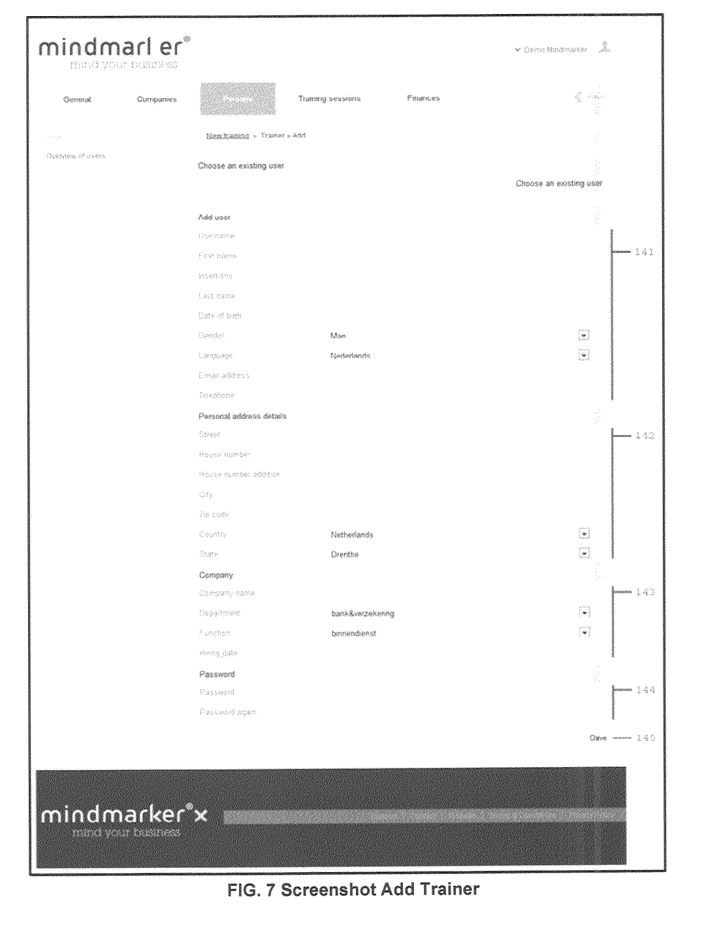

Referring now to FIG. 7, besides the ability to assign a head trainer to training, the system also has the capability to assign one or more trainers to a training. The key difference between the responsibilities of a head trainer and a trainer is that a head trainer is responsible for the content and time line of the training and the trainers are responsible for coaching, monitoring and support of the participants of the training

To add a trainer, the user selects the field “add trainer” on the screen upon which the system will show a form as is shown in FIG. 7 on the screen of the user. The user completes the form with the following trainer data: user data (141) such as such as username, first name, middle initial, last name, date of birth, gender, preferred language, email address and (mobile) phone number. Address details (142) such as street name, house number, address line 2, town/city, state, zip code and country. Company details (143) created by the administrator in the system such as for example company name, department, function, and starting work date (attributes). And a password (144) may be added.

Once all fields have been completed and data has been entered the user selects the “Save” button on the screen (145). This will send the data that was entered into the form to the system. The system checks if the form has been completed correctly and if the form has been completed correctly the data will be stored in the central database. In the database the system links the new user to the training and the system stores that this new user is classified as trainer.

If the form has not been completed correctly or there is missing information, the system will send a message to the user on its screen notifying that the form was not completed correctly. The fields that were entered incorrectly or had missing information will show up in red indicating to the user that these fields were not completed correctly and that these fields should be corrected or completed. The user will correct the form and select the “save” button again to send the form to the system, which will again check the form. Once the form has been completed correctly and the head trainer has been added to the training, the user will receive a screen message from the system informing the user that the trainer has been successfully added.

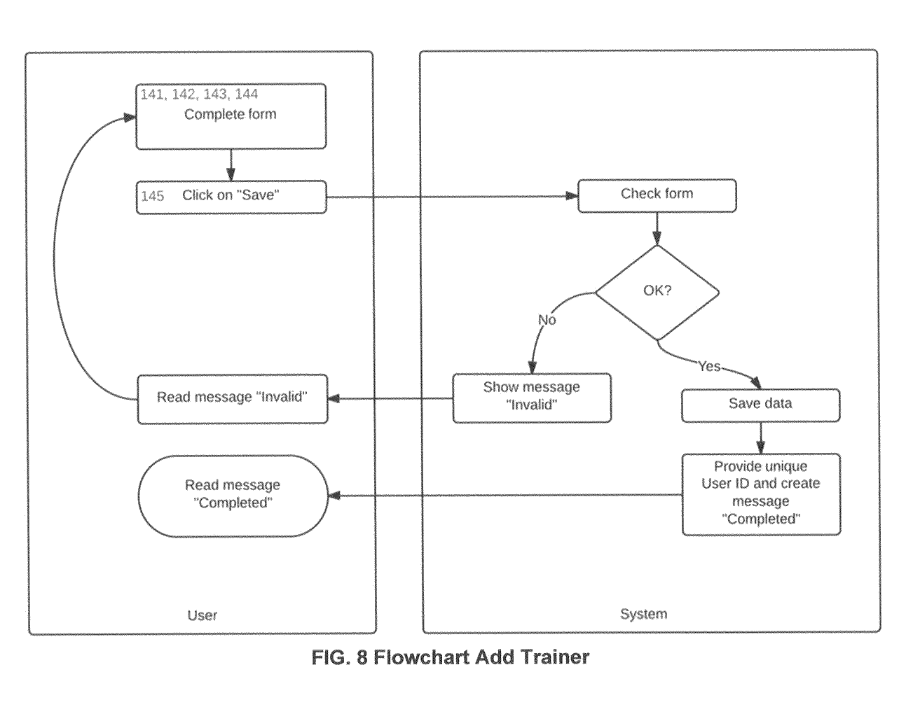

FIG. 8 shows a flowchart illustrating the above process.

1.5. Adding Participant(s)

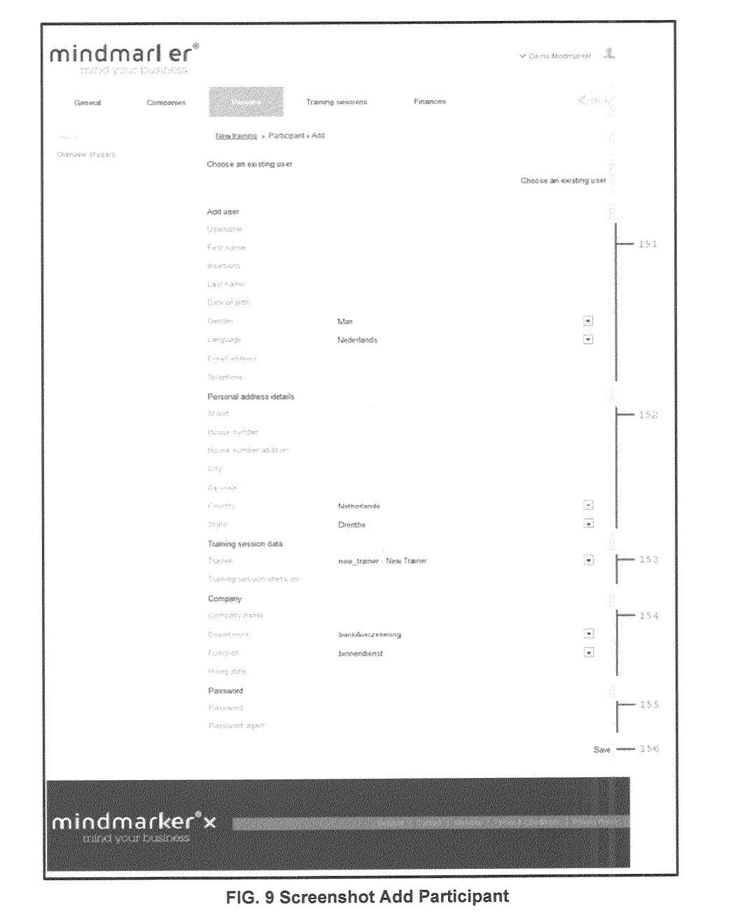

Referring now to FIG. 9, once the user has assigned a head trainer and possibly one or more trainers see 1.3 and 1.4, the user can add participants to the system. To add participants to the training, the user selects the field “add participant” on the screen upon which the system will show a form as is shown in FIG. 9 on the screen of the user.

The user completes the form with the following participant data: user data (151) such as username, first name, middle initial, last name, date of birth, gender, preferred language, email address and (mobile) phone number. Address details (152) such as street name, house number, address line 2, town/city, state, zip code and country. Company details (153) created by the administrator in the system such as for example company name, department, function, and starting work date (attributes). Training details (154) such as who is the responsible trainer for this participant and on which date the training will start. And a password (155) may be added.

Once all fields have been completed and data has been entered the user selects the “Save” button on the screen (156). This will send the data that was entered into the form to the system. The system checks if the form has been completed correctly and if the form has been completed correctly the data will be stored in the central database. In the database the system links the new participant to the training and the system stores that this new user is classified as participant.

If the form has not been completed correctly or there is missing information, the system will send a message to the user on its screen notifying that the form was not completed correctly. The fields that were entered incorrectly or had missing information will show up in red indicating to the user that these fields were not completed correctly and that these fields should be corrected or completed. The user will correct the form and select the “save” button again to send the form to the system, which will again check the form.

Once the form has been completed correctly and the head trainer has been added to the training, the user will receive a screen message from the system informing the user that the trainer has been successfully added. The system also allows the user upload participants from various files (of different type) that contain the details of the participants.

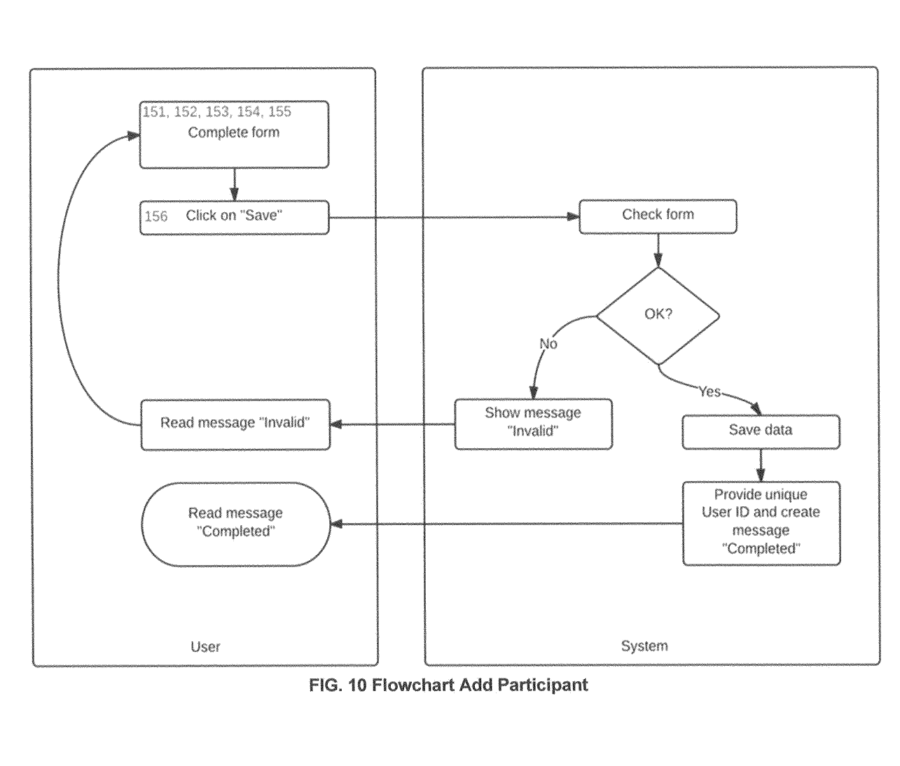

FIG. 10 shows a flowchart illustrating the above process.

1.6. Adding Questions

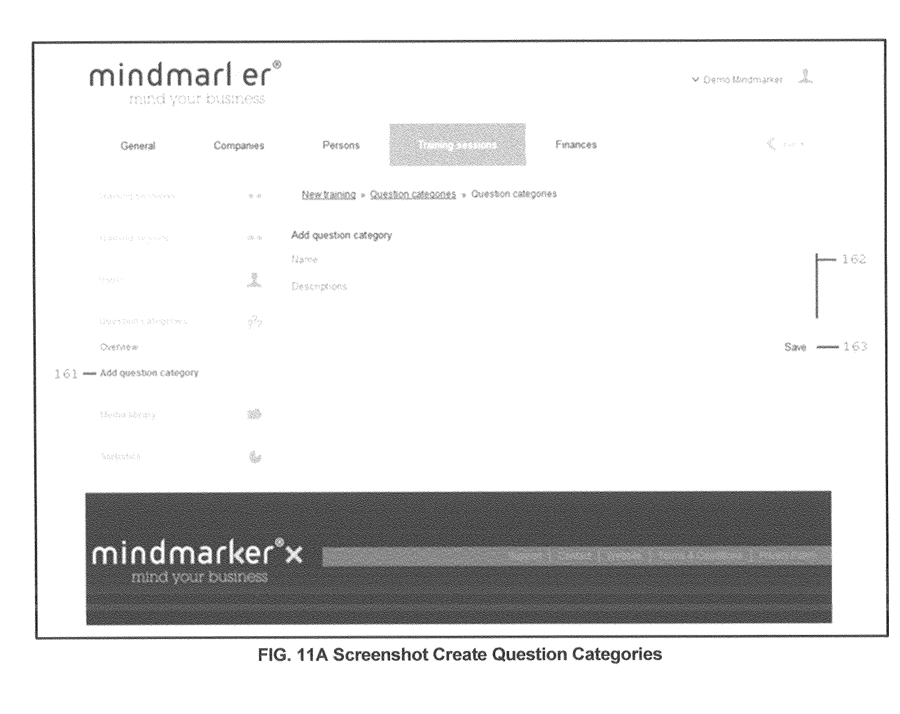

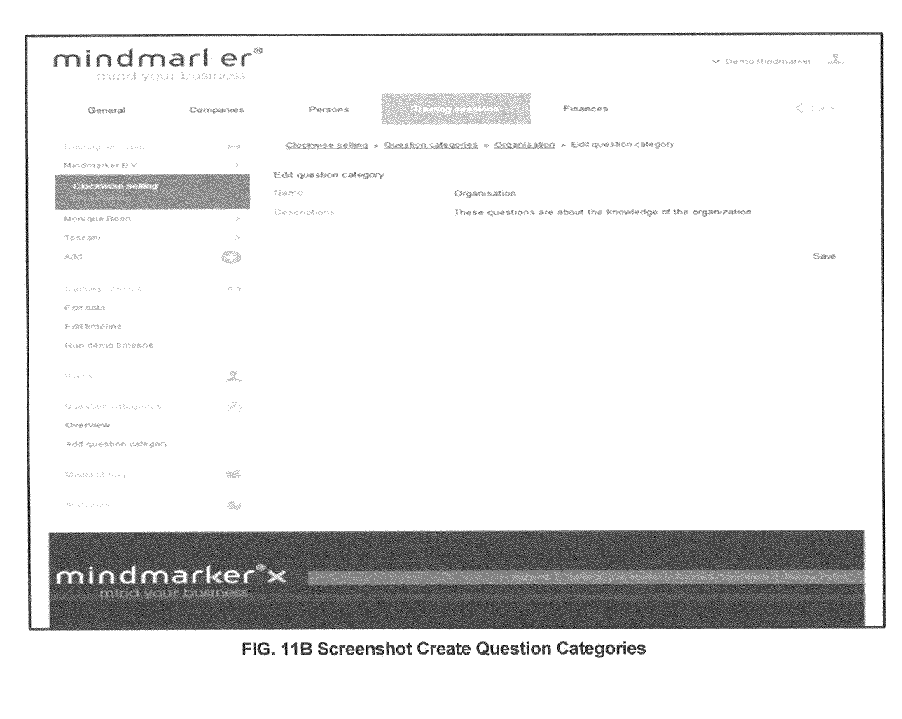

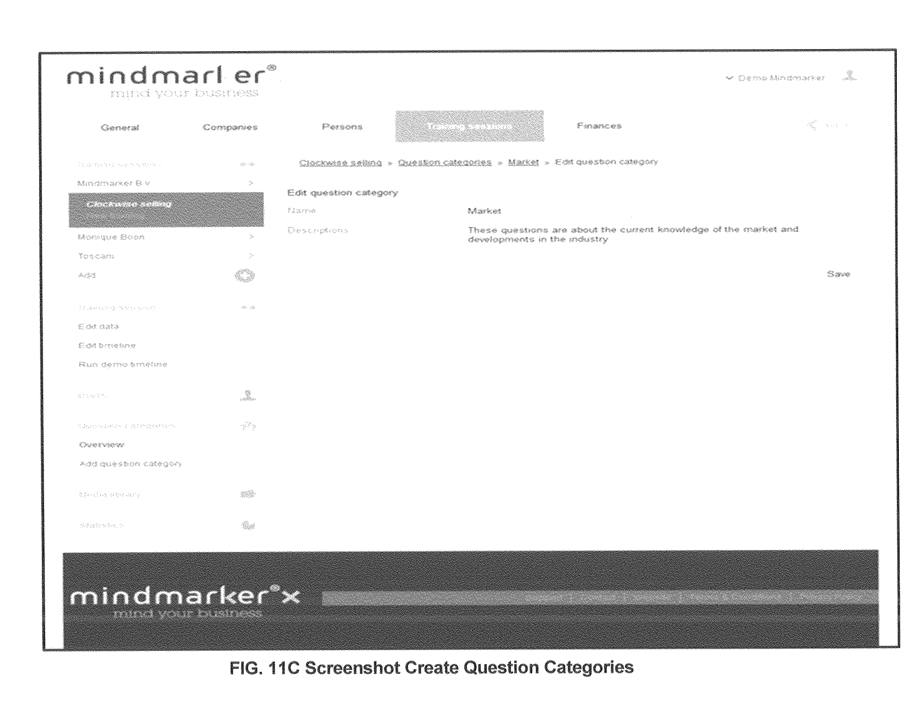

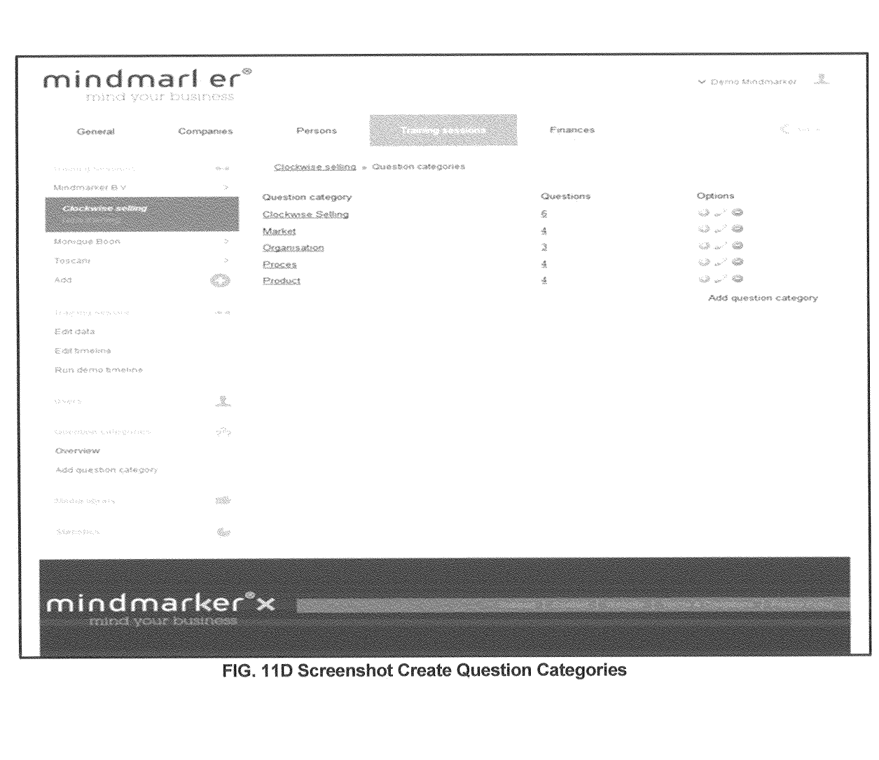

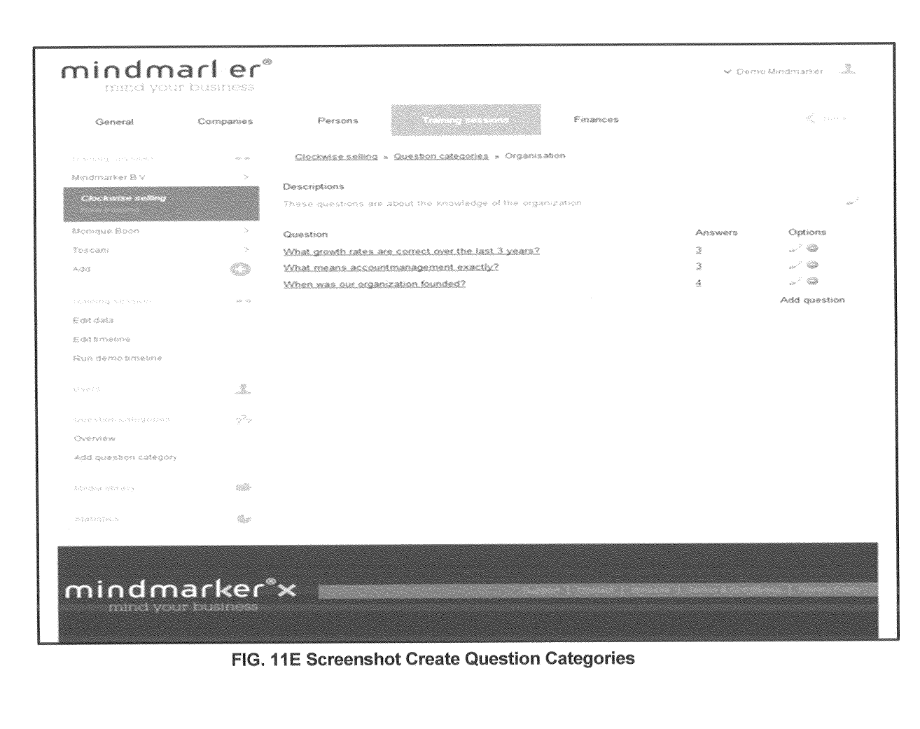

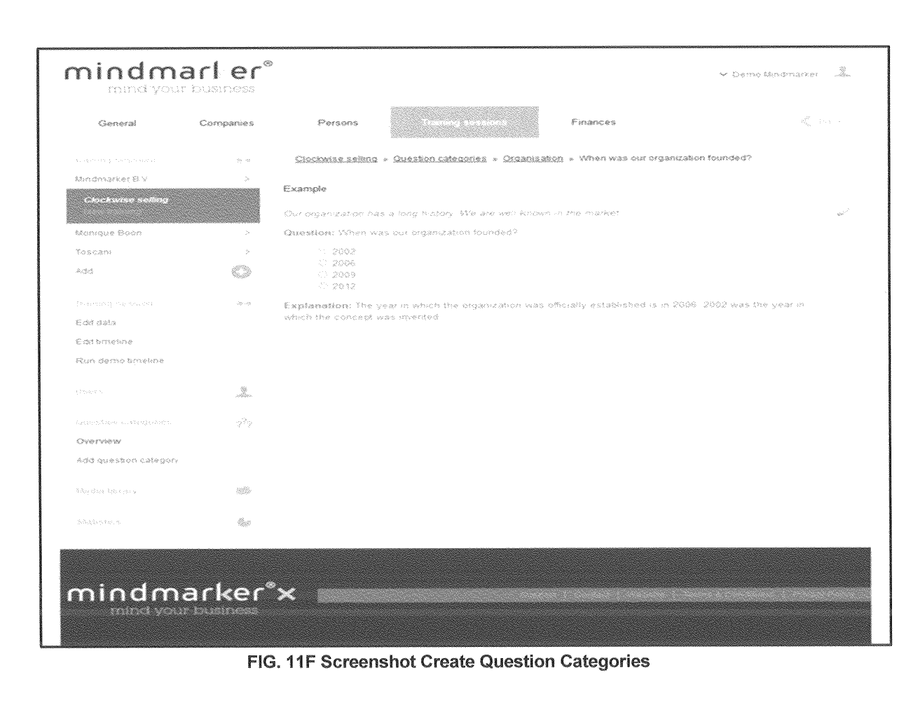

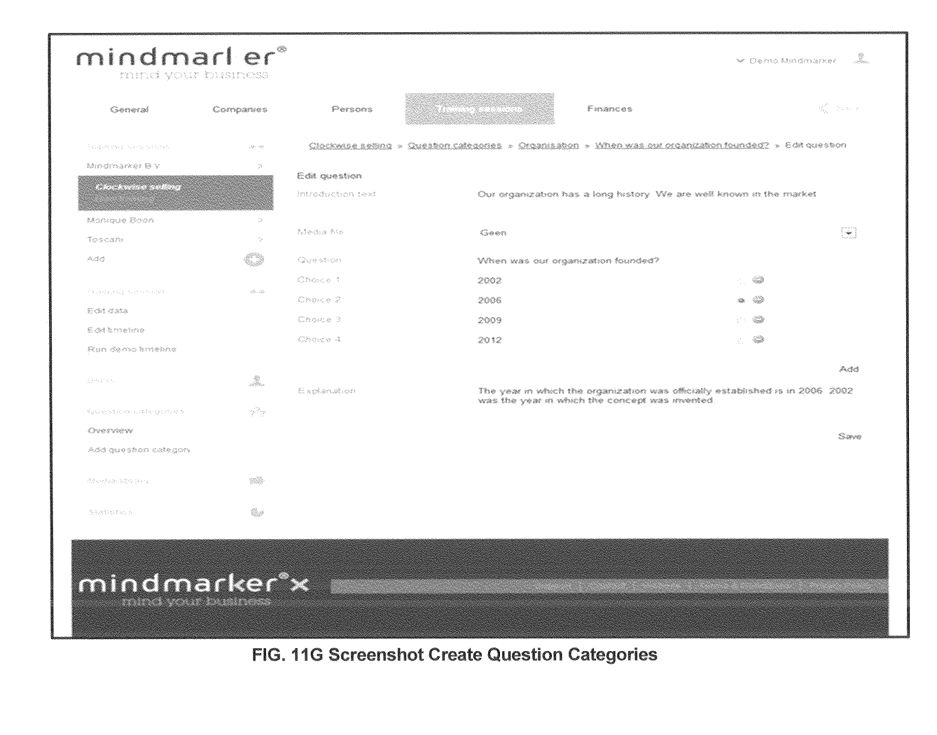

From a user point of view, the setting up of the training has now been completed. The training has been named, head trainer and trainer(s) assigned and the participants for this specific training have been loaded. Referring now to FIG. 11, the next step in the process is to add training content and a time line to the training Section1.6 describes how to add questions to the training and how to place these questions on the time line for the training Before a question can be added to the system, the user first needs to create question categories. Each question is has to be assigned to a question category.

To add a question category, the user selects the field “Add question category” (161) on the screen upon which the system will show a form as is shown in FIG. 11A on the screen of the user. The user completes the name of the question category and a description of the question category in the form (162) and selects “save” on the screen (163). The system saves this information in the database and the question category is linked in the database to the training Once the system has saved the question category in the database, the system will send a message to the screen of the user stating that the addition of the question category has been successful. In this message the system will ask the user if the user wants to add questions to this category at this time. The system allows the user to make multiple question categories by following the steps as described above.

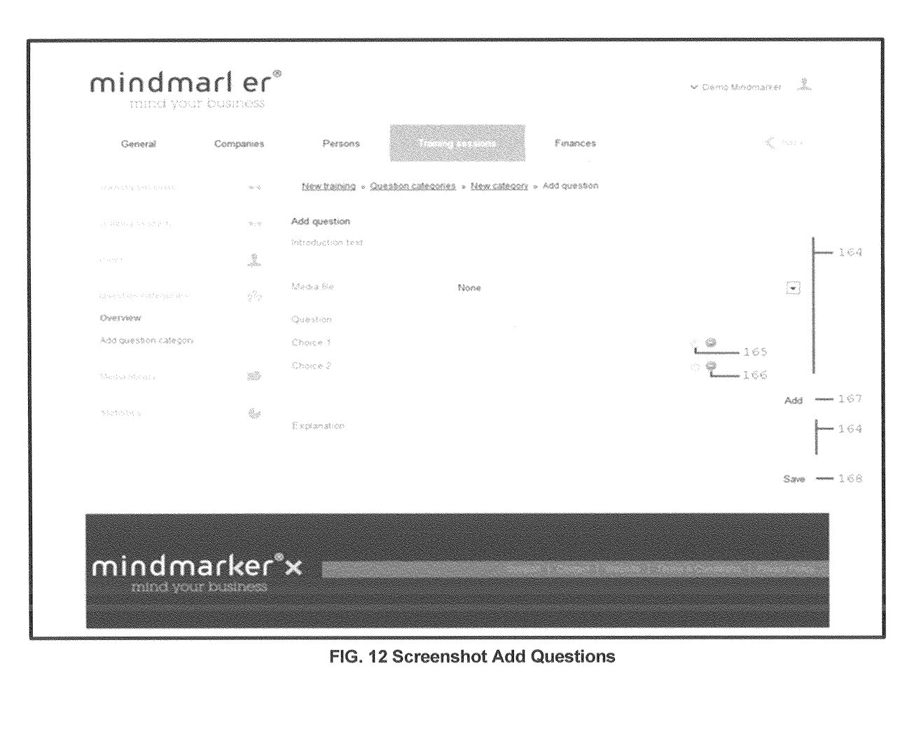

To create a question in the system the user selects “add question” from the screen as shown in FIG. 12 upon which the system will show the form as shown in FIG. 12 and the user completes the form as shown in FIG. 12 with the following data (164) such as an introduction text (which is a complementary piece of text to the question itself), a media file (is optional), that can be selected by the user using the drop down menu, such as a video file, audio file or image. The user further completes the form with the actual question and the possible answers (referred to as ‘choice1’ and ‘choice 2’ in FIG. 12.) to the question. Questions are multiple choices by nature, and the user will enter all the answers from which a participant can choose. The “Add” button labeled as (167) allows the user to add answer fields and complete these fields with additional answer choices.

The next step for the user is to mark which answer is the correct answer. The user uses clicks on the radio button right next to the correct answers (165) to mark the correct answer to the question. The user can also delete answers to a question by clicking on the delete button next to the question (166). In the field “Explanation” (164) the user can complete the text that the participant will receive after the participant has answered the question.

Typically this is used to show the participant after the participant has answered a question the correct answer and to provide an explanation of the answer to the participant.

Upon completion of the form, the user selects “Save” (168) and the data that has been entered in the form will be sent to the system. The system checks if the form has been completed correctly and if the form has been completed correctly the data will be stored in the central database. In the database the system links the question to the question category. The system will send a message to the screen of the user stating that the question has been successfully added to the category and will ask the user if the user would like to add another question.

If the form has not been completed correctly or has missing information the system will send a message to the screen of the user and opens the forms again on the screen of the user. The user then has the ability to check the forms and make the necessary adjustments. Once the user has made the corrections, the user selects the “save” button (168) and the data that has been entered in the form will be sent to the system. The system checks if the form has been completed correctly and if the form has been completed correctly the data will be stored in the central database. In the database the system links the question to the question category. The system will send a message to the screen of the user stating that the question has been successfully added to the category and will ask the user if the user would like to add another question.

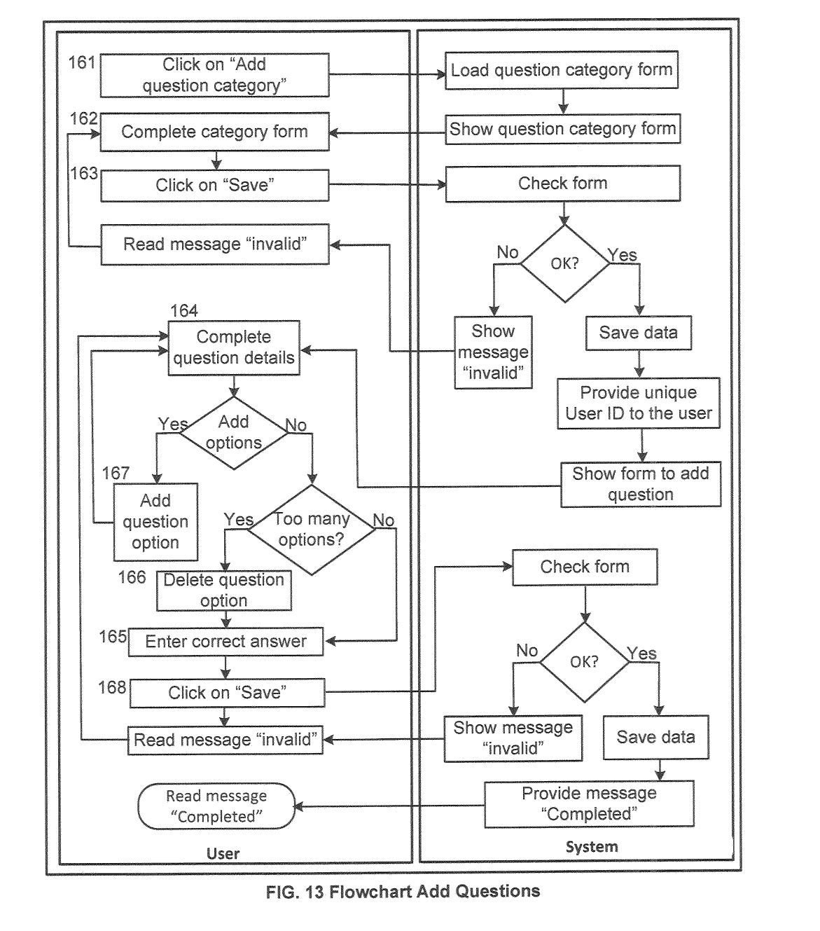

FIG. 13 shows a flowchart illustrating the above process.

FIGS. 11B through 11G provide examples of creating question categories. FIG. 11B shows how to create a question category by the user (see 162 in FIG. 11A). The user completes the name of the category e.g. “organization” and a short description of the question category, e.g. “These questions are about the knowledge of the organization.” In this example the user will create one more question category as shown in the screenshot shown in FIG. 11C. In this example, the user has created the category “Market” and has added the description “These questions are about the current knowledge of the market and developments in the industry.”

FIG. 11D shows a screenshot of the overview of the various question categories for this training in the system. The user will see this screen after the user has selected the “overview” button on the left hand side of the screen. In this case the overview shows the existing question categories with the two newly made categories “Organization” and “Market”. To the right hand side of the question categories, the user will see a number, which represents the number of questions in that specific category. The overview in FIG. 11D shows that the user has the possibility to add, change or remove questions from the specific question category. See section 1.6 and FIG. 12 for description on adding questions.

FIG. 11E shows the screen the user will receive from the system if the user selects the question category “Organization” as shown in FIG. 11D. This screen will show the user the various questions that have been created in this particular question category. In this case, the question category “Organization” has three different questions listed. This screen will also show the user how many answers each question has in the system. For example, the question “When was our organization founded?” shows that there are 4 different multiple-choice answers listed. If the user selects the actual question with the user's mouse, in this particular example, if the user clicks on “When was our organization founded?” the system will send a screen to the user as shown in FIG. 11F. FIG. 11F shows the user the complete introduction, question, answers, explanation (see 164 in FIG. 12) of this particular question. The user has the option to select the pencil on the right hand side of the screen upon which the system will send the following screen to the user FIG. 11G. This screen allows the user to make adjustments to the introduction text, question, answers and explanation. This screen allows the user to grant a weight to this question. For definition of these topics please refer to 1.6 and FIG. 12.

1.7. Add Additional Media

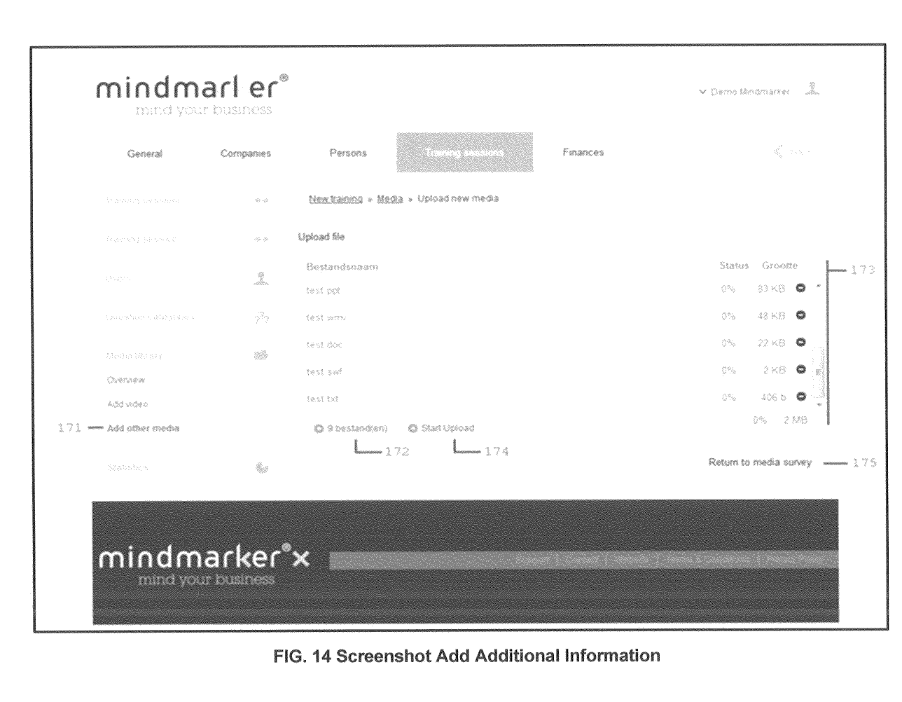

Turning now to FIG. 14, the user has the ability to upload additional media files of various types. The system uses a generic uploading tool which will determine what type of file (audio, video, image, pdf file or other) is being uploaded after the user has uploaded the file. The uploading tool allows the user to upload multiple files at the same time. To add a media file the user selects “Add other media” (171) as indicated in FIG. 14. The system will now upload the upload tool and will show the upload tool to the user on the user screen. The user selects the upload button on the screen (172), which will show the user on the user screen a selection tool for files. In this selection tool the user can specify what files the user wants to select to be uploaded. Once the user has selected the files, the selected files will appear on the screen of the user in the file overview (173). Once the user has selected all the files the user wants to upload, the user selects the “upload” button to start the uploading of the files.

Once the upload button has been selected, the files will be copied to the system. Upon receipt of the complete file(s) the system will store the file(s) in a secure environment. At this time, the system will analyze and determine what type of file has been uploaded. The file(s), including the information on the type of file, are stored in the system database and linked to the user, which will allow the user to possibly use these file(s) again in other trainings

Once all file(s) have been uploaded, the user selects “Return to Media Survey” (175) to return to the screen with the file overview.

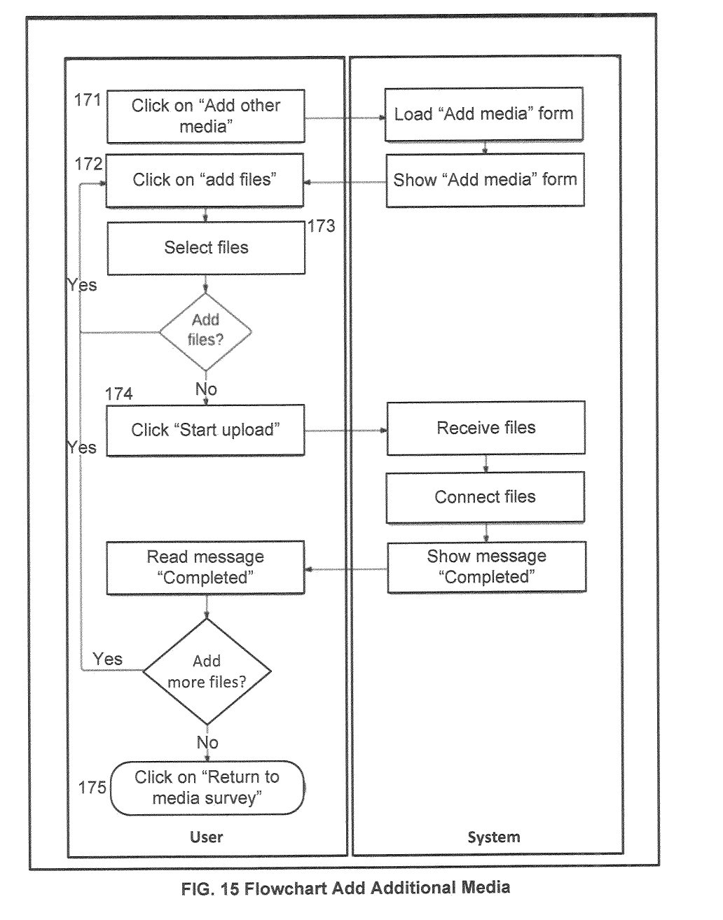

FIG. 15 shows a flowchart illustrating the above process

1.8. Adding Timeline

Once all questions and media files have been added to the system for the training, the questions and media files can be placed in the time line of the training Section 1.8 describes the process of how to place questions and media files in the training time line.

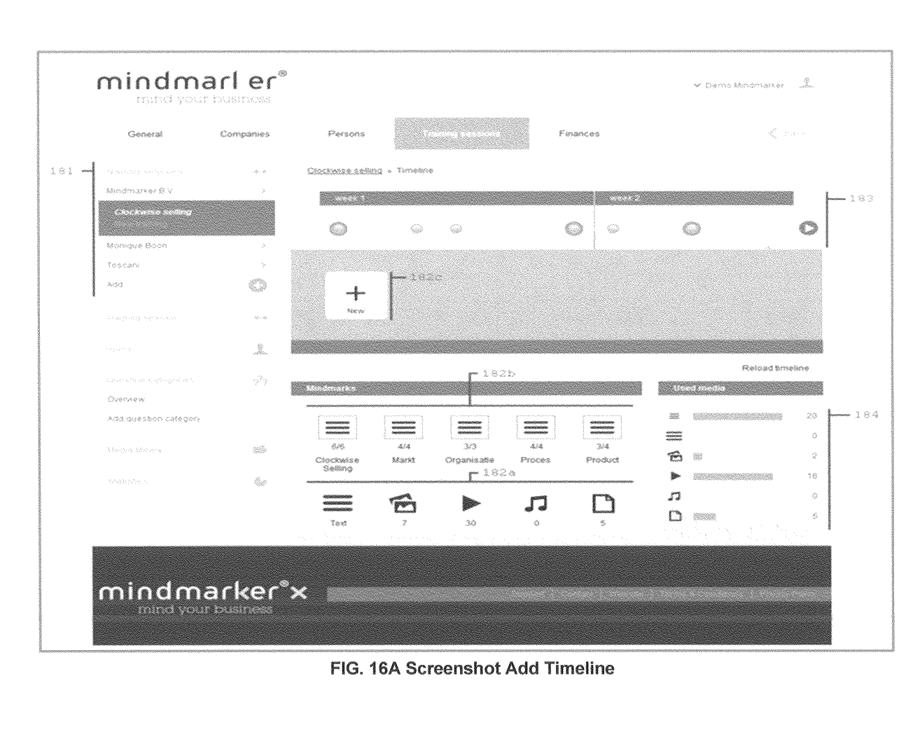

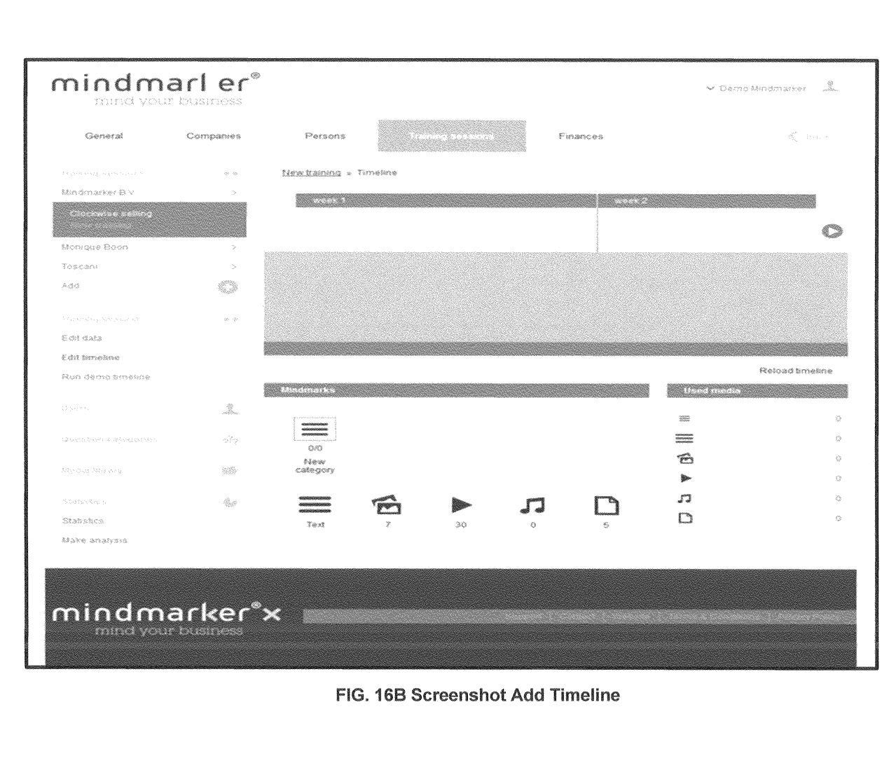

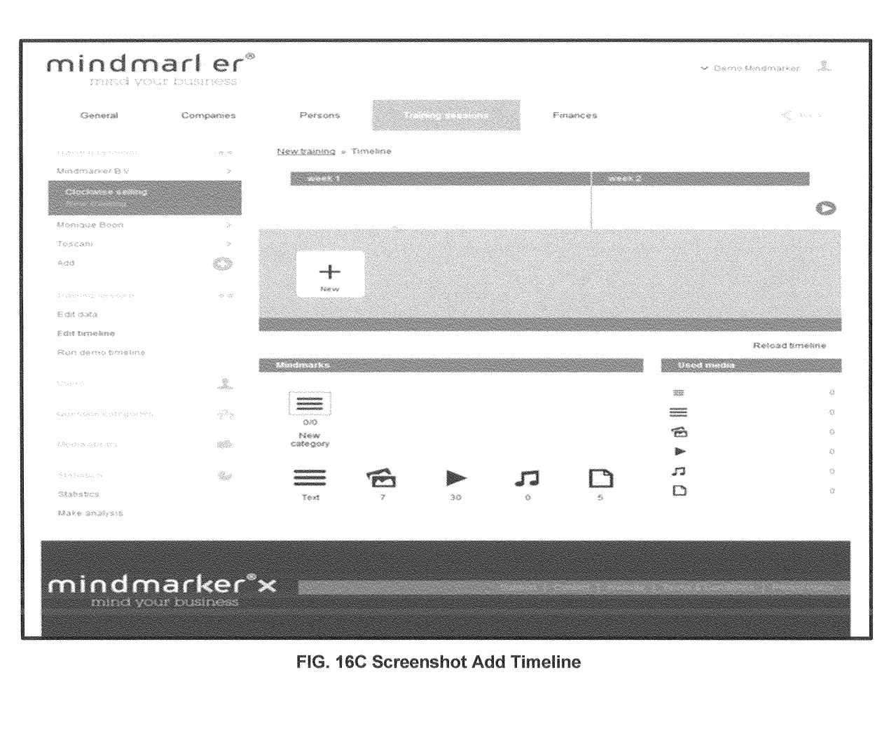

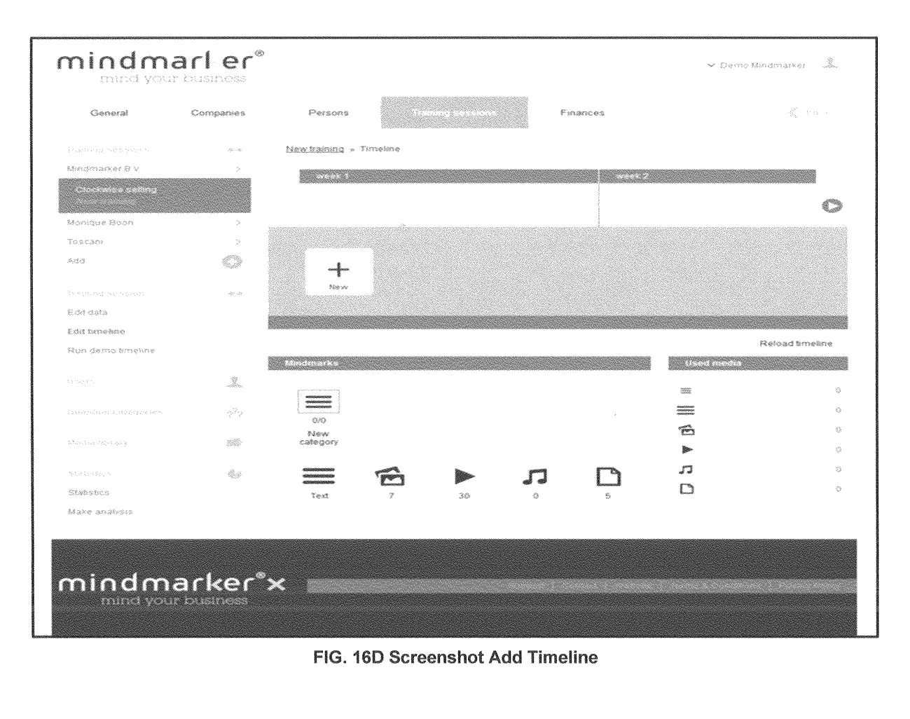

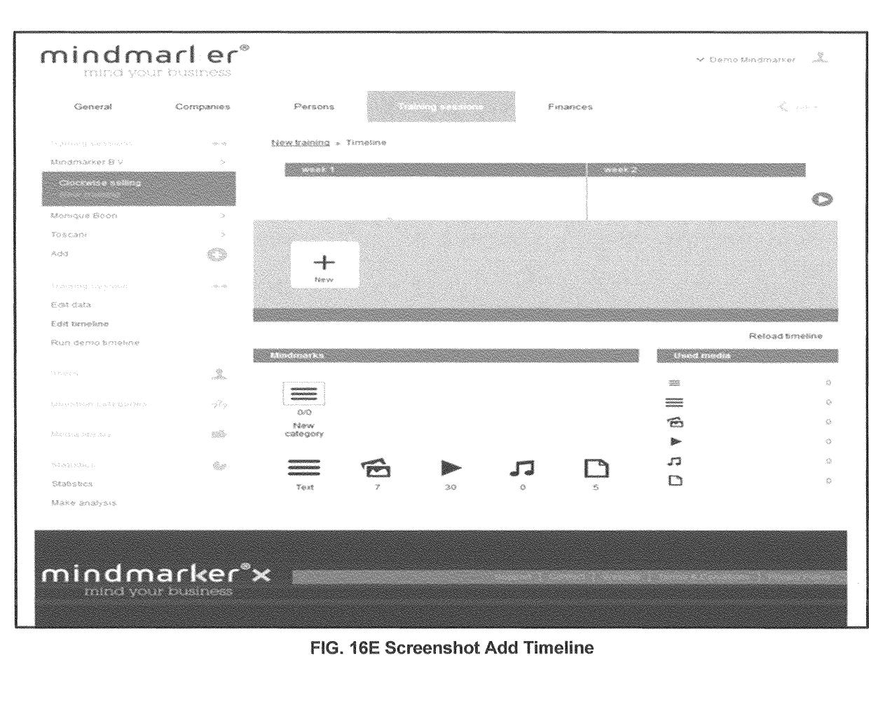

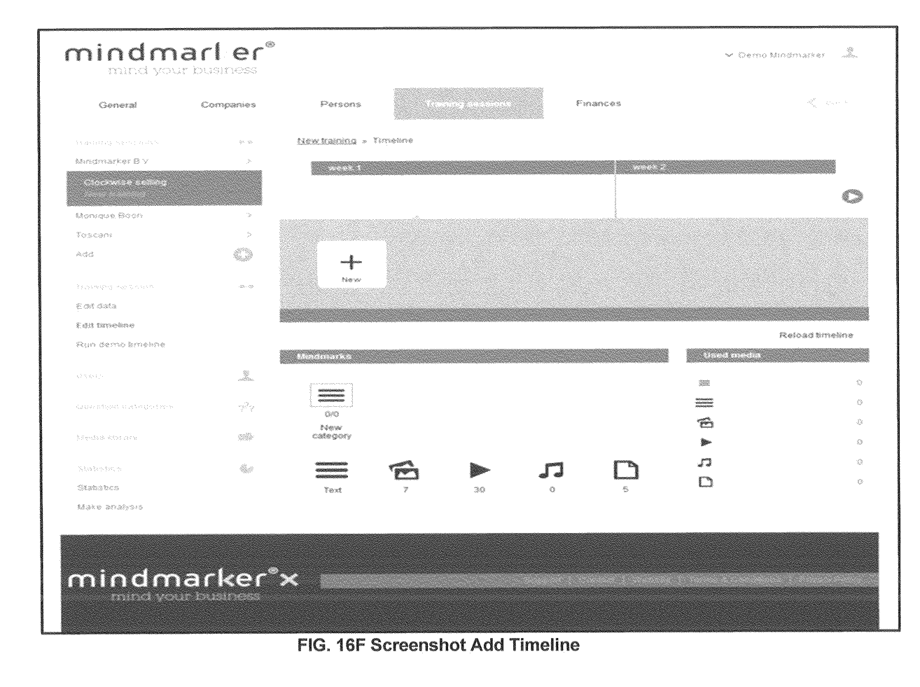

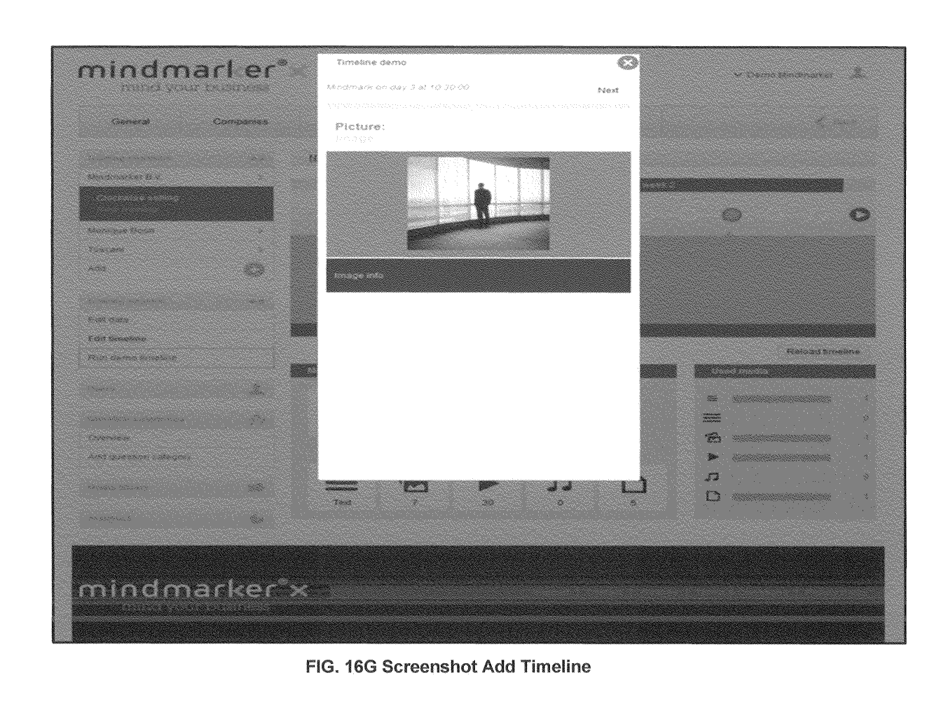

FIG. 16, consisting of FIGS. 16A through 16G, illustrate aspects of an Add Timeline process. To place content (questions and files) in a time line for a specific training, the user selects the training for which the user wants to complete the time line, see FIG. 16A (181). Once the user selects a training, the system will show the user a screen shot with the time lime for the selected training. This screen shots illustrates a time line (183); this is a graphic overview of the days in the training. A time line (also called herein a “timeline”) is a data set or construct stored in the system that represents time (e.g. day of week, time of day) for which specific content items (messages, questions, etc. of various forms described herein) are to be delivered to a participant.

For example, FIG. 16A shows a timeline 183 starting for week 1 and will increase in increments of 1 to week 2, week 3 etc. Each week has 7 days. The system allows the user to scroll through the time line using the right arrow on the right hand side and the left arrow on the left hand side of the time line.

Each day in the time line is represented by a circle (185). Each circle can be coded to reflect a certain priority status in the system. For example, a circle coded as white may indicate that there is no scheduled message to be delivered to the participant on that day. A circle coded as green may indicate that there is a scheduled message to be delivered to the participant on that day. A circle coded as green-gray may indicate that there is an important message scheduled to be delivered to the participant on that day

In the area on the screen called Mindmarkers (182a and 182b), the system displays the various materials that can be added to the time line of the training. The training material has been organized in question categories (182b) and additional media (182a). The system keeps track of how many questions have been added to the time line and if all the questions from a question category have been used. Once all questions of a certain category have been used, the user can no longer select questions from this category to be added to the time line. The system provides an overview of the available media files per file type, except for the file type “text” since these can be easily added during a training

The system provides an overview (184) of what file types and how many of these types have been selected to be used in the time line. This will allow the user to avoid using too many of one type or not enough of another type, and assisting the user to create a balanced training

The user can add questions and files in two different ways; (1) Dragging, the user moves the mouse to a question category (182b) or media file (182a), pushes and holds the left side of the mouse and drags the icon to the day on which this question or file must be sent to the participant(s) or (2) Clicking; the user clicks on a selected day in the time line (183). Once the user clicks on a day, the system will display an icon with “new” (182c). The user clicks with the mouse on this “new” icon and the system will display an overview with available media types (185) in FIG. 17. The user selects a file type by selecting it with the user mouse and to click on the selected file.

Upon completion of the above task(s) by either clicking or dragging, the system will display a form “add Mindmarker” as shown in FIG. 18, on the screen of the user.

The user will complete this form (186) with the following data: Name (name of the Mindmarker/message as it will be displayed by the system once a participant receives this message), Text (this is optional and designed to allow the user to add extra text to the message), Type (the type of message as selected in an earlier step (182, FIG. 16), Media file (the media file or question category), Week and Time (the week number and day number in the time line when the message must be sent) and Priority (to assign important or regular status to the message) and Weight.

Upon completion of the form, the user selects “Save” (187) and the data that has been entered in the form will be sent to the system. The system checks if the form has been completed correctly and if the form has been completed correctly the data will be stored in the central database. In the database the system links the data to the training and the media file or question category.

The system processes the data and updates the time line with the message. The system shows the user the screen as shown in FIG. 16A to allow the user to add additional messages to the time line.

If the form has not been completed correctly or has missing information the system will send a message to the screen of the user and opens the forms again on the screen of the user. The user then has the ability to check the form and make the necessary adjustments. Once the user has made the corrections, the user selects the “save” button (187) and the data that has been entered in the form will be sent to the system. The system checks if the form has been completed correctly and if the form has been completed correctly the data will be stored in the central database. In the database the system links the data to the training and the media file or question category.

Once the user has added all the desired messages to the time line as defined above, the training has been completed and is ready to be used by participants.

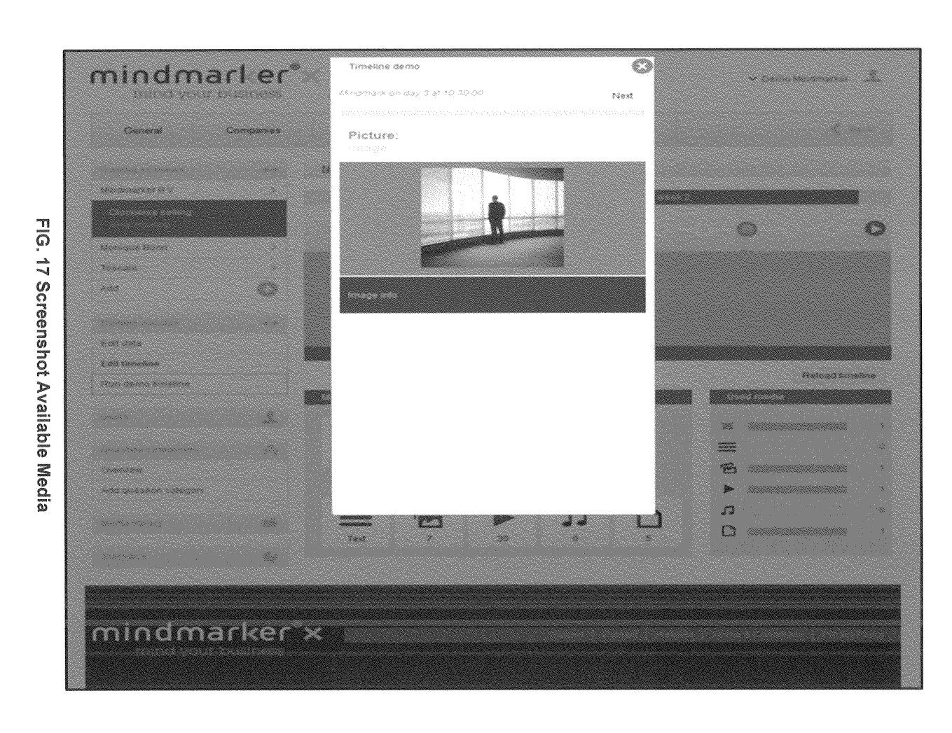

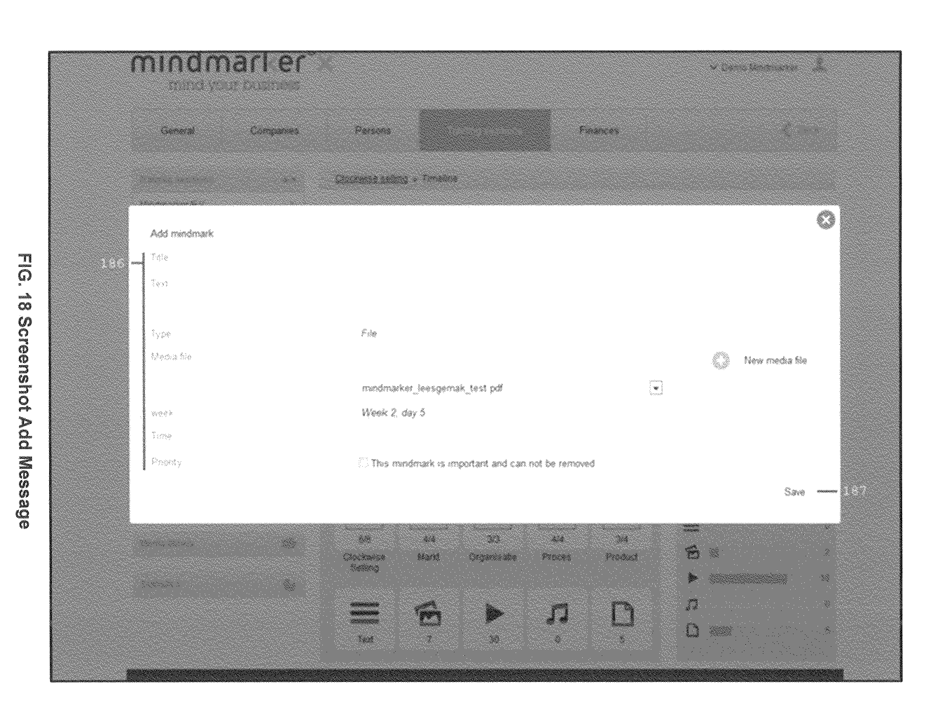

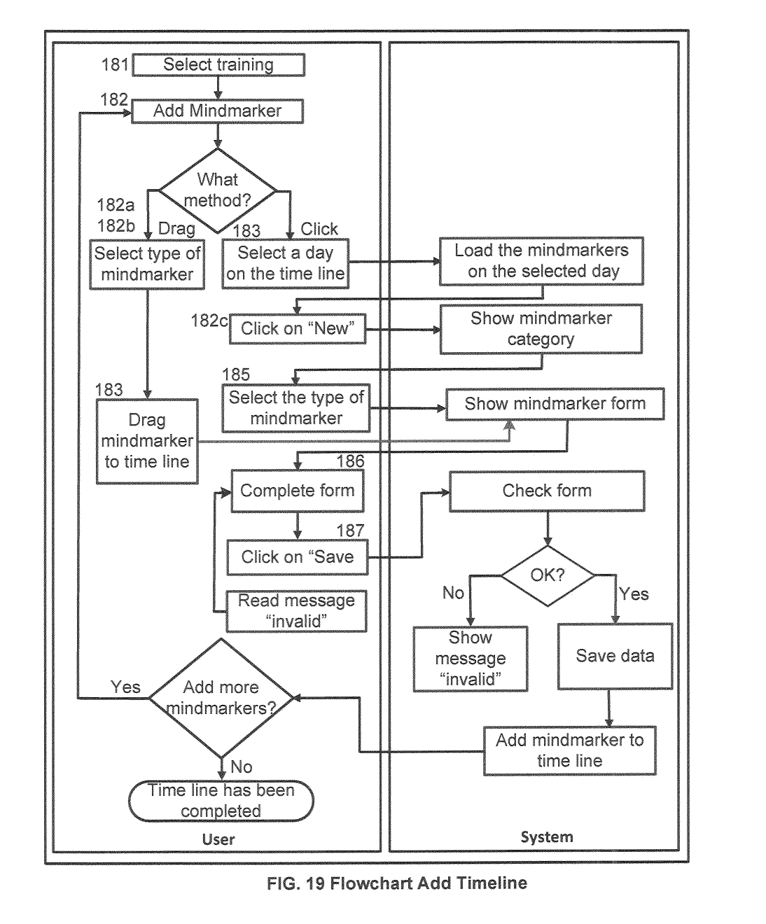

FIG. 19 shows a flowchart illustrating the above process.

FIG. 16B through FIG. 16G are other screen shots that describe the process in section 1.8. The example focuses and describes the process of adding content to specific dates and times.

FIG. 16B is a screen shot of an empty time line; meaning that there has not been any messages assigned to the time line (see FIG. 16A) (183). In this screen the user will see numbered weeks. In this example the user will see “week 1” and “week 2”. Under these weeks the user will see a line with 7 circles, which represent the 7 days in a week. Each week has 7 circles (days). The user can click on the arrow in this area to scroll to the right and see additional weeks. This timeline will show the number of weeks as defined by the user (see FIG. 3 section 122).

In this example the circles are colored white, which means that there are no scheduled messages to be delivered to the participants on any scheduled day. In FIG. 16C for example, the user has selected to add a message to day three of week 1 by clicking on that specific day or using the drag and drop method as described in section 1.8. The system sends a screen to the user showing a box with a “+” mark and the word “new” in the time line area. To add a message to the time line the user has to select this “box” and the system will send a menu of media file selections to the user as shown in FIG. 17. This is described in section 1.8.

In this example the user has selected a photo as is shown in FIG. 16D. The photo icon appears in the green area of the time line. Once the user selects the message to be sent, the user has the option to the day as described above, but also has the option to determine at what specific time of the day the message will be sent. The user uses a drop down box to select the time of the day or can enter the time of the day manually. In this example, the user has selected to use a photo to be sent on day three of week 1, at 10.30 in the morning. In this example the user has not selected the option for this message to be an important (please refer to 1.8 for defining messages as important). FIG. 16E shows an example where the user has selected a movie to be sent to the participants on day 6 of week 1 at 9.30 in the morning. The colored coded circle of this message is green/gray and indicates this is a message of the important type.

FIG. 16F shows how the user has selected a question and a pdf file to be sent to the participants on day 3 in week 2 at two different times of the day. This shows the system's ability to send multiple messages of various kinds to the participants on the same day.

FIG. 16G shows the screen the system sends to the user when the user selects the filed “run demo time line” on he left hand side of the screen. The system allows he user to scrolls through the various messages the user has added to the time line by selecting the “next” button on the right hand side by using the user's mouse. In the screen shot in 16G the user sees the first scheduled message as described in 16D. The system will allow the user to see the various messages step by step.

2. Delivery Process

This section details how messages are created and be delivered to the participants. The focus will be on the input of the participant(s), the output of the system and the interaction between the participant(s) and the system.

2.1 Create Original Main Training

The program planner, administrator, trainer or head trainer (in 2. Delivery Process referred to as “user”) creates an original main training based on existing classroom materials or digital learning materials. The user defines the goals and objectives of the training Based on the goals and objectives the user defines the length of the training. The training is composed with short messages, for example maximum 3 minutes per message. Depending on the age of the participants, the education level, the experience level, workload and other variables defined for the participants, the user selects the maximum amount of messages per week to avoid the irritation level at the participants and to maximize the reinforcement results. The user than calculates the total maximum amount of messages in the training by multiplying the length of the training in weeks, and the maximum messages per week based on the irritation level and reinforcement maximization.

Messages can be a variety of different types; videos, pictures, power point presentation, audio files, pdf files, links to internet, text messages, other types of files or questions. The system is operative to provide questions as where some information is put in front of the participant that is based on the materials that have been previous present to the participant and to receive responses.

The response from the participant is than recorded and that response is measured, assessed, evaluated, calculated, weighted, and determined if the response is correct or not. For questions where the participant needs to write a response in an open text box, this determination if the response is correct is based on the presence of keywords predefined by the user. If the participant uses one or more of the keywords, as defined by the user for that particular question, the participants is able to receive the points awarded as a weight to that question.

2.2 Content

The system allows the user to adapt the content by the addition of categories, tags, weight factor or triggers. These adaptations are decisive for the system to creating the possibility whereby the system automatically reinforces certain topics with additional messages or skips messages if scores of a participant do not meet the criteria set by the user (head trainer of the training) Based upon the results of the analyses of the knowledge and skill set(s) of the participants, companies can create an individual plan (re-training) of action for a participant or create a plan of action (re-training) for certain groups within the organization. The terms “re-training” and “learning loop” are used generally synonymously and both terms relate to the solution in the system to maximize the reinforcement based on set norms, except it will be appreciated that generally, “re-training” indicates a repetition of prior content, while “learning loop” does not necessarily require a repetition and could involve the provision of supplemental or remedial content.

2.2.1 Categorizing and Tagging

According to another aspect, the system allows the user to organize all the messages by assigning categories and/or tags. Categories and tags are created as separate objects to a message and link all messages with the same category and/or tag. In one aspect, a message can only be assigned to one category. Categorizing a message is optional.

Besides the use of categories the system allows the user to assign Tags to messages. Tagging messages is not bound to only one tag. Every message can have one, multiple, or no tag(s). Both categories and tags are unique per training and only designed specifically for that training. All the defined categories and tags are stored in the database of that specific training

2.2.2 Assign a Weight Factor to a Message and to Questions

Once the user has created the general layout of the training and all the messages are scheduled, according to one aspect the user adds a certain weight factor to each message and/or assign a weight factor to the answers to certain questions, based on its importance to achieve the objectives of the training. The weight factor of a message represents the importance of that particular message to the goal(s) of the training. As one example, weight factors range from 1-10. In this example the lowest number represents the minimum weight and thus the lowest importance for reaching the objective(s), and the highest number the maximum weight and thus most important for reaching the objective(s).

According to one aspect, the system allows the user to create Quiz Questions. Quiz Questions are questions with answers that are either correct or incorrect. The user is able to assign a weight to the total question based upon its importance to the objectives of the training. In addition to this assigned weight, the user can also assign an additional weight factor to the correct answer to a Quiz Question. For example, the participant will receive and review a Quiz Question and select the correct answer. The participant will receive the weight score for completing the question and for selecting the correct answer as assigned by the user at the creation of the training

The system also allows the user to create Survey Questions. Survey Questions are questions that do not ask for a correct or incorrect answer, but ask a question and provide answers from which a participant can choose. With Survey Questions, the system shows all possible answers and the participant selects his or her personal choice. The user can determine a weight for the Survey Question depending on the role in realizing the goals from the training and the user can assign a weight to the various answer options of that particular question based upon the importance to achieving the objectives.

For example, assume that the participant received a message with a Survey Question and he or she needs to answer the question by selecting his or her choice. In this example the system asked the participant the question “How many times did you talk to your coach this week?” with answers like “A) 0 times B) 1 time C) 2 times D) 3 times E) more than three times. The user creating the training can assign different weight to the different answers. This is based on the importance to achieve the goals of the training. In this specific example the activities as expressed in answer E (more than three times a coach meeting) has much more effect on achieving the goals compared to the behavior as described in answer A (0 meetings). This question is based on the frequency of meetings with the coach, a quantity question.

Another question type can be for example a question concerning the content of a meeting with the coach last week. These types of questions are defined as quality questions. Typically quantity questions are lower ranked in weight than quality questions. The system allows the user to assign weights to different types of questions and the answers to the questions.

According to another aspect, the system also allows the user to use Open-ended Questions. Open-ended Questions pose a question to the participant and allow the participant to type an answer of choice in their own words in a field. The user can assign an unlimited amount of keywords for which the system will check in the answers of the participant. The user will assign a weight to each keyword. If a participant answers an Open-ended Question, the system will check to see if the keywords that were predefined by the user are amongst the words the participants used to answer the Open-ended Question. If the system recognizes one or more keywords in the answer of the participant, the system will assign the weight that was assigned by the user to that keyword to the weight score of the participant. It is possible the participant has used more than one of the pre-defined keywords in which case the participant will receive the assigned weight to each keyword.

For messages where no interaction is required (like video, image, pdf file, etc.) the weight is determined by the user based upon the contribution of that message to the goals of the training

Messages that are used for the structure of the training, for example a welcome message or a message explaining what to expect at the beginning of he training or a message letting the participant know they have reached a certain point in the training (half way) are typically assigned a low weight score.

2.3 Calculation of Reinforcement Score

Referring now to FIG. 20, according to one aspect, the system calculates the total of all assigned weights to the messages, answers, and keywords of the training. As one example of weighted scoring, the system will set this total amount as 100%. Once a participant starts the training, the system will push to this participant all the messages at the selected times in the training. The system shows the progress of the participant in a variety of ways, for example showing the amount of messages completed, time and how many messages and/or time is left in the training. The system also shows the results of the participant. The system shows the number of questions answered correctly of the total questions asked or from a particular category or tag. The system shows this both in numbers and in percentages.

The system also has the possibility to show the participant's progress via the reinforcement score. The reinforcement score is designed to measure how well the participant is doing in the training to achieve the defined objectives. It reflects the type and accuracy of answers to questions, when and how many messages have been reviewed or completed.

At the moment the participant logs into the system, the system calculates the total sum of the weight of all the messages in the training from the starting date till the moment of the log in. The system has stored all messages and their weight in a table in the database. Via a calculation, the system determines the value of all the maximum weight score (including assuming that all questions are correctly answered, survey questions have been completed by using the answers with the highest scores, and using maximum score that can be achieved in open questions) from the whole training (from start to finish). At the time of login the system also determines the maximum value of all the weight scores from the starting date till the log in date and time. This can be at any point of time in the training

The progress is measured via the weighted score and is a comparison between the total score in the whole training versus the maximum score at the moment of measurement. As one example, assume that the total of all the weighted scores, corresponding to all the correct answers etc. is 1000. The system takes this as a 100% score. A participant wants to know his or her progress at a certain point in the training based on the reinforcement score. The system calculates the maximum weight score at that specific moment for example 400. To calculate the progress the system divides 400 by 1000 and multiplies the outcome with 100%. (400/1000)*100% is 40%. This represents the perfect progress reinforcement score expressed in % at that particular point in time.

The system registers all the actions from the participant for every message a participant receives. What answers did the participant provide, did he/she review all messages, when, did he/she watch the video for the complete length of the video, did he/she open the hyperlink from a message etc. At the time of login the system calculates per participant the individual weight score of the participant. Once the system has calculated the individual weighted score of the participant, the system analyzes this score in comparison with the maximum weighted score. For example, assume again that maximum score of the whole training is 1000 (100%). The actual score from this participant at the selected moment is 290. Which is (290/1000)*100% in total 29%. The reinforcement score of this participant at this time is 29%.

At any time the participant is interacting with the interface of the application, the system shows a graph and diagram in which the 2 scores: a perfect reinforcement score and the individual's reinforcement score of the participant. In this example the maximum score the participant could have achieved is 40% and he/she actually scored a 29% reinforcement score. Both numbers are shown on the display of the application, giving the participant an instant overview how he/she is doing in the reinforcement.

At the creation of the training the system allows the user to set a norm for the reinforcement score. This can also be changed and adjusted once the training has started or can be adjusted and specified for a group or individual. This norm is based on the difference between the maximum score the participant could have and the actual score. The user can define what percentage in difference is acceptable or not. According to one exemplary aspect, the system has three levels: 1) acceptable and within the norm, 2) attention but acceptable for continuing, and 3) not acceptable.

In this example the system calculates the reinforcement score difference by deducting 29% of 40% (40%-29% is 11%). The system puts this score in a table for this specific participant and compares this score with the norm that was defined by the user and assigns the status to the participant or group(s) based upon the norm. In the display of the reinforcement score on the participant's interface, the participant will notice that the reinforcement graph/bar shows a color. This color display corresponds with the status of the reinforcement for that participant. The system will show green indicating “acceptable and within the norm”, orange indicating “attention but acceptable for continuing” and red indicating “not acceptable”.

FIG. 20 shows a flowchart illustrating the above process.

2.4 Triggers

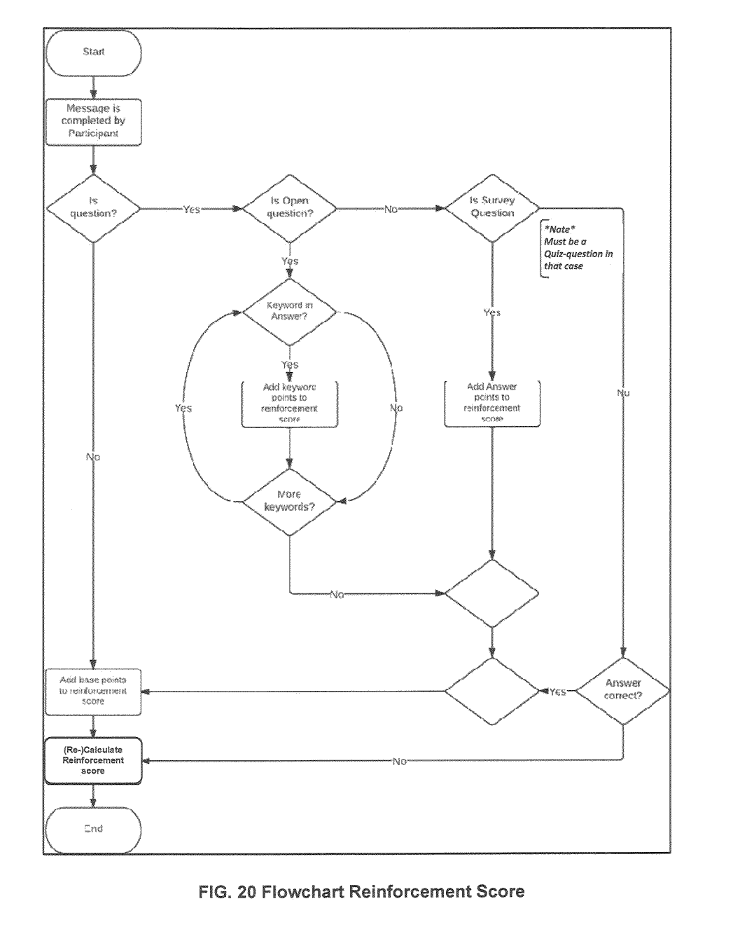

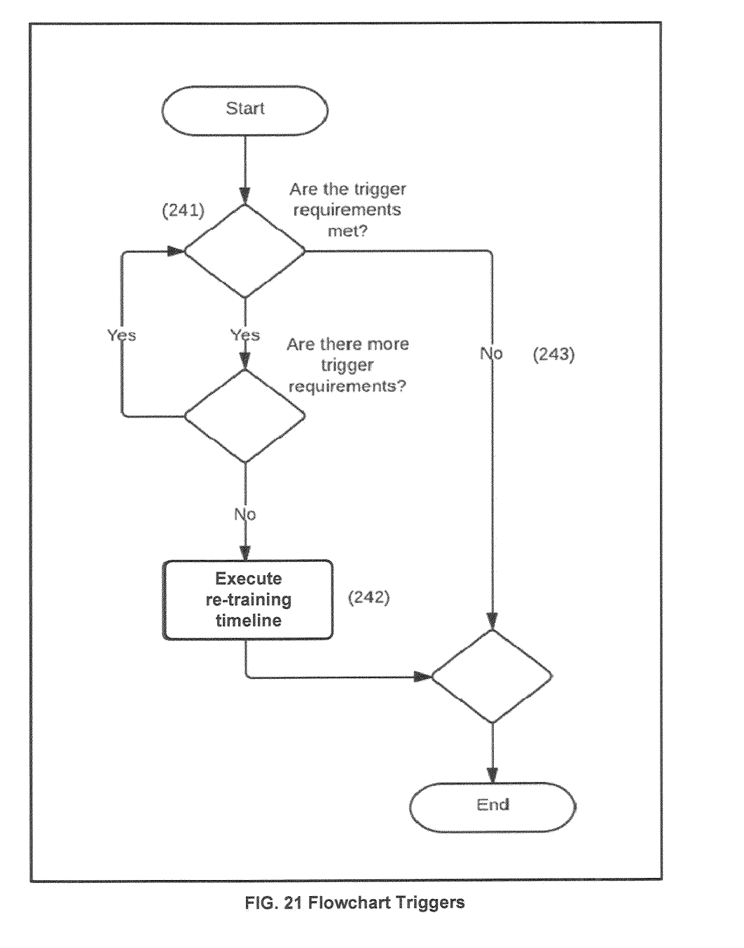

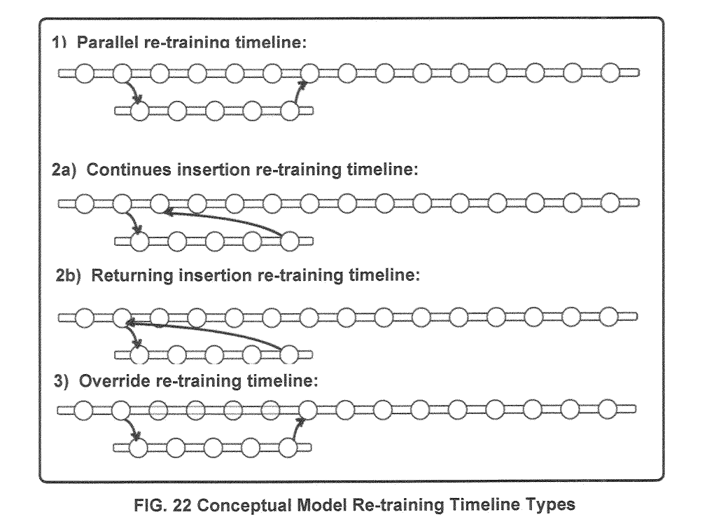

Referring now to FIG. 21, according to another feature and aspect, various types of messages can have one or more trigger(s). A trigger is a check or conditional test; if the condition of this check is met then a re-training (learning loop) is executed, e.g. see FIG. 22. The combination of triggers described in this section 2.4 with the different types of re-training timelines as described in 2.5 makes it possible to create flexible and potentially complex reinforcement training, resulting in a different experience for every participant aimed at achieving the highest possible learning result for every individual participant.

Adding a trigger to a message is optional. After the participant completes a message with a trigger the system will check whether a certain condition is met, see FIG. 21 (241) and execute a predefined action (242). If the condition is not met no action is executed and the training is proceeding as normal (243).

According to one aspect, in the system the user can select different types of triggers, including but not limited to the following:
1) Reinforcement score trigger. The definition used in the system is: IF after completing the message the Reinforcement score is higher or lower than the defined value EXECUTE Re-training (learning loop).

After completing the message with this trigger, the system automatically calculates the maximum reinforcement score that would be possible for that specific moment in the training. The statement for the condition can be ‘higher as x’, ‘lower as x’ or ‘higher as x and lower as y’.
2) Reinforcement value for category trigger. The definition used in the system is; IF after completing the message the Reinforcement score for the defined category is higher or lower than the defined value EXECUTE Re-training (learning loop).

After completing the messages with this trigger, the system automatically calculates the perfect reinforcement score for all messages in that category that would be possible for that moment in the training for that particular category. The statement for the condition can be ‘higher as x’, ‘lower as x’ or ‘higher as x and lower as y’.
3) Reinforcement value for tag trigger. The definition used in the system is: IF after completing the message the Reinforcement score for the defined tag is higher or lower than the defined value EXECUTE Re-training (learning loop).

After completing the messages with this trigger, the system automatically calculates the perfect reinforcement score for all messages with that tag that would be possible for that moment in the training for that particular tag. The statement for the condition can be ‘higher as x’, ‘lower as x’ or ‘higher as x and lower as y’.
4) Quiz Question response trigger. The definition used in the system is: IF after completing the Quiz Question the given answer by the participant is correct or incorrect EXECUTE Re-training (learning loop).
   The user can couple the trigger to either the correct or the incorrect answer. This trigger can only be coupled to a Quiz Question.
5) Survey Question response trigger. The definition used in the system is: IF after completing the Quiz question the given answer by the participant is equal to the predefined value EXECUTE Re-training (learning loop).

The user can couple the trigger to every answer for the Survey Question. This trigger can only be coupled to a Survey Question.
6) Open-ended Question response trigger: The definition used in the system is: IF after completing the Open-ended Question the given answer by the participant the predefined keywords are missing/present EXECUTE Re-training (learning loop).

The user can couple the trigger to whether one or more keywords are included or not included in the participants answer. This trigger can only be coupled to an Open-ended Question.
7) Participant attribute value trigger. The definition used in the system is: IF after completing the message the value of the predefined attribute is equal to the predefined value EXECUTE Re-training (learning loop).

This trigger can be used as a stand-alone trigger and also as an extra parameter for other triggers as described above. When used as an extra parameter on another trigger it essentially decreases the potential scope of participants that can pass a certain condition. It can even be used to set a trigger for especially only one participant. For example: Execute a re-training for all participants with a low reinforcement score AND as extra parameter the attribute “sales”. To be complete in this example, all other participants with a low reinforcement score but who do not have the attribute “sales” will NOT be redirected to the predefined re-training (learning loop).

2.5 Re-Training (Learning Loops)

Referring now to FIG. 22, a re-training is executed if a condition of a trigger is met. Re-training influences the original main training of a participant by redirecting the participant to a temporary extra training timeline. These extra timelines are called “re-training” timelines or learning loops.

In accordance with one embodiment, there are four different re-training timelines as shown in FIG. 22, sorted in three main types:
1) A parallel re-training timeline (e.g. number 1 in FIG. 22). After a condition of a trigger is met the system will send automatically extra messages to the participant on top of the existing messages in the original main training as shown in FIG. 23. The parallel re-training timeline does not influence the length (in time) of the original main training
2) An inserted re-training timeline. After a condition of a trigger is met the system will automatically insert extra messages in the original main training and send to the participant. Because the system will pause the original main training temporarily the length (in time) of the original main training will increase as shown in FIG. 24. The system distinguishes two types of insertions a) continues insertion re-training timeline and b) returning insertion re-training timeline;
   a) Continues insertion re-training timeline (e.g. number 2a in FIG. 22). After the participant completed the extra message(s) the system continues sending messages from the original main training starting from the message where the participant temporarily has left the original main training (The system will send the next message on the original main training which was scheduled before the re-training timeline event occurred).
   b) Returning insertion re-training timeline (number 2b in FIG. 22). After the participant completed the extra message(s) the system allows the participant to re-do the message on the original main training that triggered this insertion. For example; the participant will be able to re-answer a question if the message contains a Quiz Question.
3) An overriding re-training timeline (number 3 in FIG. 22). After a condition of a trigger is met the system will override the scheduled message(s) on the original main training for the length (in time) of the re-training timeline as shown in FIG. 25.

2.5.1 Creating a Re-Training Timeline

The user can create a re-training timeline in the same way as the original main timeline is created as described in 2.1 and 2.2. The user can select messages that the system already has send to participants or new messages. According to one aspect, a re-training timeline should always hold at least one message, it cannot be an empty timeline.

Suggestions Based on Categories and Tags and Automatic Message Placement

According to another aspect, the system is capable of suggesting what messages should be included in the re-training timeline based on the category and/or tag(s) of the trigger message. The user can select the category and let the system automatically fill the re-training timeline based on other messages within the training that also have the same category. The user can also select one or more tags that the trigger message has and let the system automatically fill the re-training timeline based on other messages that also have those tags.

According to one aspect, a user can only choose one category (because messages are limited to one category see 2.2.1) and/or one or multiple tags for automatic message placement. The user chooses one or more of these selection criteria and the system will add all selected messages to the re-training timeline automatically. The system spreads the messages for every category or tag evenly over the re-training timeline. The user can adjust the order, remove and add messages freely after the automatic re-training message placement.

According to another aspect, the described system has the possibility that a re-training timeline has one or more re-training timeline(s) itself. The user has no limitations in creating original main training and re-training timeline(s). Preferably, each participant in the system has to finish his or her reinforcement program always by completing the last message in the original main training. The system will automatically check whether such condition applies to the original main training and its re-training timeline(s) if not the training will be invalid and will be set to inactive. The system shows the user where additional actions are required.

Reinforcement Score for Re-Training Timeline Messages

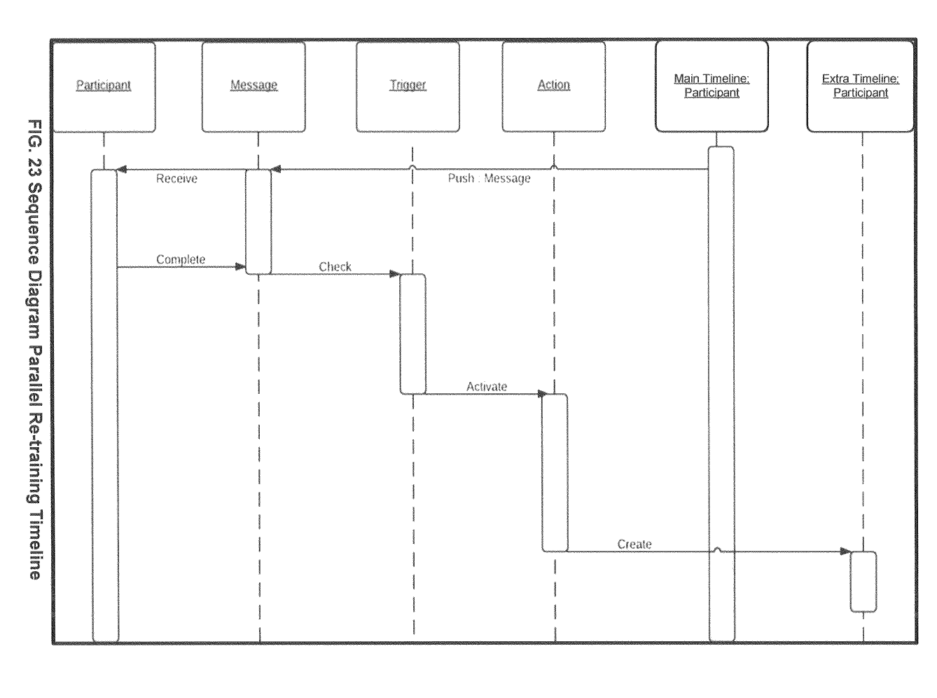

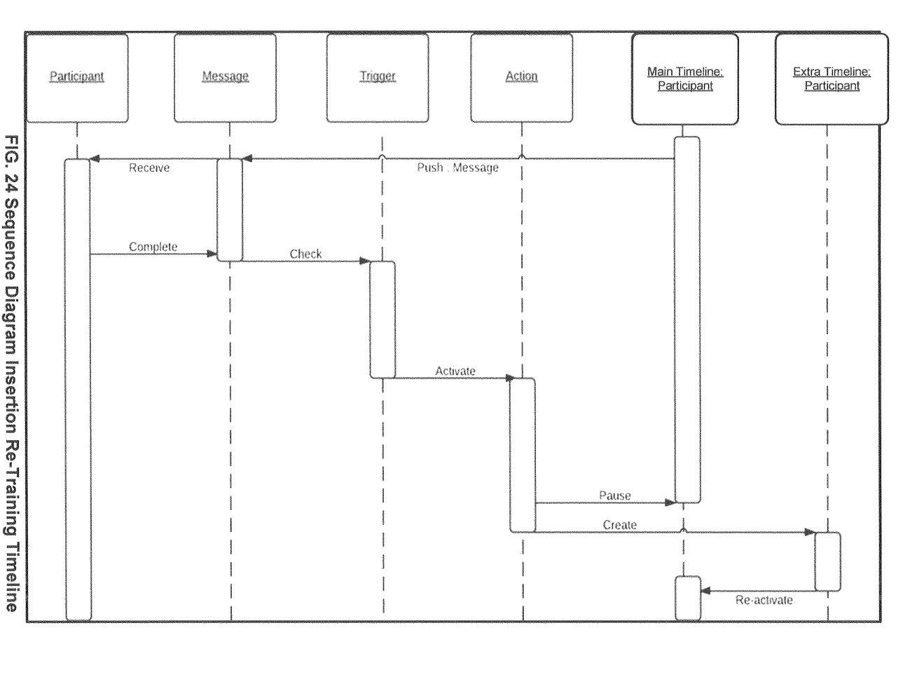

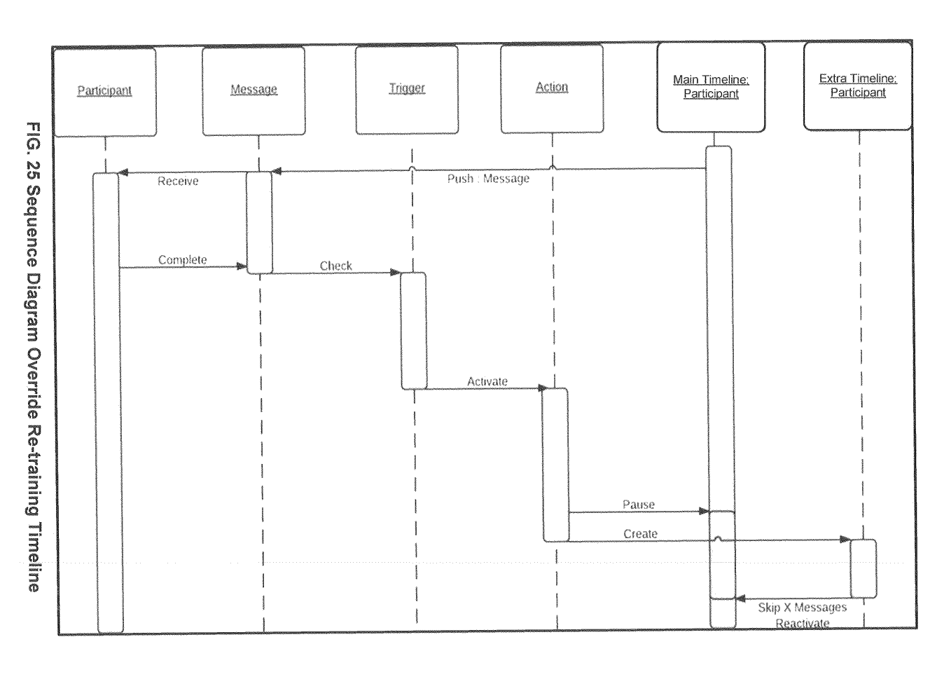

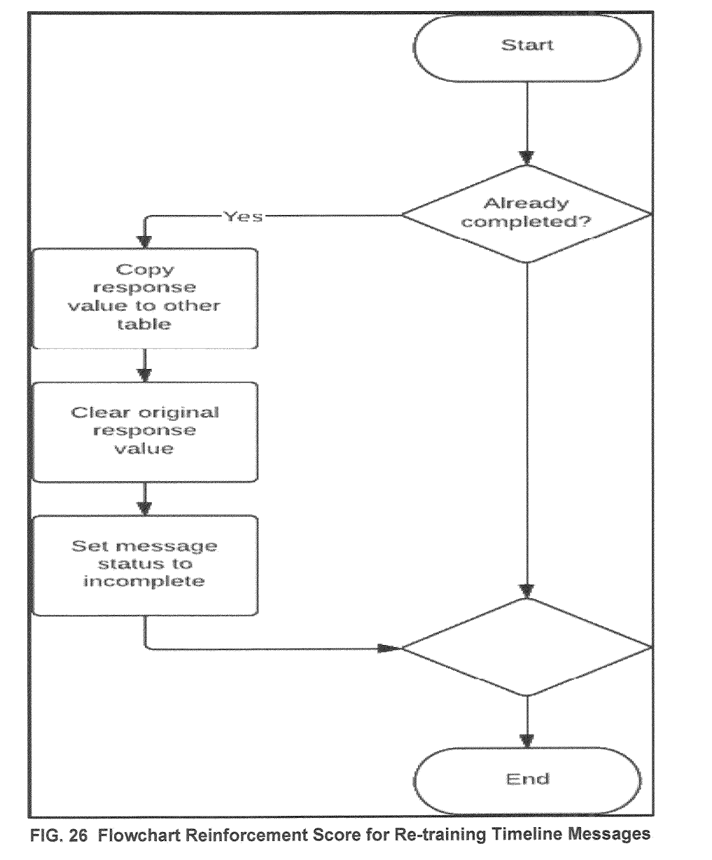

Referring now to FIG. 26, according to one aspect, all messages that are part of re-training timelines are included in the reinforcement score calculation. For the messages that have already been completed by the participant in an earlier stage the reinforcement score based on the result will be re-calculated. The previous values will however not be overwritten and saved in the database for the particular participant in the system and will still be available for analyzing purposes as shown in FIG. 26.

2.6 Automatic Re-Training

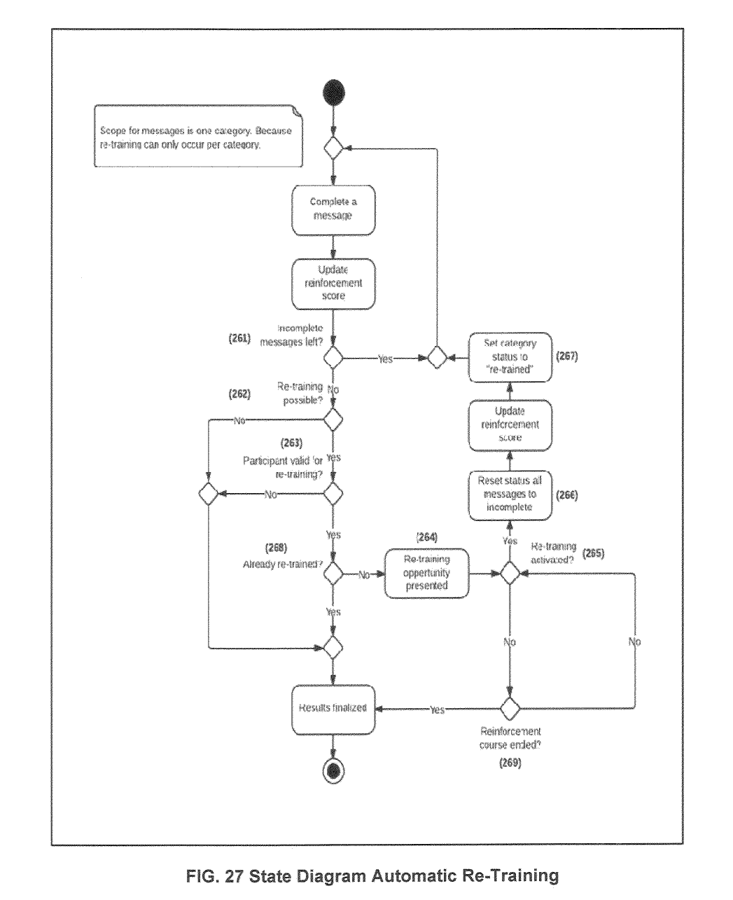

Referring now to FIG. 27, according to another exemplary aspect, the system allows the participant to activate an automatic re-training timeline per category. An automatic re-training timeline can only be activated after all messages within a certain category in the original main training have been completed by the participant. See FIG. 27 (261). The user should have indicated that automatic re-training is active for this category (262).

In one exemplary application, by default the length of an automatic re-training timeline is one day per message, the default length is therefore equal to the amount of messages in the category in days. The user can set another pre-defined length for the automatic re-training timeline. The system will spread the messages equally over the available days set by the user, based on the categories order of messages.

According to another exemplary aspect, automatic re-training timelines can only be of the parallel type (see 2.5). The user can set conditions under which an automatic re-training timeline becomes valid for a participant per category (263). Per category the user can set the requirements to which the participant must comply for an automatic re-training to become on option for this participant. In this exemplary aspect, the requirements can be set on the following criteria:

1) Value of reinforcement score for category
The user can set a maximum value for the reinforcement score. If the participants score, after completion of all messages in this category, is lower as defined the automatic re-training option will become active for this user.

2) Value for participant attribute
The user can set one or more, non-conflicting, participant attributes to which a user must comply in order for an automatic re-training option to occur.

In this exemplary aspect, the system will automatically notify the participant of automatic re-training timeline possibility (264). Automatic re-training timeline(s) will only be actually applied if the participant requests and confirms this specifically. After clicking and confirming the request to activate the automatic re-training timeline the system will activate the automatic re-training timeline for this participant (265).

In this example, after a participant has activated an automatic re-training timeline all messages of that category will be set to incomplete—allowing the participant to review the messages and re-answer the questions (266). However the original responses to the messages will not be overwritten in the database and still be available for comparison purposes in the re-training analyses for the user. After a participant chooses to re-train a certain category, the system will re-calculate all its accumulated reinforcement score points for the messages that are involved in the automatic re-training (set as not completed). The participant can reclaim those reinforcement score points by re-completing the messages in the automatic re-training. The category for which the automatic re-training occurred will however be marked as “re-trained” (267).

According to another exemplary aspect, a participant can only perform the automatic re-training of a category once per category. A category that is already marked as “re-trained” cannot be re-trained again (268).

A participant can choose to activate an automatic re-training of a category at any time during the original main training. However if the reinforcement course is finished, in other words the last message on the original main training has been completed, it is no longer possible to active an automatic re-training (269) as described above.

The difference with a re-training timeline that is not automatic is that, in case of an automatic re-training timeline, the user does not pre-define the messages for the automatic re-training timeline and that the participant will need to specifically confirm a re-training event.

2.7. Login

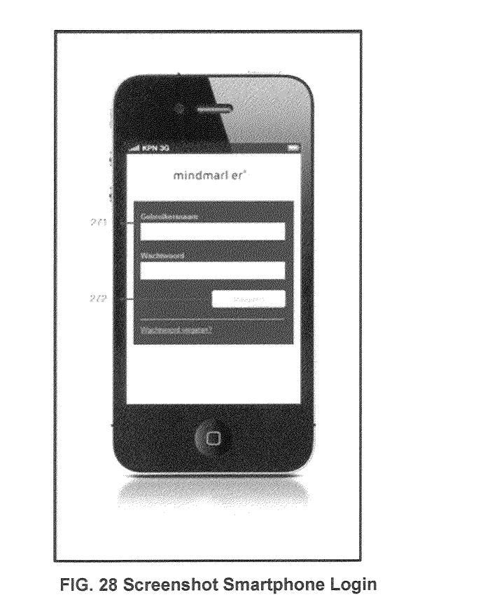

Referring now to FIG. 28, before a user can participate in a training the user needs to login into the system. The user completes the login data in required data fields (271). Once the data fields have been completed the user selects the login button (272).

Once the user has selected the login button, the system checks if the entered data is correct, using the following criteria:
Does the database recognize the entered username?
Does the password code match the password code that is stored in the database?
Is the specific user authorized to login into the system?

Each user has its own unique number in the database. If the above described validation process has been successful, the system connects the IP address, which the user used to connect to the system and to login, to the unique number that was assigned to this specific user. This allows the system and the user to know that the user is logged in. The system will provide a message to the user on screen stating that login has been successful.

If the above described validation has not been successful, the system will generate a message to the user on screen stating that login has failed as a result of incorrect login data. To protect the system from any unauthorized login activity, the system does not state in its message which one of the three validation criteria caused the failure of the login process.

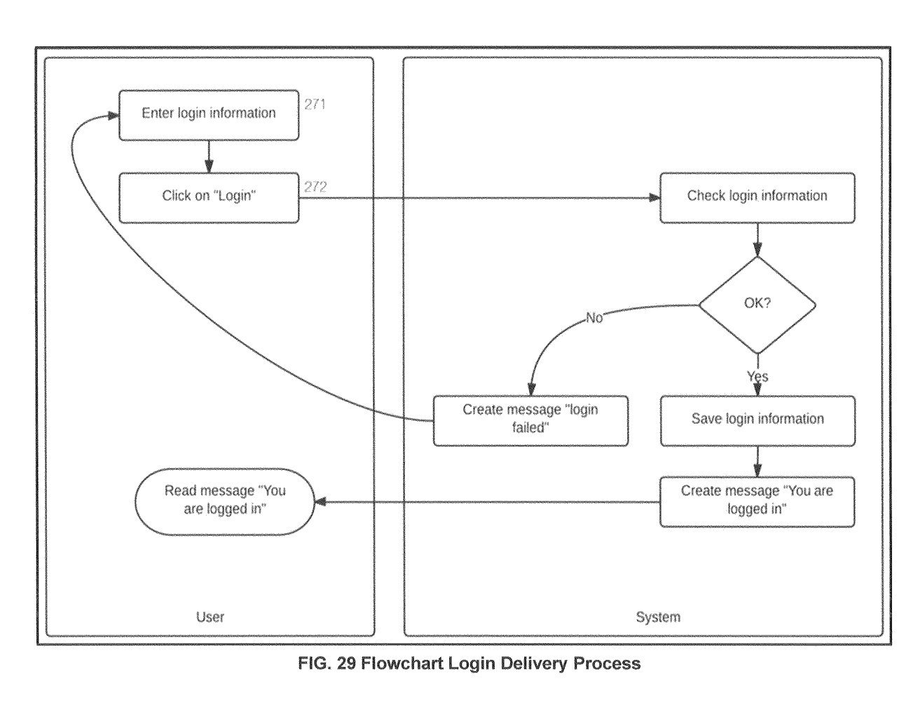

FIG. 29 shows a flowchart illustrating the above process.

2.8. Push Notification

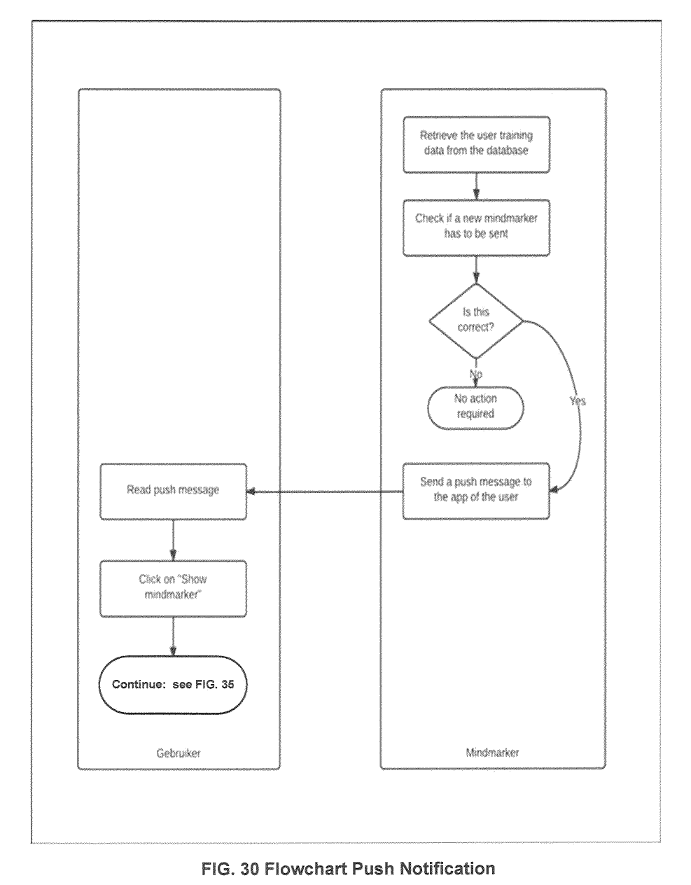

Referring now to FIG. 30, according to one aspect in one exemplary embodiment, the system allows the user to invite individual participants to a training Once the training is completely created the user can invite individual participants or a group of participants. (See 1.5). The user completes the form including on which date the training will start. The system connects the details from the participant to the selected training. The system sends an invitation e-mail with activation instructions to the particular participant. The participant activates his/her participation to the selected training by logging into the system. The system registers this particular participant as an active participant. If the participant does not activate his invitation to the training the status of this particular participant does not change in the system and remains invited. The system collects this data and stores this in the database.

Based on an interval frequency, the system automatically reinvites the particular participant with the status invited. The interval of this reinvitation process is determined by the user. The user also can reinvite this particular participant manually in the system. If the status changed into active the system will store these adjusted data in the database. If the status is not changed after the invitation or reinvitation the system will automatically send a notification (email and/or push notification) to a selected group of stakeholders like for example the supervisor.

In one exemplary aspect, the system uses push technology, i.e. electronic delivery for sending the messages from the training to the participant. The system pushes a notification to a participant so that the participant is alerted that there is a training message to review. The timing of the notification is based on some algorithm that has to do with the goal of the training and retention. The participant receives this notification on a smartphone, tablet or computer. The participant needs to complete the new messages whether it is watching a video, reading a file, answering a question, downloading a PDF file or whatever action is required in the specific message.

In one exemplary aspect, a participant can select the way of receiving notifications. For mobile applications the system is using a visual, light, sound and/or vibration notification and it shows the number of new messages that needs to be completed.

If a participant chooses to receive the notifications of a new message via the email, the participant will receive an e-mail with a link to the web browser. The system recognizes the specific dates from that participant and the system will directly show the dashboard with the notification.

The participant can receive the notifications from a new message on both his/her smartphone, tablet and computer. Once the participant has completed the training message all devices and computer are synchronized. According to one exemplary aspect, it is not possible to answer the new message on a different device for the second time. The system stores the first answer or information regarding the completion of the message. After storing this information the system synchronizes all devices which are known in the system for this particular participant.

In another exemplary embodiment, the system allows participants to follow more than one training at the same time. All data collected from completion from messages per training is stored in different tables. The participant recognizes the messages per training, based on specific characteristics, such as the name of the training or all other types of differentiation.

The system sends all the notifications of new messages based on the local time of the participant. If the user creates the training and determines that a message must be send to the participant at for example 2 PM, the system sends this message inclusive the notification at 2 PM local time of the participant. Once the participant connects with the system for the first time, the system collects information from the devices and stores that information in the data base to this particular participant. If the participant changes to another time zone the system uses the new time zone as standard for his participant.

If the participant switches his device into the off-line modus, the participant is still able to read, use or watch all received messages. Preferably, a participant's statistics remain available, i.e. the participant has complete access to all his personal results.

If a user or a participant wants to delete a send and completed message because it is, for example, confidential or not relevant anymore, the system allows the user or participant to delete it manually from each device or via the system on remote base. Once the participant connects to the system, the system always synchronizes with the latest version in the system of the new send messages and the deleted messages.

According to another aspect, the system collects the data per participant which specific message is completed or not. When the user creates the training the user also sets the norm for the allowed delay. If the participant does not meet the set norm, the system will send a notification to the participant. If the participant does complete the uncompleted messages, the system updates the status of this participant. If the participant does not complete the uncompleted messages within a set norm of time, for example 24 hours, the system sends another notification for example an e-mail with a direct link to the browser to complete the uncompleted messages. The system automatically also sends an email to the supervisor of this participant in case the user has set that during the creation of the training. The user can set standards on the maximum of uncompleted messages, the period within the participant needs to complete the uncompleted messages and the way to inform all stakeholders. The system registers all dates related to the particular participant in the database, such as for example send invitations, send notifications, send messages, messages completed, messages uncompleted, send e-mails and all other relevant information to reach the goals of the training One of the ways to receive messages through the system is via push notification. Once the participant is connected to the timeline (see 1.5), the participant will receive a message on the mobile phone or tablet once a new message is available.

According to one aspect, the system checks on occasion (e.g. periodically, and/or in accordance with a checking schedule, on demand by a user) if there is a new message available for a participant. If there are no messages available for the participant, for example because the participant is completely up-to-date with the training or the training for the participant has not yet started, the system will complete this check, not send any messages and do this similar at a later time in accordance with a checking schedule.

If the system checks and there is a new message available for a participant, the system will automatically retrieve the data for this message from the database. The system will then collect the question category, media file, extra text and participant's data to whom the message must be sent, and transfer this into a push notification format that can be sent to the right participant. Once the data has been transformed in the right format, the message will be sent.

The mobile device of the participant (tablet or smartphone) notifies the participant that there is a message available using a visual, light, sound and/or vibration notification. The participant can select the message by touch screen on the device and the Mindmarker app will start on their device and the message will be shown on the screen of the participant's device.

FIG. 30 shows a flowchart illustrating the above process.

2.9. SMS Notification

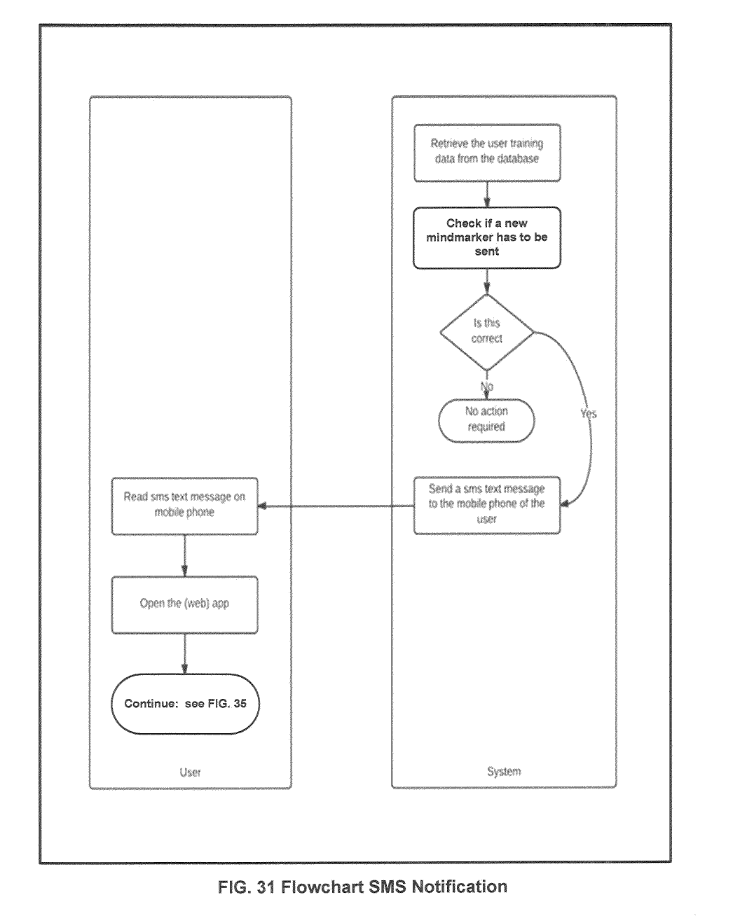

Referring now to FIG. 31, another exemplary way to receive messages through the system is via SMS or text messaging notification. The participant will receive a SMS message or text message on their mobile device announcing that there is a new message available.

As in other embodiments, the system checks on occasion if there is a new message available for a participant. If there are no messages available for the participant, for example because the participant is completely up-to-date with the training or the training for the participant has not yet started, the system will complete this check, not send any messages and do a similar check at a later time.

If the system checks and there is a new message available for a participant, the system will automatically retrieve the data for this message from the database. The system transforms and shortens the data of the message into a SMS format (maximum 140 characters). Once the system has transformed the message, the message will be sent by the system to the mobile phone, using the mobile phone number as stored in the database, of the participant.

The mobile phone of the participant receives the SMS or text message and the participant receives a message on the screen that there is a new message from the system available. The participant can now login via the app or web application to retrieve the message.

FIG. 31 shows a flowchart illustrating the above process.

2.10. E-Mail Notification

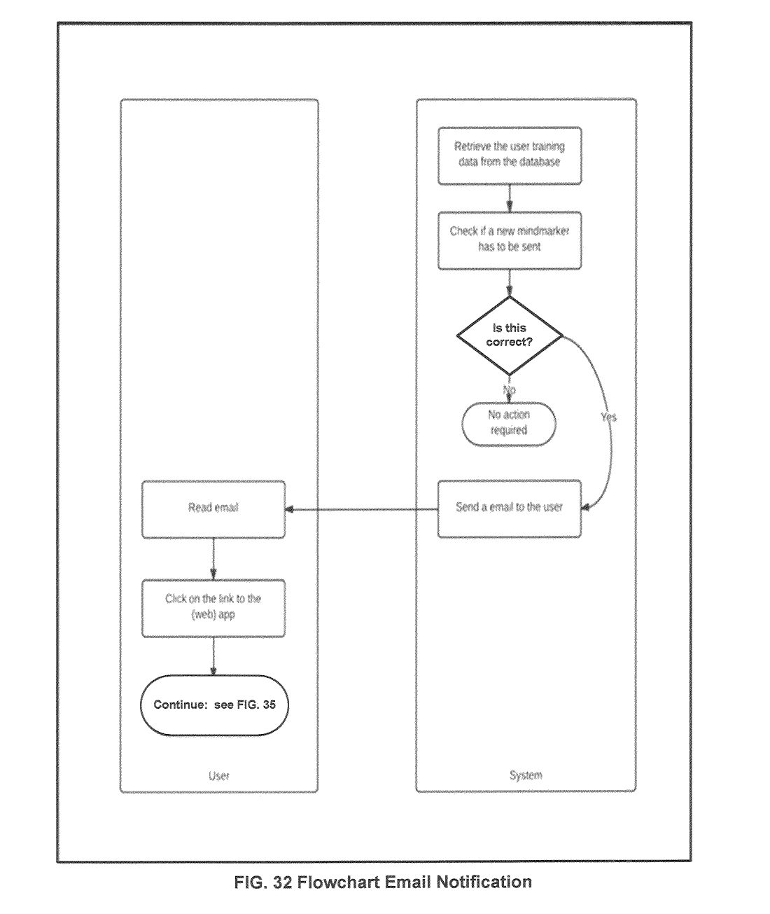

Referring now to FIG. 32, another exemplary way to receive messages through the system is via email notification. The participant will receive an email message in their email box announcing that there is a new message available.

As in other embodiments, system checks on occasion if there is a new message available for a participant. If there are no messages available for the participant, for example because the participant is completely up-to-date with the training or the training for the participant has not yet started, the system will complete this check, not send any messages and do a similar check at a later time.

If the system checks and there is a new message available for a participant, the system will automatically retrieve the data for this message from the database. The system transforms the data of the message into an email format. Once the system has transformed the message, the message will be sent by the system to the email address, using the email address as stored in the database, of the participant.

The participant receives an email message on the email address on file, stating that there is a new message from Mindmarker available. The participant can use the link in the email message either to install the Mindmarker app, open the Mindmarker app or login to the Mindmarker portal via the web and review the message.

FIG. 32 shows a flowchart illustrating the above process.

2.11. Processing Message

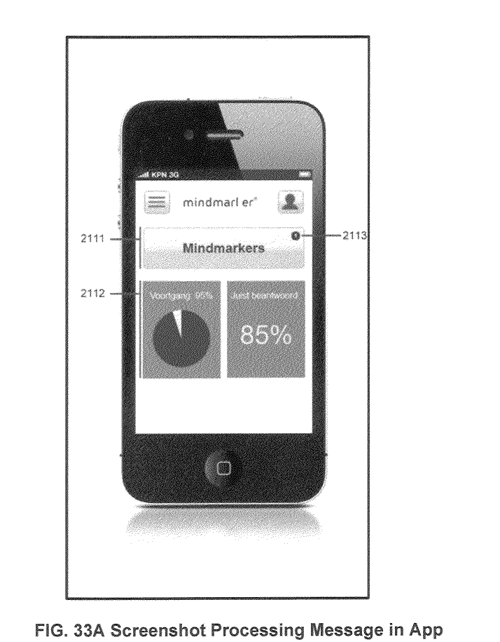

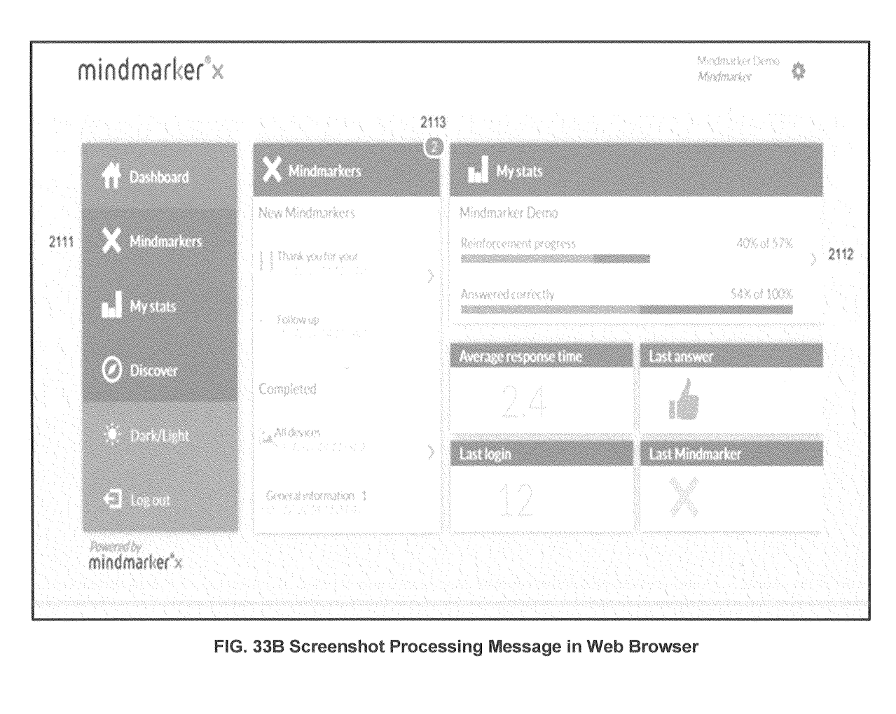

Referring now to FIG. 33, the user has opened the Mindmarker app on the smart phone or tablet and the device is showing the screenshot as shown in FIG. 33A. If the participant has opened the Mindmarker web application via the link in the e-mail notification or via the SMS notification, the system is showing the screenshot as shown in FIG. 33B.

These screens are referred to as a dashboard. The participant can use this dashboard to monitor progress (2112), check if there is a message available to be reviewed by looking at the numeric sign in small red dot on the screen (2113). A number in this small red dot indicates a new message is available for review. The participant uses the touchscreen of the device to select the bar called ‘Mindmarkers’ (2111) upon which the system generates the details for the message to the correct participant.

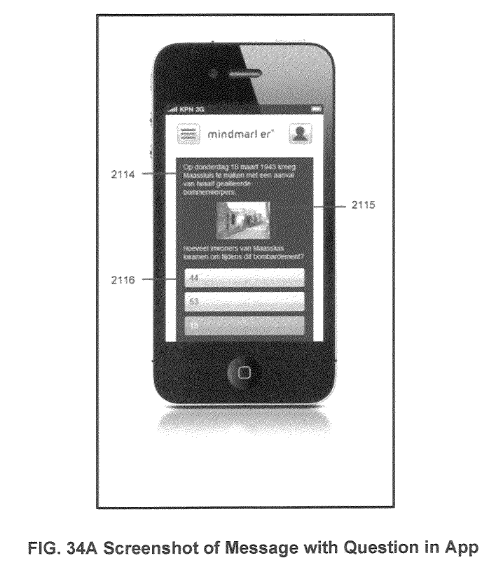

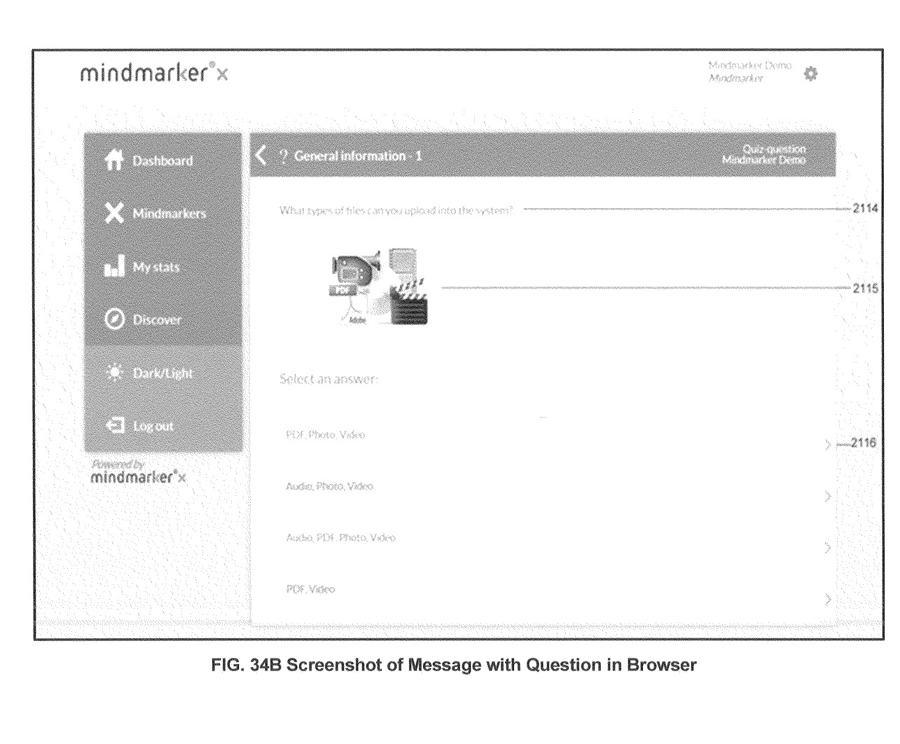

Referring now to FIG. 34, once a participant opens the message, the system sends a message that for example looks like FIG. 34A or FIG. 34B with a text block (2114) and a media file (2115). If the message includes a question, then the participant will also see the question and the possible answers to choose from (2116). The participant will read the text, view the media file and read the question (if included) and selects an answer from the multiple-choice answers provided in the question. The system registers the answers as selected by the participant, shows the selected answer on the screen of the device of the participant and shows a button on the screen for the participant to confirm the answer. This allows the participant to change the answer before the participant confirms the answer.

Once the participant selects the confirm answer button on the screen, the system receives the information and analyses the answer in the database. The correct answer along with the answer that the participant selected will be stored in the database for this participant. Storing the answers allows the system to create reports showing the % of questions answered correctly or incorrectly by the participant. The system loads the correct answer and explanation this to the device of the participant. If the question was answered correctly, the screen will show an indicator, e.g. a green check mark, and if the answer was not answered correctly, the screen will show another indicator, e.g. a red cross. Once the participant has read the explanation on the screen, the participant will select the “next” button. The system registers this and marks this message as being completed by the participant. The system checks at this time if there are additional messages available for this participant. If there are any additional messages, these will be send to the participant, if not the system will send a message to the participant that there are no new messages and that the participant is on track with the training

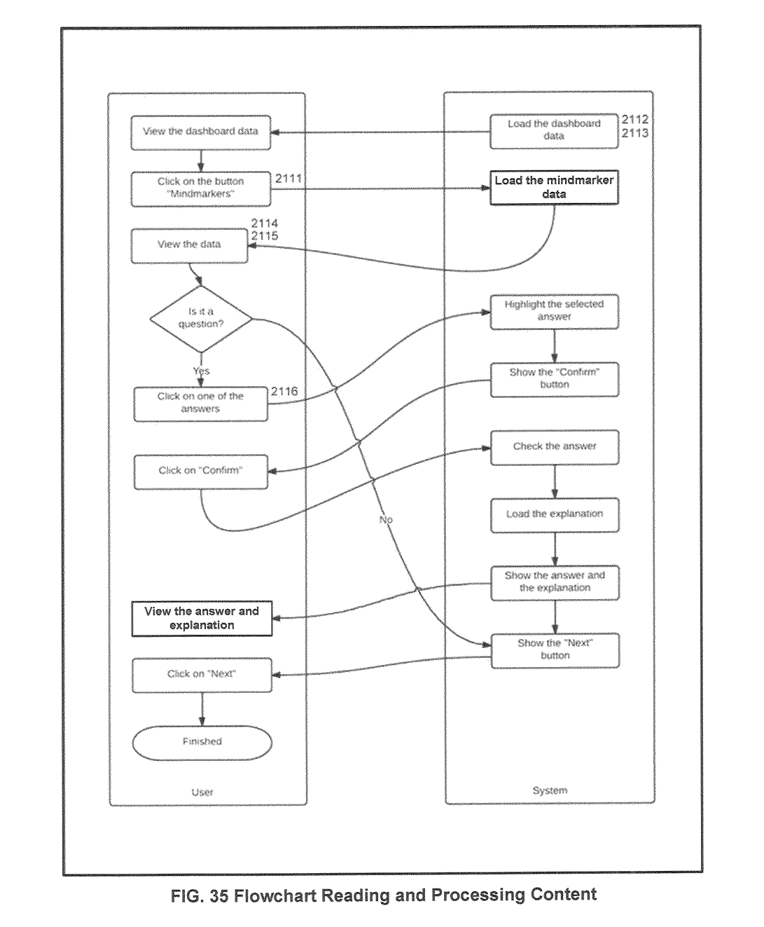

FIG. 35 shows a flowchart illustrating the above process.

3. Evaluation Process

In certain exemplary embodiments, the trainer/user can evaluate the progress and performance of the participants. The system generates statistics and graphs that can be reviewed by the trainer. The data can be sorted and filtered to create custom reports. The focus will be on the input of the participant(s), the output of the system and the interaction between the participant(s) and the system.

3.1. Login

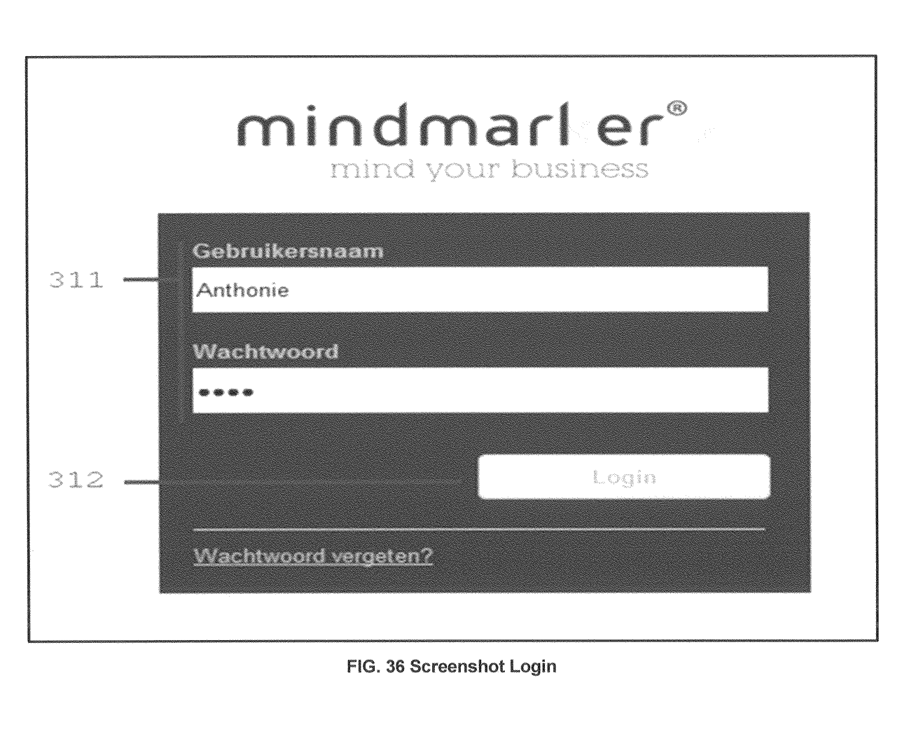

Referring now to FIG. 36, in one aspect, the user/trainer must be logged into the system before analyzing a training. The user completes the login data in required data fields (311). Once the data fields have been completed the user selects the login button (312). Once the user has selected the login button, the system checks if the entered data is correct, using the following criteria:
Does the database recognize the entered username?
Does the password code match the password code that is stored in the database?
Is the specific user authorized to login into the system?

Each user has its own unique number in the database. If the above described validation process has been successful, the system connects the IP address, which the user used to connect to the system and to login, to the unique number that was assigned to this specific user. This allows the system and the user to know that the user is logged in. The system will provide a message to the user on screen stating that login has been successful.

If the above described validation has not been successful, the system will generate a message to the user on screen stating that login has failed as a result of incorrect login data. To protect the system from any unauthorized login activity, the system does not state in its message which one of the three validation criteria caused the failure of the login process.

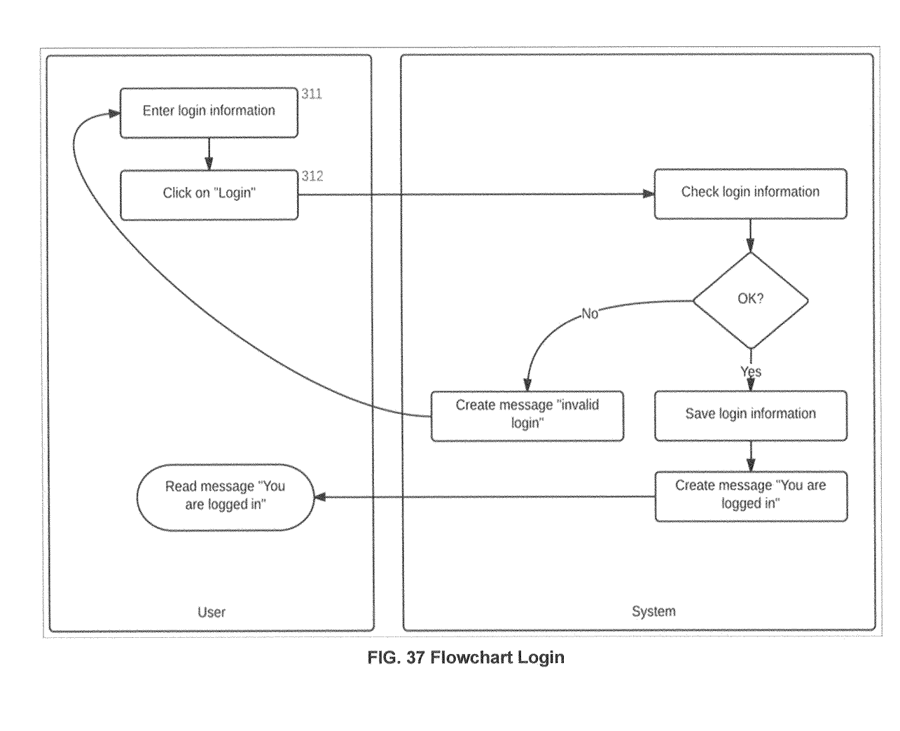

FIG. 37 shows a flowchart illustrating the above process.

3.2. Statistics

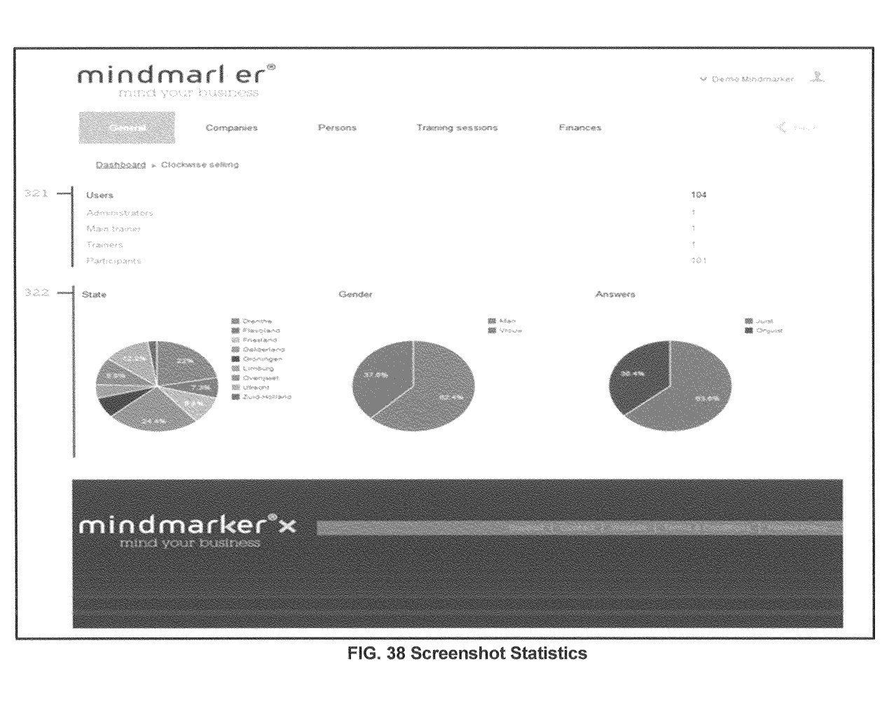

Referring now to FIG. 38, in another exemplary aspect, once a user is logged in, the system creates and send a dashboard page to the computer of the user. The system calculates how many participants there are enrolled in the training and how they are divided over the various categories as listed in 321. The system sorts the data details of the participants based upon a variety of criteria: state, gender, number of questions answered correctly or incorrectly. The system converts this data into graphs and shows these at the bottom of the screen of the dashboard (322).

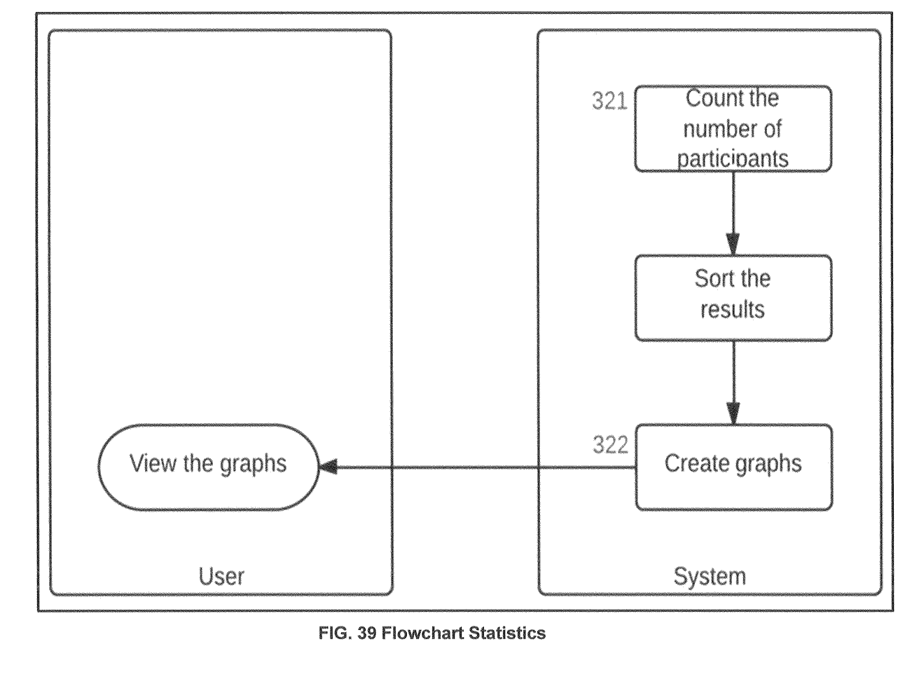

FIG. 39 shows a flowchart illustrating the above process.

3.3. Analyses

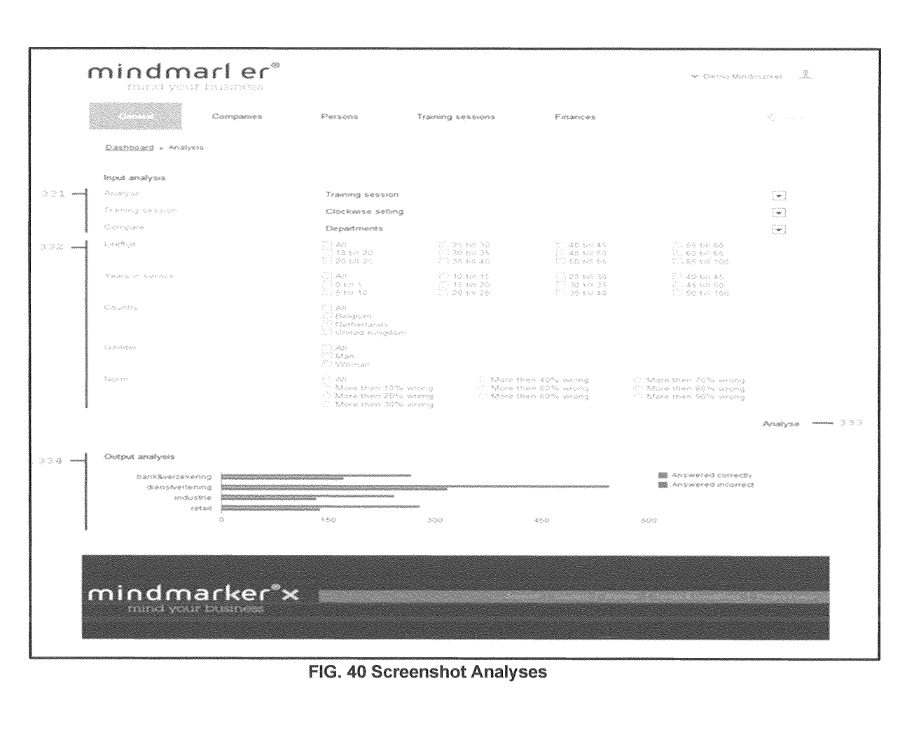

Referring now to FIG. 40, in another exemplary aspect, a user is also able to define and create custom reporting through the system. The user has the option to select specific analytical topics in the system's analytical form. The first step in this process is that the user selects what is being analyzed (331); the training or the company (the results of one training or the results of all trainings that the company is doing). If the user selects to analyze one training, the user selects one specific training from the drop down menu (331). The third step is to select what is being compared, for example departments, performance by gender, performance by age or performance geography.

Once the user has made these three selections, the user can select what filters the user wants to apply to the analyses (332), for example age, years in service, country, gender, performance norm. Once the user has selected the filters, the user selects the button “analyze” (333). The system will take this command and create a query and send this query to the database, which will return the requested data to the system. The system will process these data and create a bar graph (334), which will be displayed on the screen of the user.

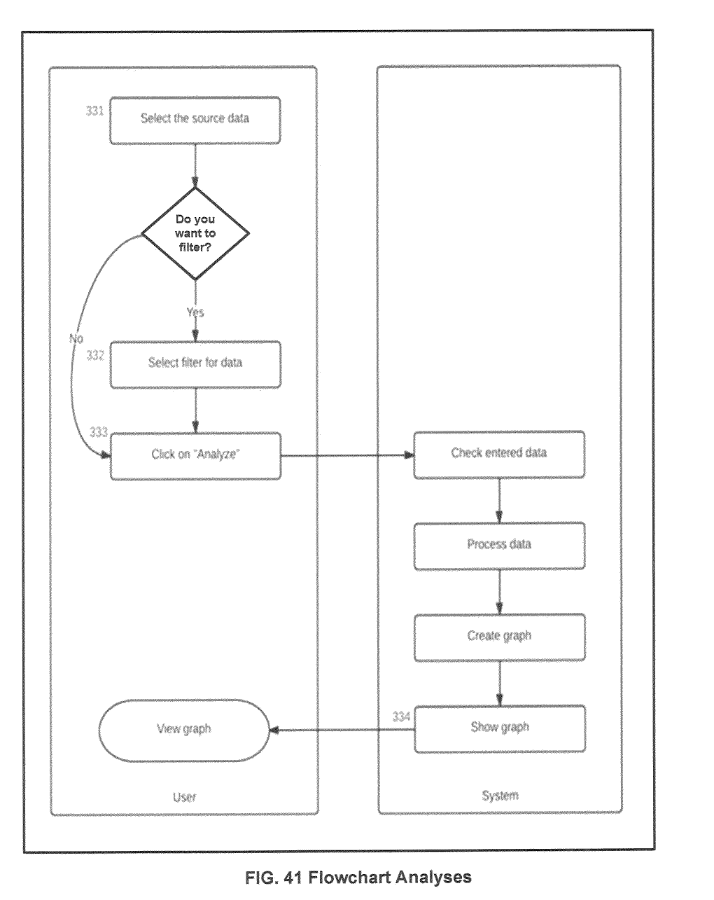

FIG. 41 shows a flowchart illustrating the above process.

According to another exemplary aspect, the system keeps track of the number of questions answered correctly and incorrectly by the participant. At the creation of the training the head trainer can define what percentage of questioned must be answered correctly by the user to give the participant a pass score for the training course. For example, if the head trainer defines that the participant must at minimum answer 70% of the questions correctly and the participant answers 80% correctly, the participant has a good enough score to move on. If the participant scores below the norm set by the head trainer, in this case 70%, the system will automatically send a message to the participant, trainer and head trainer that the participant is advised to follow a re-training course.

Based upon the analyses of the answers the system will determine what course needs to be initiated to this participant to further train the participant on the subject where the participant lacks knowledge or skills. These re-training modules are created at the creation of the basic training and will automatically be executed by the system once the system determines a participant scores below the norm set by the head trainer.

Once a participant has been re-directed to a re-training, the participant will follow the training and complete the questions as they are included in the re-trainer time line. The system will analyze if the participant has successfully completed the re-training, this is again based upon the performance norms as defined by the head trainer for this re-training at the creation of the training

Once the participant has successfully completed this re-training, the participant will be re-directed to the original time line and will continue with the original training. In this case the time line of the original training is temporarily paused and will restart once the participant has successfully completed the re-training. If he participant does not successfully completes the re-training the participant will be re-directed to the same or a secondary version of the re-training as defined in the system.

According to another exemplary aspect, the system also analyzes the usage of each participant. The system tracks and reports how the participant handles the receipt of the push messages that are sent by the system. For example: Did the participant open the push message, but did not complete the requested action like answering a question or viewing a video? Did the participant download the file that was referred to? Did the participant click on the provided link in the message?

According to one aspect, the system analyzes the responses and response time of the participants. The head trainer can define at the creation of the training in what amount of time the participant must execute the required action as listed in the push message received by the participant. If the participant does not execute the required action within this set time period, for example 48 hours, the system will automatically create and send an email message to the participant stating that a task has not completed. If the participant does not complete the requested task of the message within another pre-set period (for example an additional 48 hours), the system can generate an email message stating this fact and send this to the head trainer and/or trainer. This will allow the head trainer and/or trainer to take specific action towards this participant.

From the foregoing description of various aspects and features of methods and a system for creating interactive training and reinforcement programs, it will be understood that various embodiments of the present system described herein are generally implemented as a special purpose or general-purpose computers including various computer hardware as discussed in greater detail below, including personal computers and mobile devices used by the users and participants. Embodiments within the scope of the present disclosure also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, the systems and methods are described in the general context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the described systems and methods may be practiced in network computing environments with many types of computer system configurations, including personal computers, hand-held devices, multi-processor systems, microprocessor-based or programmable consumer electronics, networked PCs, minicomputers, mainframe computers, and the like. Embodiments of the described systems and methods are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the described embodiments for storing the training programs and delivering the described content, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote memory storage device. It will be appreciated that the network connections described or shown are exemplary and other mechanisms of establishing communications over wide area networks or the Internet may be used.

In view of the foregoing detailed description of preferred embodiments, it readily will be understood by those persons skilled in the art that the present invention as claimed is susceptible to broad utility and application. While various aspects have been described in the context of a preferred embodiment, additional aspects, features, and methodologies of the present invention as claimed will be readily discernible from the description herein, by those of ordinary skill in the art. Many embodiments and adaptations other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated by the applicant. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions as claimed. In addition, some steps may be carried out simultaneously.

From the foregoing, it will now be understood and appreciated that there is described and disclosed at least the following first embodiment and aspects:

A computer-implemented method for providing a predetermined program of digital training content to a training participant via a computer network in accordance with a timeline corresponding to a predetermined training time period, the training content comprising one or more digital content items and one or more questions relating to content items delivered to a participant, comprising the steps of:

(a) providing a network-accessible content delivery computer system including a memory and a processor, for storing a plurality of programs of training content and for electronically delivering selected content items and questions to a training participant via an electronic communication port;

(b) storing a timeline in the computer system representing a program of training content, the timeline comprising data representing a schedule for content delivery, data identifying particular selected content items to be delivered to a participate in accordance with the schedule, and data corresponding to questions related to content items;

(c) storing a plurality of selectable digital content items and a plurality of questions in the computer system;

(d) electronically delivering, by the computer system, the content items to a participant in accordance with the schedule corresponding to a stored timeline, at least some of the content items comprising a question that the participant is to answer in order to progress along the timeline and receive subsequent content items in the schedule of the saved timeline;

(e) receiving, at the computer system, answers to one or more questions input by a participant in response to a delivered content item comprising a question provided at a particular question point in the timeline;

(f) processing, at the computer system, received answers to the questions input by the participant to determine a progress score for the participant corresponding to an expected progress score for the participant at the particular question point in the timeline; and

(g) adjusting, at the computer system, the timeline for the participant in response to a determined progress score so as to alter the schedule of delivery of content items to the participant in accordance with the timeline.

At least secondly, there has also been described and disclosed a system for providing a predetermined program of digital training content to a training participant via a computer network in accordance with a timeline corresponding to a predetermined training time period, the training content comprising one or more digital content items and one or more questions relating to content items delivered to a participant, comprising:

a network-accessible content delivery computer system including a processor for electronically delivering selected content items and questions to a training participant via an electronic communication port, the processor operative for executing computer program code;

a memory for storing a plurality of programs of training content and one or more timelines, each timeline comprising data representing a schedule for content delivery, data identifying particular selected content items to be delivered to a participate in accordance with the schedule, and data corresponding to questions related to content items;

the memory further storing a plurality of selectable digital content items and a plurality of questions in the computer system;

the processor operative for executing computer program code for:
(a) electronically delivering the content items to a participant in accordance with the schedule corresponding to a stored timeline, at least some of the content items comprising a question that the participant is to answer in order to progress along the timeline and receive subsequent content items in the schedule of the saved timeline;
(b) receiving answers to one or more questions input by a participant in response to a delivered content item comprising a question provided at a particular question point in the timeline;
(c) processing received answers to the questions input by the participant to determine a progress score for the participant corresponding to an expected progress score for the participant at the particular question point in the timeline; and
(d) adjusting the timeline for the participant in response to a determined progress score so as to alter the schedule of delivery of content items to the participant in accordance with the timeline.

At least thirdly, there has also been described and disclosed a computer-implemented method for constructing a predetermined program of digital training content for delivery to a training participant via a computer network in accordance with a timeline corresponding to a predetermined training time period, the training content comprising one or more digital content items and one or more questions relating to content items delivered to a participant by a content delivery computer system, comprising the steps of:

(a) providing a network-accessible computer system including a memory and a processor, for storing a plurality of programs of training content comprising selected content items and questions for electronic delivery to a training participant via a content delivery computer system;

(b) providing a display and input coupled to the computer system for interaction with a program planner to construct a timeline and select training content for delivery to participants;

(c) storing a timeline in the computer system representing a program of training content, the timeline comprising data representing a schedule for content delivery, data identifying particular selected content items to be delivered to a participate in accordance with the schedule, and data corresponding to questions related to content items;

(d) storing a plurality of selectable digital content items and a plurality of questions in the computer system;

(e) displaying, by the computer system, a timeline graphical representation to a program planner, the timeline graphical representation corresponding to a stored timeline and comprising user selectable date indicia, for a program planning session;

(f) receiving, at the computer system, input from the program planner during the program planning session to select a date indicium on a displayed timeline graphical representation;

(g) receiving, at the computer system, input from the program planner to select one or more particular content items and questions to associate with the selected date indicium in the program planning session, thereby indicating commanded delivery by the content delivery computer system of the selected content items and questions to the participant on the date corresponding to the selected date indicium; and

(h) saving the timeline for a participant upon completion of a program planning session by a program planner as a saved timeline, for access by the content delivery computer system and subsequent delivery of the content items and questions in accordance with the timeline.

At least fourthly, there has also been described and disclosed a system for constructing a predetermined program of digital training content for delivery to a training participant via a computer network in accordance with a timeline corresponding to a predetermined training time period, the training content comprising one or more digital content items and one or more questions relating to content items delivered to a participant by a content delivery computer system, comprising:

a network-accessible computer system including a processor, the processor operative for executing computer program code;

a memory for storing a plurality of programs of training content and one or more timelines, each timeline comprising data representing a schedule for content delivery, data identifying particular selected content items to be delivered to a participate in accordance with the schedule, and data corresponding to questions related to content items;

the memory further storing a plurality of selectable digital content items and a plurality of questions in the computer system;

a display and input device coupled to the computer system for interaction with a program planner to construct a timeline and select training content for delivery to participants;

the processor operative for executing computer program code for:
(a) storing a timeline in the memory representing a program of training content, the timeline comprising data representing a schedule for content delivery, data identifying particular selected content items to be delivered to a participate in in accordance with the schedule, and data corresponding to questions related to content items;
(b) storing a plurality of selectable digital content items and a plurality of questions in the memory;
(c) displaying, on the display, a timeline graphical representation to a program planner, the timeline graphical representation corresponding to a stored timeline and comprising user selectable date indicia, for a program planning session;
(d) receiving input from the program planner during the program planning session to select a date indicium on a displayed timeline graphical representation;
(e) receiving input from the program planner to select one or more particular content items and questions to associate with the selected date indicium in the program planning session, thereby indicating commanded delivery by the content delivery computer system of the selected content items and questions to the participant on the date corresponding to the selected date indicium; and
(f) saving the timeline for a participant in the memory upon completion of a program planning session by a program planner as a saved timeline, for access by the content delivery computer system and subsequent delivery of the content items and questions in accordance with the timeline.

At least fifthly, there has also been described and disclosed a computer-implemented method for providing a predetermined program of digital training content to a training participant via a computer network in accordance with a timeline corresponding to a predetermined training time period, the training content comprising one or more digital content items and one or more questions relating to content items delivered to a participant, comprising the steps of:

(a) providing a network-accessible content delivery computer system including a memory and a processor, for storing a plurality of programs of training content and for electronically delivering selected content items and questions to a training participant via an electronic communication port;

(b) providing a display and input coupled to the computer system for interaction with a program planner to construct and/or adjust a timeline and select training content for delivery to participants;

(c) storing a timeline in the computer system representing a program of training content, the timeline comprising data representing a schedule for content delivery, data identifying particular selected content items to be delivered to a participate in accordance with the schedule, and data corresponding to questions related to content items;

(d) storing a plurality of selectable digital content items and a plurality of questions in the computer system;

(e) displaying, by the computer system, a timeline graphical representation to a program planner, the timeline graphical representation corresponding to a stored timeline and comprising user selectable date indicia, for a program planning session;

(f) receiving, at the computer system, input from the program planner during the program planning session to select a date indicium on a displayed timeline graphical representation;

(g) receiving, at the computer system, input from the program planner to select one or more particular content items and questions to associate with the selected date indicium in the program planning session, thereby indicating commanded delivery by the computer system of the selected content items and questions to the participant on the date corresponding to the selected date indicium;

(h) saving the timeline for a participant upon completion of a program planning session by a program planner as a saved timeline;

(i) electronically delivering, by the computer system, the content items to a participant in accordance with the schedule indicated by a saved timeline, at least some of the content items comprising a question that the participant is to answer in order to progress along the timeline and receive subsequent content items in the schedule of the saved timeline;

(j) receiving, at the computer system, answers to one or more questions input by a participant in response to a delivered content item comprising a question provided at a particular question point in the timeline;

(k) processing, at the computer system, received answers to the questions input by the participant to determine a progress score for the participant corresponding to an expected progress score for the participant at the particular question point in the timeline; and

(l) adjusting, at the computer system, the timeline for the participant in response to a determined progress score so as to alter the schedule of delivery of content items to the participant in accordance with the timeline.

At least sixthly, there has also been described and disclosed a system for providing a predetermined program of digital training content to a training participant via a computer network in accordance with a timeline corresponding to a predetermined training time period, the training content comprising one or more digital content items and one or more questions relating to content items delivered to a participant, comprising the steps of:

a network-accessible computer system including a processor, the processor operative for executing computer program code;

a memory for storing a plurality of programs of training content and one or more timelines, each timeline comprising data representing a schedule for content delivery, data identifying particular selected content items to be delivered to a participate in accordance with the schedule, and data corresponding to questions related to content items;

the memory further storing a plurality of selectable digital content items and a plurality of questions in the computer system;

a display and input device coupled to the computer system for interaction with a program planner to construct and/or adjust a timeline and select training content for delivery to participants;

the processor operative for executing computer program code for:
(a) displaying a timeline graphical representation to a program planner via the display, the timeline graphical representation corresponding to a stored timeline and comprising user selectable date indicia, for a program planning session;
(b) receiving input from the program planner during the program planning session to select a date indicium on a displayed timeline graphical representation;
(c) receiving input from the program planner to select one or more particular content items and questions to associate with the selected date indicium in the program planning session, thereby indicating commanded delivery by the computer system of the selected content items and questions to the participant on the date corresponding to the selected date indicium;
(d) saving the timeline for a participant upon completion of a program planning session by a program planner as a saved timeline;
(e) electronically delivering the content items to a participant in accordance with the schedule indicated by a saved timeline, at least some of the content items comprising a question that the participant is to answer in order to progress along the timeline and receive subsequent content items in the schedule of the saved timeline;
(f) receiving answers to one or more questions input by a participant in response to a delivered content item comprising a question provided at a particular question point in the timeline;
(g) processing received answers to the questions input by the participant to determine a progress score for the participant corresponding to an expected progress score for the participant at the particular question point in the timeline; and
(h) adjusting the timeline for the participant in response to a determined progress score so as to alter the schedule of delivery of content items to the participant in accordance with the timeline.

Further aspects of one exemplary method further comprise the steps of:

(i) providing a display and input device coupled to the computer system for interaction with a program planner to construct a timeline and select training content for delivery to participants;

(ii) displaying, by the computer system, a timeline graphical representation to a program planner, the timeline graphical representation corresponding to a stored timeline and comprising user selectable date indicia, for a program planning session;

(iii) receiving, at the computer system, input from the program planner during the program planning session to select a date indicium on a displayed timeline graphical representation;

(iv) receiving, at the computer system, input from the program planner to select one or more particular content items and questions to associate with the selected date indicium in the program planning session, thereby indicating commanded delivery by the computer system of the selected content items and questions to the participant on the date corresponding to the selected date indicium; and

(v) saving the timeline for a participant upon completion of a program planning session by a program planner as a saved timeline.

According to further aspects, the timeline graphical representation comprises a linear graphical item extending across a portion of the program planner's display, the linear graphical item including visually coded items to indicate a particular date and inform the program planner that a selected visually coded date is associated with content that can be viewed and edited with a user selection.

According to further aspects, the visually coded items indicate that (a) no content is scheduled to be delivered on the selected date, (b) content is scheduled to be delivered on the selected date, (c) important content is scheduled to be delivered on the selected date.

According to further aspects, certain embodiments further comprise the step of displaying, to the program planner, an interactive region corresponding to the timeline, an interactive region for selecting available content items for association with a timeline, an interactive region for displaying selected content items associated with a time indicium on the timeline, an interactive region for displaying information as to a participant associated with a timeline.

According to further aspects, the timeline graphical representation includes selectable indicia to indicate a particular day of a week represented by the timeline, and wherein selection of a particular day indicium on the timeline results in display of selected content items associated with that day arranged in a sequence for delivery, associated with a time indicium for each selected content item.

According to further aspects, each of the plurality of questions is associated with a category of questions, and further comprising the step of displaying an interactive region to the program planner an interactive region listing one or more categories of questions.

Further aspects and embodiments include a display and input device coupled to the computer system for interaction with a program planner to construct a timeline and select training content for delivery to participants, and wherein the processor is operative for executing further computer code for:

(i) displaying a timeline graphical representation to a program planner, the timeline graphical representation corresponding to a stored timeline and comprising user selectable date indicia, for a program planning session;

(ii) receiving input from the program planner during the program planning session to select a date indicium on a displayed timeline graphical representation;

(iii) receiving input from the program planner to select one or more particular content items and questions to associate with the selected date indicium in the program planning session, thereby indicating commanded delivery by the system of the selected content items and questions to the participant on the date corresponding to the selected date indicium; and

(iv) saving the timeline for a participant upon completion of a program planning session by a program planner as a saved timeline.

According to further aspects, the timeline graphical representation comprises a linear graphical item extending across a portion of the program planner's display, the linear graphical item including visually coded items to indicate a particular date and inform the program planner that a selected visually coded date is associated with content that can be viewed and edited with a user selection.

According to further aspects, the visually coded items indicate that (a) no content is scheduled to be delivered on the selected date, (b) content is scheduled to be delivered on the selected date, (c) important content is scheduled to be delivered on the selected date.

According to further aspects, the processor is further operative for executing computer program code for displaying, to the program planner, an interactive region corresponding to the timeline, an interactive region for selecting available content items for association with a timeline, an interactive region for displaying selected content items associated with a time indicium on the timeline, an interactive region for displaying information as to a participant associated with a timeline.

According to further aspects, each of the plurality of questions is associated with a category of questions, and further comprising the step of displaying an interactive region to the program planner an interactive region listing one or more categories of questions.

According to further aspects, the timeline graphical representation includes selectable indicia to indicate a particular day of a week represented by the timeline, and wherein selection of a particular day indicium on the timeline results in display of selected content items associated with that day arranged in a sequence for delivery, associated with a time indicium for each selected content item.

According to further aspects, the content delivery system is operative for accessing a saved timeline and electronically delivering the content items to a participant in accordance with the schedule indicated by a saved timeline.

Further aspects and embodiments comprise the steps of:

receiving, at the computer system, answers to one or more questions input by a participant in response to a delivered content item comprising a question provided at a particular question point in the timeline;

processing, at the computer system, received answers to the questions input by the participant to determine a progress score for the participant corresponding to an expected progress score for the participant at the particular question point in the timeline; and

adjusting, at the computer system, the timeline for the participant in response to a determined progress score so as to alter the schedule of delivery of content items to the participant for subsequent portions of the timeline.

According to further aspects, the timeline graphical representation comprises a linear graphical item extending across a portion of the program planner's display, the linear graphical item including visually coded items to indicate a particular date and inform the program planner that a selected visually coded date is associated with content that can be viewed and edited with a user selection.

According to further aspects, the visually coded items indicate that (a) no content is scheduled to be delivered on the selected date, (b) content is scheduled to be delivered on the selected date, (c) important content is scheduled to be delivered on the selected date.

In many of the described embodiments, the digital content items include but are not limited to electronic images, videos, text, sound, presentations, other forms of multimedia.

In many of the described embodiments, the computer system delivers content items to participants formatted for display and interaction on a dedicated computer application program, a web browser, a smartphone, a tablet, other digital display and input device.

In many of the described embodiments, a question comprises category data associating the question with a category, introductory text, question text, answer text, and answer explanation text.

In many of the described embodiments, each of the content items and questions is assigned a weighting value that is stored in the computer system in association with a corresponding content item or question, and wherein the step of processing received answers to the questions input by the participant comprises:

retrieving the stored weighting value for questions; and

calculating the progress score in accordance with the stored weighting value for the questions.

In many of the described embodiments, adjusting the timeline for a participant comprises adjusting the timeline for one of more of the following in accordance with a progress score:

(a) providing a parallel timeline of additional training content on dates and/or times independent of the dates and/or times in a particular timeline;

(b) advancing a participant to a later point on a particular timeline;

(c) providing an additional timeline of additional training content on dates and/or times independent of the dates and/or times in a particular timeline and returning to a predetermined point on a particular timeline; or

(d) providing an additional timeline of additional training content on dates and/or times independent of the dates and/or times in a particular timeline and returning to a predetermined point on a particular timeline even with or prior to departure of the timeline to the additional timeline.

In many of the described embodiments, the timeline further comprises data corresponding to notification messages for electronic delivery to a participant, each notification message being associated with a date and/or time on the schedule, each notification message comprising information for a participant indicating the availability of training content for access and/or of questions for answering, and further comprising the step of electronically delivering notification messages by the computer system to a participant in accordance with the timeline.

In many of the described embodiments, the step of adjusting the timeline comprises introducing a learning loop of content to the timeline in accordance with one or more of the following conditions:
1) In response to a participant completing a predetermined message, if after completing the message a Reinforcement score is higher or lower than a defined value, executing a first learning loop;
2) In response to a participant completing a predetermined message associated with a predetermined category, if after completing the message a Reinforcement score for the defined category is higher or lower than a defined value, executing a predetermined second learning loop;
3) In response to a participant completing a predetermined message associated with a predetermined tag, if after completing the message a Reinforcement score for the defined tag is higher or lower than a defined value, executing a predetermined third learning loop;

In response to a participant completing a predetermined message associated with a predetermined Quiz Question, if after completing the Quiz Question the given answer by the participant is correct or incorrect, executing a predetermined fourth learning loop;
4) In response to a participant completing a predetermined message associated with a predetermined Survey Question, the given answer by the participant is equal to a predefined value, executing a predetermined fifth learning loop;
5) In response to a participant completing a predetermined message associated with a predetermined Open-ended Question, if the given answer by the participant is missing or includes predefined keywords, executing a predetermined sixth learning loop;
6) In response to a participant being associated with a predetermined participant attribute, if after completing the message the value of the predefined attribute is equal to a predefined value, executing a predetermined seventh learning loop.

Many of the described embodiments are further characterized by assigning categories and tags to messages; determining a progress score for a participant based on a series of messages within a particular category or having the same tag, and adjusting the timeline by providing a predetermined learning loop corresponding to a particular category or tag.

The embodiments were chosen and described in order to explain the principles of the inventions as claimed and their practical application so as to enable others skilled in the art to utilize the claimed inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. A computer-implemented method for providing a predetermined program of digital training content to a training participant via a computer network in accordance with a timeline corresponding to a predetermined training time period, the training content comprising one or more digital content items and one or more questions relating to content items delivered to a participant, comprising the steps of:
(a) providing a network-accessible content delivery computer system including a memory and a processor, for storing a plurality of programs of training content and for electronically delivering selected content items and questions to a training participant via an electronic communication port;
(b) storing a timeline in the computer system representing a program of training content, the timeline comprising data representing a schedule for content delivery, data identifying particular selected content items to be delivered to a participate in accordance with the schedule, and data corresponding to questions related to content items;
(c) storing a plurality of selectable digital content items and a plurality of questions in the computer system;
(d) electronically delivering, by the computer system, the content items to a participant in accordance with the schedule corresponding to a stored timeline, at least some of the content items comprising a question that the participant is to answer in order to progress along the timeline and receive subsequent content items in the schedule of the saved timeline;
(e) receiving, at the computer system, answers to one or more questions input by a participant in response to a delivered content item comprising a question provided at a particular question point in the timeline;
(f) processing, at the computer system, received answers to the questions input by the participant to determine a progress score for the participant corresponding to an expected progress score for the participant at the particular question point in the timeline; and
(g) adjusting, at the computer system, the timeline for the participant in response to a determined progress score so as to alter the schedule of delivery of content items to the participant in accordance with the timeline.

2. The method of claim 1, wherein the digital content items include but are not limited to electronic images, videos, text, sound, presentations, other forms of multimedia.

3. The method of claim 1, wherein the computer system delivers content items to participants formatted for display and interaction on a dedicated computer application program, a web browser, a smartphone, a tablet, other digital display and input device.

4. The method of claim 1, further comprising the steps of:
(i) providing a display and input device coupled to the computer system for interaction with a program planner to construct a timeline and select training content for delivery to participants;
(ii) displaying, by the computer system, a timeline graphical representation to a program planner, the timeline graphical representation corresponding to a stored timeline and comprising user selectable date indicia, for a program planning session, the timeline graphical representation comprises a linear graphical item extending across a portion of the program planner's display, the linear graphical item including visually coded items to indicate a particular date and inform the program planner that a selected visually coded date is associated with content that can be viewed and edited with a user selection, the visually coded items indicate that (a) no content is scheduled to be delivered on the selected date, (b) content is scheduled to be delivered on the selected date, (c) important content is scheduled to be delivered on the selected date;
(iii) receiving, at the computer system, input from the program planner during the program planning session to select a date indicium on a displayed timeline graphical representation;
(iv) receiving, at the computer system, input from the program planner to select one or more particular content items and questions to associate with the selected date indicium in the program planning session, thereby indicating commanded delivery by the computer system of the selected content items and questions to the participant on the date corresponding to the selected date indicium; and
(v) saving the timeline for a participant upon completion of a program planning session by a program planner as a saved timeline.

5. The method of claim 4, further comprising the step of displaying, to the program planner, an interactive region corresponding to the timeline, an interactive region for selecting available content items for association with a timeline, an interactive region for displaying selected content items associated with a time indicium on the timeline, an interactive region for displaying information as to a participant associated with a timeline.

6. The method of claim 4, wherein timeline graphical representation includes selectable indicia to indicate a particular day of a week represented by the timeline, and wherein selection of a particular day indicium on the timeline results in display of selected content items associated with that day arranged in a sequence for delivery, associated with a time indicium for each selected content item.

7. The method of claim 1, wherein each of the content items and questions is assigned a weighting value that is stored in the computer system in association with a corresponding content item or question, and wherein the step of processing received answers to the questions input by the participant comprises:
retrieving the stored weighting value for questions; and
calculating the progress score in accordance with the stored weighting value for the questions.

8. The method of claim 1, wherein the step of automatically adjusting the timeline for a participant comprises adjusting the timeline for one of more of the following in accordance with a progress score:
(a) providing a parallel timeline of additional training content on dates and/or times independent of the dates and/or times in a particular timeline;
(b) advancing a participant to a later point on a particular timeline;
(c) providing an additional timeline of additional training content on dates and/or times independent of the dates and/or times in a particular timeline and returning to a predetermined point on a particular timeline; or
(d) providing an additional timeline of additional training content on dates and/or times independent of the dates and/or times in a particular timeline and returning to a predetermined point on a particular timeline even with or prior to departure of the timeline to the additional timeline.

9. The method of claim 1, wherein the step of adjusting the timeline comprises introducing a learning loop of content to the timeline in accordance with one or more of the following conditions:
1) In response to a participant completing a predetermined message, if after completing the message a Reinforcement score is higher or lower than a defined value, executing a first learning loop;
2) In response to a participant completing a predetermined message associated with a predetermined category, if after completing the message a Reinforcement score for the defined category is higher or lower than a defined value, executing a predetermined second learning loop;
3) In response to a participant completing a predetermined message associated with a predetermined tag, if after completing the message a Reinforcement score for the defined tag is higher or lower than a defined value, executing a predetermined third learning loop;
4) In response to a participant completing a predetermined message associated with a predetermined Quiz Question, if after completing the Quiz Question the given answer by the participant is correct or incorrect, executing a predetermined fourth learning loop;
5) In response to a participant completing a predetermined message associated with a predetermined Survey Question, the given answer by the participant is equal to a predefined value, executing a predetermined fifth learning loop;
6) In response to a participant completing a predetermined message associated with a predetermined Open-ended Question, if the given answer by the participant is missing or includes predefined keywords, executing a predetermined sixth learning loop;
7) In response to a participant being associated with a predetermined participant attribute, if after completing the message the value of the predefined attribute is equal to a predefined value, executing a predetermined seventh learning loop.

10. A system for providing a predetermined program of digital training content to a training participant via a computer network in accordance with a timeline corresponding to a predetermined training time period, the training content comprising one or more digital content items and one or more questions relating to content items delivered to a participant, comprising:
a network-accessible content delivery computer system including a processor for electronically delivering selected content items and questions to a training participant via an electronic communication port, the processor operative for executing computer program code;
a memory for storing a plurality of programs of training content and one or more timelines, each timeline comprising data representing a schedule for content delivery, data identifying particular selected content items to be delivered to a participate in accordance with the schedule, and data corresponding to questions related to content items;
the memory further storing a plurality of selectable digital content items and a plurality of questions in the computer system;
the processor operative for executing computer program code for:
(a) electronically delivering the content items to a participant in accordance with the schedule corresponding to a stored timeline, at least some of the content items comprising a question that the participant is to answer in order to progress along the timeline and receive subsequent content items in the schedule of the saved timeline;
(b) receiving answers to one or more questions input by a participant in response to a delivered content item comprising a question provided at a particular question point in the timeline;
(c) processing received answers to the questions input by the participant to determine a progress score for the participant corresponding to an expected progress score for the participant at the particular question point in the timeline; and
(d) adjusting the timeline for the participant in response to a determined progress score so as to alter the schedule of delivery of content items to the participant in accordance with the timeline.

11. The system of claim 10, further comprising a display and input device coupled to the computer system for interaction with a program planner to construct a timeline and select training content for delivery to participants, and wherein the processor is operative for executing further computer code for:
(i) displaying a timeline graphical representation to a program planner, the timeline graphical representation corresponding to a stored timeline and comprising user selectable date indicia, for a program planning session, the timeline graphical representation comprises a linear graphical item extending across a portion of the program planner's display, the linear graphical item including visually coded items to indicate a particular date and inform the program planner that a selected visually coded date is associated with content that can be viewed and edited with a user selection, the visually coded items indicate that (a) no content is scheduled to be delivered on the selected date, (b) content is scheduled to be delivered on the selected date, (c) important content is scheduled to be delivered on the selected date;
(ii) receiving input from the program planner during the program planning session to select a date indicium on a displayed timeline graphical representation;
(iii) receiving input from the program planner to select one or more particular content items and questions to associate with the selected date indicium in the program planning session, thereby indicating commanded delivery by the system of the selected content items and questions to the participant on the date corresponding to the selected date indicium; and
(iv) saving the timeline for a participant upon completion of a program planning session by a program planner as a saved timeline.

12. The system of claim 11, wherein timeline graphical representation includes selectable indicia to indicate a particular day of a week represented by the timeline, and wherein selection of a particular day indicium on the timeline results in display of selected content items associated with that day arranged in a sequence for delivery, associated with a time indicium for each selected content item.

13. The system of claim 10, wherein adjusting the timeline for a participant comprises adjusting the timeline for one of more of the following in accordance with a progress score:
(a) providing a parallel timeline of additional training content on dates and/or times independent of the dates and/or times in a particular timeline;
(b) advancing a participant to a later point on a particular timeline;
(c) providing an additional timeline of additional training content on dates and/or times independent of the dates and/or times in a particular timeline and returning to a predetermined point on a particular timeline; or
(d) providing an additional timeline of additional training content on dates and/or times independent of the dates and/or times in a particular timeline and returning to a predetermined point on a particular timeline even with or prior to departure of the timeline to the additional timeline.

14. The system of claim 10, wherein adjusting the timeline comprises introducing a learning loop of content to the timeline in accordance with one or more of the following conditions:
1) In response to a participant completing a predetermined message, if after completing the message a Reinforcement score is higher or lower than a defined value, executing a first learning loop;
2) In response to a participant completing a predetermined message associated with a predetermined category, if after completing the message a Reinforcement score for the defined category is higher or lower than a defined value, executing a predetermined second learning loop;
3) In response to a participant completing a predetermined message associated with a predetermined tag, if after completing the message a Reinforcement score for the defined tag is higher or lower than a defined value, executing a predetermined third learning loop;
4) In response to a participant completing a predetermined message associated with a predetermined Quiz Question, if after completing the Quiz Question the given answer by the participant is correct or incorrect, executing a predetermined fourth learning loop;
5) In response to a participant completing a predetermined message associated with a predetermined Survey Question, the given answer by the participant is equal to a predefined value, executing a predetermined fifth learning loop;
6) In response to a participant completing a predetermined message associated with a predetermined Open-ended Question, if the given answer by the participant is missing or includes predefined keywords, executing a predetermined sixth learning loop;
7) In response to a participant being associated with a predetermined participant attribute, if after completing the message the value of the predefined attribute is equal to a predefined value, executing a predetermined seventh learning loop.

15. A computer-implemented method for providing a predetermined program of digital training content to a training participant via a computer network in accordance with a timeline corresponding to a predetermined training time period, the training content comprising one or more digital content items and one or more questions relating to content items delivered to a participant, comprising the steps of:
(a) providing a network-accessible content delivery computer system including a memory and a processor, for storing a plurality of programs of training content and for electronically delivering selected content items and questions to a training participant via an electronic communication port;
(b) providing a display and input coupled to the computer system for interaction with a program planner to construct and/or adjust a timeline and select training content for delivery to participants;
(c) storing a timeline in the computer system representing a program of training content, the timeline comprising data representing a schedule for content delivery, data identifying particular selected content items to be delivered to a participate in accordance with the schedule, and data corresponding to questions related to content items;
(d) storing a plurality of selectable digital content items and a plurality of questions in the computer system;
(e) displaying, by the computer system, a timeline graphical representation to a program planner, the timeline graphical representation corresponding to a stored timeline and comprising user selectable date indicia, for a program planning session;
(f) receiving, at the computer system, input from the program planner during the program planning session to select a date indicium on a displayed timeline graphical representation;
(g) receiving, at the computer system, input from the program planner to select one or more particular content items and questions to associate with the selected date indicium in the program planning session, thereby indicating commanded delivery by the computer system of the selected content items and questions to the participant on the date corresponding to the selected date indicium;
(h) saving the timeline for a participant upon completion of a program planning session by a program planner as a saved timeline;
(i) electronically delivering, by the computer system, the content items to a participant in accordance with the schedule indicated by a saved timeline, at least some of the content items comprising a question that the participant is to answer in order to progress along the timeline and receive subsequent content items in the schedule of the saved timeline;
(j) receiving, at the computer system, answers to one or more questions input by a participant in response to a delivered content item comprising a question provided at a particular question point in the timeline;
(k) processing, at the computer system, received answers to the questions input by the participant to determine a progress score for the participant corresponding to an expected progress score for the participant at the particular question point in the timeline; and
(l) adjusting, at the computer system, the timeline for the participant in response to a determined progress score so as to alter the schedule of delivery of content items to the participant in accordance with the timeline.

16. The method of claim 15, wherein the timeline graphical representation comprises a linear graphical item extending across a portion of the program planner's display, the linear graphical item including visually coded items to indicate a particular date and inform the program planner that a selected visually coded date is associated with content that can be viewed and edited with a user selection, the visually coded items indicate that (a) no content is scheduled to be delivered on the selected date, (b) content is scheduled to be delivered on the selected date, (c) important content is scheduled to be delivered on the selected date.

17. The method of claim 15, wherein the timeline graphical representation includes selectable indicia to indicate a particular day of a week represented by the timeline, and wherein selection of a particular day indicium on the timeline results in display of selected content items associated with that day arranged in a sequence for delivery, associated with a time indicium for each selected content item.

18. The method of claim 15, wherein each of the content items and questions is assigned a weighting value that is stored in the computer system in association with a corresponding content item or question, and wherein the step of processing received answers to the questions input by the participant comprises:
retrieving the stored weighting value for questions; and
calculating the progress score in accordance with the stored weighting value for the questions.

19. The method of claim 15, wherein the step of automatically adjusting the timeline for a participant comprises adjusting the timeline for one of more of the following in accordance with a progress score:
(a) providing a parallel timeline of additional training content on dates and/or times independent of the dates and/or times in a particular timeline;
(b) advancing a participant to a later point on a particular timeline;
(c) providing an additional timeline of additional training content on dates and/or times independent of the dates and/or times in a particular timeline and returning to a predetermined point on a particular timeline; or
(d) providing an additional timeline of additional training content on dates and/or times independent of the dates and/or times in a particular timeline and returning to a predetermined point on a particular timeline even with or prior to departure of the timeline to the additional timeline.

20. A system for providing a predetermined program of digital training content to a training participant via a computer network in accordance with a timeline corresponding to a predetermined training time period, the training content comprising one or more digital content items and one or more questions relating to content items delivered to a participant, comprising the steps of:
a network-accessible computer system including a processor, the processor operative for executing computer program code;
a memory for storing a plurality of programs of training content and one or more timelines, each timeline comprising data representing a schedule for content delivery, data identifying particular selected content items to be delivered to a participate in accordance with the schedule, and data corresponding to questions related to content items;
the memory further storing a plurality of selectable digital content items and a plurality of questions in the computer system;
a display and input device coupled to the computer system for interaction with a program planner to construct and/or adjust a timeline and select training content for delivery to participants;
the processor operative for executing computer program code for:
(a) displaying a timeline graphical representation to a program planner via the display, the timeline graphical representation corresponding to a stored timeline and comprising user selectable date indicia, for a program planning session;
(b) receiving input from the program planner during the program planning session to select a date indicium on a displayed timeline graphical representation;
(c) receiving input from the program planner to select one or more particular content items and questions to associate with the selected date indicium in the program planning session, thereby indicating commanded delivery by the computer system of the selected content items and questions to the participant on the date corresponding to the selected date indicium;
(d) saving the timeline for a participant upon completion of a program planning session by a program planner as a saved timeline;
(e) electronically delivering the content items to a participant in accordance with the schedule indicated by a saved timeline, at least some of the content items comprising a question that the participant is to answer in order to progress along the timeline and receive subsequent content items in the schedule of the saved timeline;
(f) receiving answers to one or more questions input by a participant in response to a delivered content item comprising a question provided at a particular question point in the timeline;
(g) processing received answers to the questions input by the participant to determine a progress score for the participant corresponding to an expected progress score for the participant at the particular question point in the timeline; and
(h) adjusting the timeline for the participant in response to a determined progress score so as to alter the schedule of delivery of content items to the participant in accordance with the timeline.

21. The system of claim 20, wherein the timeline graphical representation comprises a linear graphical item extending across a portion of the program planner's display, the linear graphical item including visually coded items to indicate a particular date and inform the program planner that a selected visually coded date is associated with content that can be viewed and edited with a user selection, the visually coded items indicate that (a) no content is scheduled to be delivered on the selected date, (b) content is scheduled to be delivered on the selected date, (c) important content is scheduled to be delivered on the selected date.

22. The system of claim 20, wherein the processor is further operative to execute program code for displaying, to the program planner, an interactive region corresponding to the timeline, an interactive region for selecting available content items for association with a timeline, an interactive region for displaying selected content items associated with a time indicium on the timeline, an interactive region for displaying information as to a participant associated with a timeline.

23. The system of claim 20, wherein timeline graphical representation includes selectable indicia to indicate a particular day of a week represented by the timeline, and wherein selection of a particular day indicium on the timeline results in display of selected content items associated with that day arranged in a sequence for delivery, associated with a time indicium for each selected content item.

24. The system of claim 20, wherein each of the content items and questions is assigned a weighting value that is stored in the computer system in association with a corresponding content item or question, and wherein the processing received answers to the questions input by the participant comprises:
retrieving the stored weighting value for questions; and
calculating the progress score in accordance with the stored weighting value for the questions.

25. The system of claim 20, wherein adjusting the timeline for a participant comprises adjusting the timeline for one of more of the following in accordance with a progress score:
(a) providing a parallel timeline of additional training content on dates and/or times independent of the dates and/or times in a particular timeline;
(b) advancing a participant to a later point on a particular timeline;
(c) providing an additional timeline of additional training content on dates and/or times independent of the dates and/or times in a particular timeline and returning to a predetermined point on a particular timeline; or
(d) providing an additional timeline of additional training content on dates and/or times independent of the dates and/or times in a particular timeline and returning to a predetermined point on a particular timeline even with or prior to departure of the timeline to the additional timeline.

26. The system of claim 20, wherein adjusting the timeline comprises introducing a learning loop of content to the timeline in accordance with one or more of the following conditions:
1) In response to a participant completing a predetermined message, if after completing the message a Reinforcement score is higher or lower than a defined value, executing a first learning loop;
2) In response to a participant completing a predetermined message associated with a predetermined category, if after completing the message a Reinforcement score for the defined category is higher or lower than a defined value, executing a predetermined second learning loop;
3) In response to a participant completing a predetermined message associated with a predetermined tag, if after completing the message a Reinforcement score for the defined tag is higher or lower than a defined value, executing a predetermined third learning loop;
4) In response to a participant completing a predetermined message associated with a predetermined Quiz Question, if after completing the Quiz Question the given answer by the participant is correct or incorrect, executing a predetermined fourth learning loop;
5) In response to a participant completing a predetermined message associated with a predetermined Survey Question, the given answer by the participant is equal to a predefined value, executing a predetermined fifth learning loop;
6) In response to a participant completing a predetermined message associated with a predetermined Open-ended Question, if the given answer by the participant is missing or includes predefined keywords, executing a predetermined sixth learning loop;
7) In response to a participant being associated with a predetermined participant attribute, if after completing the message the value of the predefined attribute is equal to a predefined value, executing a predetermined seventh learning loop.
